(19) United States
(12) Patent Application Publication
(10) Pub. No.: US 2026/0244897 A1
(43) Pub. Date: Aug. 20, 2026

(54) SIMILARITY DETERMINATION METHOD, SIMILARITY CALCULATION UNIT, DIFFUSION-TYPE LEARNING NETWORK, AND EXECUTIVE PROGRAM OF NEURAL NETWORK

(71) Applicant: NTT, Inc., Tokyo (JP)

(72) Inventor: Takao YAMASHITA, Musashino-shi, Tokyo (JP)

(21) Appl. No.: 18/878,958

(22) PCT Filed: Jun. 23, 2023
(86) PCT No.: PCT/JP2023/023436

§ 371 Date: Dec. 26, 2024

(30) Foreign Application Priority Data
Jun. 27, 2022 (WO) PCT/JP2022/025633

(51) Int. Cl. G06N 3/043; G06N 3/0475

(52) U.S. Cl. CPC G06N 3/043; G06N 3/0475

(57) ABSTRACT

A value obtained by dividing the number of inputs in which both wᵢ and yᵢ are the value H by a value obtained by adding the number of inputs in which yᵢ is the value H to the number of inputs in which wᵢ is the value His calculated and output as similarity representing the degree of similarity.

### CROSS-REFERENCE TO RELATED APPLICATIONS

This is a National Stage Application of PCT Application No. PCT/JP2023/023436, filed on Jun. 23, 2023. The disclosure of the prior application is considered part of the disclosure of this application, and is incorporated in its entirety into this application.

### BACKGROUND

### Technical Field

The present invention relates to a similarity determination method, a similarity calculation unit (or similarity calculator), a diffusive learning network, and a neural network execution program.

### Background Art

In recent years, artificial intelligence technology using an artificial neural network has developed, and various industrial applications have progressed. Such a neural network is characterized by using a network in which perceptrons obtained by modeling a nerve cell are connected. In a neural network, calculation is performed based on an input to the entire network, and a calculation result is output.

As a perceptron used in an artificial neural network, a perceptron obtained by developing early nerve cell modeling is used.

FIG. 51 is a diagram illustrating an operation of a perceptron 200 including a variable constant input.

As illustrated in FIG. 51, b, x₁, x₂, . . . x_{N} are input to the perceptron 200 as N+1 input values. Among them, N external inputs are input to the entire neural network, and an input value xᵢ is input to an input i. b is a constant value held inside the neural network. In addition, one output y is output from the perceptron as the output of the neural network. A value wᵢ called a weight is assigned to the input i (i=1, 2, . . . N) (hereinafter, it is referred to as a synaptic weight). At this time, the output y is represented by Formula (1).

$$[ Formula 1 ]$$

$$y = f ( {\sum }_{i = 1}^{N} {w}_{i} {x}_{i} + b ) \qquad ( 1 )$$

Here, f(⋅) represents an activation function. As the activation function, a nonlinear function such as a sigmoid function or a tanh function, a rectified linear unit function (ReLU), or the like is often used.

In Formula (1), in order to eliminate the difference in notation between wᵢxᵢ and b and make the formula easy to see, a circuit as illustrated in FIG. 52 in which a constant input is set to 1 and a synaptic weight w₀ for the constant input is set to b and Formula (2) described below are often used. FIG. 52 is a diagram illustrating an operation of the perceptron 200 in which expression of input/synaptic weight is generalized.

$$[ Formula 2 ]$$

$$y = f ( {\sum }_{i = 0}^{N} {w}_{i} {x}_{i} ) \qquad ( 2 )$$

As expressed in Formula (2), the value passed to the activation function is calculated on the basis of the value of the input, and the value to be output is calculated by the activation function. In the following description, a value passed to the activation function is referred to as an activation degree. When the activation function is represented by f(a), a is the activation degree. Normally, when machine learning is performed using an artificial neural network, a network in which one or more perceptrons 200 are hierarchically connected as illustrated in FIG. 53 is used. FIG. 53 is a diagram illustrating a multilayered artificial neural network.

The artificial neural network has a plurality of combinations of input values xᵢ (i=1, 2, . . . , N). When one combination is represented by j and each of the input values xᵢ (i=1, 2, . . . , N) of the combination j is considered as a component of a vector, a vector including xᵢ (i=1, 2, . . . , N) is represented as xⱼ. Here, a component of xⱼ is represented as xⱼ=(xⱼ₁, xⱼ₂, . . . , x_{jN})^{T} included in (xⱼ=(xⱼ₁, xⱼ₂, . . . , x_{jN})^{T} means conversion of the vector into a column vector).

Next, a plurality of those in which a target value 1; is assigned is prepared with respect to each xⱼ, and the value of wᵢ is determined using it as learning data. This value is determined so as to minimize an error with respect to the entire learning data by using a difference between a value calculated by the neural network and the target value as an error.

In such a type of machine learning method using an artificial neural network, learning data itself is not stored in the neural network. On the other hand, among machine learning methods, there is a method called a k-nearest neighbor algorithm in which learning data is stored, similarity between an input and a storage pattern is calculated, and a label is output using k pieces of memory having high similarity. It is known that the k-nearest neighbor algorithm can perform relatively stable learning even in a case where the learning data is small, and there is an advantage depending on the application.

In addition, as a function of the brain, as described in Non Patent Literature 4, when there is a plurality of inputs from the outside, even in a case where a completely matched input pattern is not stored with respect to an input pattern that is a combination of the inputs, it is considered that there is a function of pattern complementation that completely recall a close memory already fixed in the brain. Searching for a memory close to an input pattern from the outside is one of the functions of human intelligence, and calculating similarity between the input and the storage pattern is basic information for searching for the most similar memory, and therefore, as an elemental technology of a method for achieving pattern complementation, a technology for calculating similarity between the input and the storage pattern is important.

As described above, it is an elemental technology for artificially achieving intelligent functions such as machine learning and the recollection of similar memories, which are considered to be included in a human by a neural network.

In neurons and neural networks on which perceptrons and artificial neural networks are based, there are Associative Networks described in Non Patent Literature 1, Non Patent Literature 2, and Non Patent Literature 3 as techniques for learning information input in the past, storing the information, comparing the stored information with current input, and determining similarity. Examples of neurons used in the Associative Network and the Associative Network are illustrated in FIGS. 54 and 55, respectively.

FIG. 54 is a diagram illustrating an example of a simple Associative Network. In FIG. 54, a neuron 300 is represented by a combination of an arrow and a black triangle. The upper side of this triangle (the side without the arrow portion) corresponds to the input portion of this neuron, and the lower side of the triangle (the side with the arrow portion) corresponds to the output portion of this neuron.

Now, it is assumed that there is a neuron 300 that changes to a firing state (representing a state in which the membrane potential of a nerve cell rises and exceeds a threshold) when a certain input A is added in the neural network. Then, when input B is repeatedly added at the same time when the input A is added, a phenomenon in which the neuron 300 changes to the firing state only by the input B occurs. This is a phenomenon described by the Hebb's rule that the connection of the synapse formed between the input B and the neuron 300 is strengthened by simultaneously firing the neuron generating the input B and the neuron 300. At this time, a phenomenon that the neuron 300 enters the firing state only by the input B is referred to as classical conditioning, and the input A and the input B are referred to as an unconditioned stimulus and a conditioned stimulus, respectively.

FIG. 55 is a diagram illustrating an example of an Associative Network including a plurality of unconditioned stimuli.

FIG. 55 illustrates a case where different unconditioned stimuli P, Q, and R are associated with one conditioned stimulus C by classical conditioning. The unconditioned stimulus P and the conditioned stimulus C are input to a neuron 301. The unconditioned stimulus Q and the conditioned stimulus C are input to a neuron 302. The unconditioned stimulus R and the conditioned stimulus C are input to a neuron 303.

Next, a technique for determining similarity by the Associative Network will be described.

FIG. 56 is a diagram for describing the neuron 300 as a component of the Associative Network regarding a technique for determining similarity by the Associative Network. FIG. 56 is setting of synaptic weights in a simple Associative Network.

Four input values x₁, x₂, x₃, and x₄ are input to the neuron 300 in FIG. 56. Here, an input value xᵢ is input to an input i. These input values are one of binary values of 0 and 1. This is related to the state of a preceding neuron generating individual inputs, and 0 corresponds to the non-firing state of the preceding neuron (a state in which the membrane potential of a nerve cell does not reach a threshold membrane potential state), and 1 corresponds to the firing state of the preceding neuron. This corresponds to that a neurotransmitter does not reach the connected neuron in the non-firing state, and that a neurotransmitter reaches in the firing state. Since a combination of input values to a neuron can be regarded as a vector having each as a component, a vector having x₁, x₂, x₃, and x₄ as components is represented as x, and x=(x₁, x₂, x₃, x₄). Hereinafter, x is referred to as an input vector.

It is assumed that a synaptic weight is assigned to a synapse whose input is a portion connected to a neuron, and w₁, w₂, w₃, and we are assigned to inputs 1, 2, 3, and 4, respectively. Since this combination of synaptic weights can also be regarded as a vector, a synaptic weight vector w is expressed as w=(w₁, w₂, w₃, w₄)^{T} by using the same notation as the input.

FIGS. 57A to 57F are diagrams for describing similarity calculation in the conventional art.

FIG. 57A illustrates a state at the time of learning of the Associative Network. Six inputs are connected to the neuron 300 in FIG. 57A. In FIG. 57A, an input vector x₁ is set as x₁=(1, 0, 0, 1, 0, 1)^{T}. With this learning, a synaptic weight vector is set as illustrated in FIG. 57B. This indicates that when the neuron 300 illustrated in FIG. 57A is in the firing state, the input vector x₁=(1, 0, 0, 1, 0, 1)^{T} is added, and the corresponding synaptic weight is set to 1 on the basis of the Hebb's rule for the input having a value of 1 among the components of the input vector. That is, w=x₁.

As an example of the first similarity determination, as illustrated in FIG. 57C, it is assumed that x₁=(1, 0, 0, 1, 0, 1)^{T} is input as an input vector x₁. That is, it is assumed that the same input vector as that at the time of learning is also added at the time of similarity determination. In the Associative Network, at this time, similarity between x₁ and the input x₁ at the time of learning is calculated as an inner product of both vectors. That is, the inner product is x₁·x₁. Since w=x₁, the inner product can be rewritten as w·x₁. The degree of similarity (hereinafter, referred to as an inner product similarity) calculated in this manner is 3. At this time, the activation degree of the neuron in FIG. 57C, that is, the value passed to the activation function of the neuron to determine the output is considered to be equal to the inner product similarity. If the neuron 300 in FIG. 57C has a step function with a threshold of 3 as an activation function, this neuron 300 outputs 1.

As an example of the second similarity determination, as illustrated in FIG. 57D, it is assumed that x₂=(1, 0, 0, 1, 1, 0)^{T} is input as an input vector x₂. The inner product similarity at this time is 2, indicating that the number of inputs having a value of 1 is one less than the input vector xᵢ at the time of learning. When the neuron 300 in FIG. 57D has the same activation function as that when the input vector x₂ described above is input, the inner product similarity does not reach a threshold of 3, and thus 0 is output.

As an example of the third similarity determination, as illustrated in FIG. 57E, it is assumed that x₃=(1, 0, 0, 1, 0, 0)^{T} is input as an input vector x₃. Also at this time, the inner product similarity is 2, indicating that the number of inputs having a value of 1 is one less than the input vector xᵢ at the time of learning. Also in this case, 0 is output as in FIG. 57D.

Here, looking at the difference between the input vectors x₂ and x₃, in x₂, there is one input in which the input at the time of learning is 0 and the input at the time of similarity determination is 1, and there is one input in which the input at the time of learning is 1 and the input at the time of similarity determination is 0. That is, there are two inputs resulting in the difference. On the other hand, in x₃, there is only one input in which the input at the time of learning is 1 and the input at the time of similarity determination is 0. That is, there is only one input resulting in the difference. Therefore, x₃ is practically closer to xᵢ, but the inner product similarity has the same value.

As an example of the fourth similarity determination, as illustrated in FIG. 57F, it is assumed that x₄=(1, 1, 1, 1, 0, 1)^{T} is input as an input vector x₄. The inner product similarity at this time is 3, which is the same value as the first similarity determination example in which the input vector x₁ at the time of learning is input as it is. However, while x₁ is exactly the same as x₁, in x₄, the same result as in the case of x₁ is obtained although there are two inputs in which the input at the time of learning is 0 and the input at the time of similarity determination is 1.

### RELATED ART

### Non Patent Literature

Non Patent Literature 1: B. L. McNaughton, R. G. M. Morris, “Hippocampal synaptic enhancement and information storage within a distributed memory system”, Trends in Neuroscience, volume 10, Issue 10, pp. 408-415, 1987. Non Patent Literature 2: Thomas Trappenberg, “Fundamentals of Computational Neuroscience”, Oxford University Press, 2010.
Non Patent Literature 3: Edmund T. Roll, “Cerebral Cortex: Principles of Operation”, Oxford University Press, 2016.
Non Patent Literature 4: Eric R. Kandel, James H. Schwartz, Thomas M. Jessell, Steven A. Siegelbaum, A. J. Hudspeth, “PRINCIPLES OF NEURAL SCIENCE: Fifth Edition”, McGraw-Hill Education, 2012.
Non Patent Literature 5: David J. Heeger, “Normalization of cell responses in cat striate cortex”, Visual Neuroscience, vol. 9, pp. 181-197, 1992.
Non Patent Literature 6: T. Tanimoto, “An elementary mathematical theory of classification and prediction.”, Technical report, International Business Machines Corporation, New York, 1958.
Non Patent Literature 7: P. Jaccard, “The distribution of the flora in the alpine zone”, Phytologist, 1912; 11 (2): 37-50. https://doi.org/10.1111/j.1469-8137.1912.tb05611.x.
Non Patent Literature 8: G. A. Carpenter, S. Grossberg, N. Markuzon, J. H. Reynolds, D. B. Rosen, “Fuzzy ARTMAP: A Neural Network Architecture for Incremental Supervised Learning of Analog Multidimensional Maps”, IEEE Transactions of Neural Network, Vol. 3, No. 5, pp. 698-713, 1992.
Non Patent Literature 9: L. Zadeh, “Fuzzy sets”, Information and Control, Vol. 8, No. 3, pp. 338-353, 1965.

### SUMMARY OF INVENTION

### Technical Problem

In the Associative Network, an input of a neural network is used as a vector (input vector), and an inner product of an input vector at the time of learning and an input vector for determining similarity is calculated to determine similarity. Actually, even if there is a difference in distance between two input vectors for determining similarity with respect to the input vector at the time of learning, the inner product similarity may have the same value.

For example, as in the third similarity determination example illustrated in FIG. 57E, x₃ is practically closer to x₁, but the inner product similarity has the same value, or as in the fourth similarity determination example illustrated in FIG. 57F, in x₄, the same result as in the case of x₁ may be obtained although there are two inputs in which the input at the time of learning is 0 and the input at the time of similarity determination is 1.

As described above, in the similarity calculation in the conventional art, there is a problem that the difference between the input vector at the time of learning and the input vector at the time of similarity determination cannot be accurately determined for the inner product similarity.

The present invention has been made in view of such circumstances, and an object is to accurately determine a difference between an input vector at the time of learning and an input vector at the time of similarity determination when determining the inner product similarity.

### Solution to Problem

In order to solve the above problem, a similarity determination method is a similarity determination method for calculating the degree of similarity between the input of the learning phase and the input of the similarity determination phase using the perceptron obtained by modeling a nerve cell, the similarity determination method having one or more inputs, one of the two different values: the value L or the value H is input to each input, when the value of the i-th input in the learning phase is represented as xᵢ and the value of the i-th input in the similarity determination phase is represented as yᵢ, the value wᵢ is assigned to the i-th input, one of the two values of the value L and the value H is set to the value wᵢ, in the learning phase, setting the value wᵢ of the weight assigned to the i-th input to the value of xᵢ, and in the similarity determination phase, calculating three numbers: the number of inputs in which the value of xᵢ is the value H, the number of inputs in which both wᵢ and yᵢ are the value H, and the number of inputs in which the value of yᵢ is the value H, and calculating and outputting a value obtained by dividing the value representing the number of inputs in which both wᵢ and yᵢ are the value H by a value obtained by adding the value representing the number of inputs in which the value of yᵢ is the value H to the value representing the number of inputs in which the value of wᵢ is the value H as similarity representing the degree of similarity

### Advantageous Effects of Invention

According to the present invention, it is possible to accurately determine a difference between an input vector at the time of learning and an input vector at the time of similarity determination when determining the inner product similarity.

### BRIEF DESCRIPTION OF DRAWINGS

FIG. 1 illustrates an example of a neural circuit that performs divisive normalization operation of a divisive normalization similarity determination method according to a first embodiment of the present invention.

FIG. 2 is a diagram illustrating an example of a circuit that performs a divisive normalization similarity determination method of the divisive normalization similarity determination method according to the first embodiment of the present invention.

FIG. 3 is a diagram illustrating setting of synaptic weights in the divisive normalization similarity determination method according to the first embodiment of the present invention.

FIG. 4 is a diagram illustrating a similarity determination phase in the divisive normalization similarity determination method according to the first embodiment of the present invention.

FIG. 5 is a diagram illustrating an example of a diffusive learning network in the divisive normalization similarity determination method according to the first embodiment of the present invention.

FIG. 6 is a diagram illustrating a diffusive learning network in which a perceptron that adds outputs of respective perceptrons is excluded from the diffusive learning network of FIG. 5.

FIG. 7 is a diagram for describing <learning phase> of a first operation example (step function) of the diffusive learning network illustrated in FIG. 6.

FIG. 8 is a diagram for describing a first example of <similarity determination phase> of the first operation example (step function) of the diffusive learning network illustrated in FIG. 6.

FIG. 9 is a diagram for describing a second example of <similarity determination phase> of the first operation example (step function) of the diffusive learning network illustrated in FIG. 6.

FIG. 10 is a diagram for describing a third example of <similarity determination phase> of the first operation example (step function) of the diffusive learning network illustrated in FIG. 6.

FIG. 11 is a diagram for describing <learning phase> of a second operation example (linear function) of the diffusive learning network illustrated in FIG. 6.

FIG. 12 is a diagram for describing a first example of <similarity determination phase> of the second operation example (linear function) of the diffusive learning network illustrated in FIG. 6.

FIG. 13 is a diagram for describing a second example of <similarity determination phase> of the second operation example (linear function) of the diffusive learning network illustrated in FIG. 6.

FIG. 14 is a diagram for describing a third example of <similarity determination phase> of the second operation example (linear function) of the diffusive learning network illustrated in FIG. 6.

FIG. 15 is a flowchart illustrating processing in a learning phase of a divisive normalization similarity calculator of the divisive normalization similarity determination method according to the first embodiment of the present invention.

FIG. 16 is a flowchart illustrating processing in a similarity determination phase of the divisive normalization similarity calculator of the divisive normalization similarity determination method according to the first embodiment of the present invention.

FIG. 17 is a flowchart illustrating processing in the learning phase of the divisive normalization similarity calculator of the divisive normalization similarity determination method according to the first embodiment of the present invention.

FIG. 18 is a flowchart illustrating processing in the similarity determination phase of the divisive normalization similarity calculator of the divisive normalization similarity determination method according to the first embodiment of the present invention.

FIG. 19 is a diagram illustrating a neural network in a case where the divisive normalization similarity determination method according to the first embodiment of the present invention and the diffusive learning network are combined.

FIG. 20 is a flowchart illustrating processing in the learning phase of <Example 3> of the divisive normalization similarity determination method according to the first embodiment of the present invention.

FIG. 21 is a flowchart illustrating processing in the similarity determination phase of <Example 3> of the divisive normalization similarity determination method according to the first embodiment of the present invention.

FIG. 22 is a flowchart illustrating processing in the learning phase of <Example 4> of the divisive normalization similarity determination method according to the first embodiment of the present invention.

FIG. 23 is a flowchart illustrating processing in the similarity determination phase of <Example 4> of the divisive normalization similarity determination method according to the first embodiment of the present invention.

FIG. 24 is a diagram illustrating an effect of a diffusive information network when m is changed with the activation function of the perceptron in the divisive normalization similarity calculator of the divisive normalization similarity determination method according to the first embodiment of the present invention as a step function, N=100, p=0.05, and k=0.

FIG. 25 is a diagram illustrating an effect of the diffusive information network when p=1.0 with respect to FIG. 24.

FIG. 26 is a diagram illustrating an effect of the diffusive learning network when the value of k is changed with m=0 in FIG. 24.

FIG. 27 is a diagram illustrating an effect of the diffusive learning network when the value of k is changed with m=0 in FIG. 25.

FIG. 28 is a diagram illustrating an effect of the diffusive learning network when the values of m and k are changed simultaneously with m=k in FIG. 24.

FIG. 29 is a diagram illustrating an effect of the diffusive learning network when the values of m and k are changed simultaneously with m=k in FIG. 25.

FIG. 30 is a diagram illustrating an effect (in the case of a linear function, p=0.05, and k=0) of the diffusive learning network in the divisive normalization similarity determination method according to the first embodiment of the present invention.

FIG. 31 is a diagram illustrating an effect (in the case of a linear function, p=1.0, and k=0) of the diffusive learning network in the divisive normalization similarity determination method according to the first embodiment of the present invention.

FIG. 32 is a diagram illustrating an effect (in the case of a linear function, p=0.05, and m=0) of the diffusive learning network in the divisive normalization similarity determination method according to the first embodiment of the present invention.

FIG. 33 is a diagram illustrating an effect (in the case of a linear function, p=1.0, and m=0) of the diffusive learning network in the divisive normalization similarity determination method according to the first embodiment of the present invention.

FIG. 34 is a diagram illustrating an effect (in the case of a linear function, p=0.05, and m=k) of the diffusive learning network in the divisive normalization similarity determination method according to the first embodiment of the present invention.

FIG. 35 is a diagram illustrating an effect (in the case of a linear function, p=1.0, and m=k) of the diffusive learning network in the divisive normalization similarity determination method according to the first embodiment of the present invention.

FIG. 36 is a diagram illustrating an activation degree (N=100) of a perceptron that performs output of a diffusive information network when only a divisive normalization similarity calculation method and a diffusive learning network according to a second embodiment of the present invention are used.

FIG. 37 is a diagram illustrating an activation degree (N=1000) of the perceptron that performs output of the diffusive information network when only the divisive normalization similarity calculation method and the diffusive learning network according to the second embodiment of the present invention are used.

FIG. 38 is a diagram illustrating an activation degree (output change when the number of inputs in which input value is 1 at the time of learning and 0 at the time of similarity determination is changed) of a perceptron that performs output of a diffusive information network when the divisive normalization similarity calculation method, the diffusive learning network, and a noise addition sensitivity characteristic improvement method according to the second embodiment of the present invention are used.

FIG. 39 is a diagram illustrating an activation degree (output change when the number of inputs in which input value is 0 at the time of learning and 1 at the time of similarity determination is changed) of the perceptron that performs output of the diffusive information network when the divisive normalization similarity calculation method, the diffusive learning network, and a noise addition sensitivity characteristic improvement method according to the second embodiment of the present invention are used.

FIG. 40 is a diagram comparing an activation degree (output change when the number of inputs in which input value is 1 at the time of learning and 0 at the time of similarity determination is changed) of the perceptron that performs output of the diffusive information network and raised Tanimoto similarity when the divisive normalization similarity calculation method, the diffusive learning network, and the noise addition sensitivity characteristic improvement method according to the second embodiment of the present invention are used.

FIG. 41 is a diagram comparing an activation degree (output change when the number of inputs in which input value is 0 at the time of learning and 1 at the time of similarity determination is changed) of the perceptron that performs output of the diffusive information network and raised Tanimoto similarity when the divisive normalization similarity calculation method, the diffusive learning network, and the noise addition sensitivity characteristic improvement method according to the second embodiment of the present invention are used.

FIG. 42 is a flowchart illustrating processing in a similarity determination phase of a divisive normalization similarity calculator according to the second embodiment of the present invention.

FIG. 43 is a flowchart illustrating processing in the similarity determination phase of the divisive normalization similarity calculator according to the second embodiment of the present invention.

FIG. 44 is a flowchart illustrating processing in the similarity determination phase of the divisive normalization similarity calculator according to the second embodiment of the present invention.

FIG. 45 is a flowchart illustrating processing in the similarity determination phase of the divisive normalization similarity calculator according to the second embodiment of the present invention.

FIG. 46 is a diagram for describing an example of similarity by a divisive normalization similarity calculation method using Fuzzy logic according to a third embodiment of the present invention.

FIG. 47 is a flowchart illustrating processing of a learning phase by the divisive normalization similarity calculation method using Fuzzy logic according to the third embodiment of the present invention.

FIG. 48 is a flowchart illustrating processing in a similarity determination phase of a divisive normalization similarity calculator when a noise addition sensitivity characteristic improvement method according to the third embodiment of the present invention is not used.

FIG. 49 is a flowchart illustrating processing in the similarity determination phase of the divisive normalization similarity calculator when the noise addition sensitivity characteristic improvement method according to the third embodiment of the present invention is used.

FIG. 50 is a hardware configuration diagram illustrating an example of a computer that implements a function of the divisive normalization similarity calculator of the divisive normalization similarity determination method according to the first to third embodiments of the present invention.

FIG. 51 is a diagram illustrating an operation of a perceptron including a variable constant input.

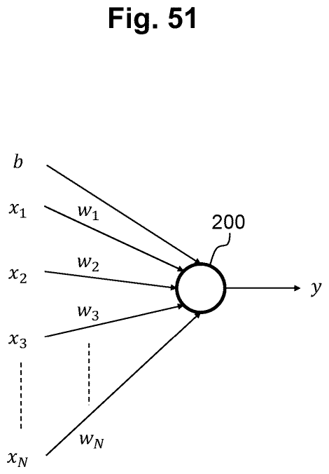

FIG. 52 is a diagram illustrating an operation of a perceptron in which expression of input/synaptic weight is generalized.

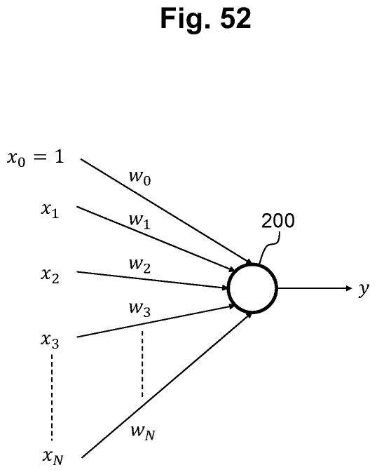

FIG. 53 is a diagram illustrating a multilayered artificial neural network.

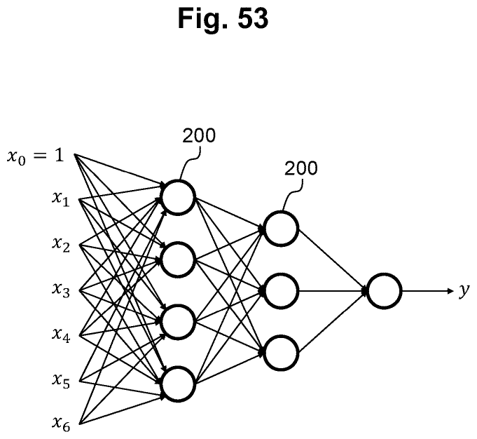

FIG. 54 is a diagram illustrating an example of a simple Associative Network.

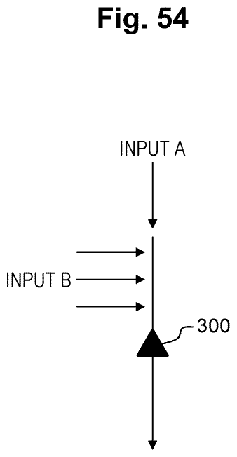

FIG. 55 is a diagram illustrating an example of an Associative Network including a plurality of unconditioned stimuli.

FIG. 56 is a diagram for describing a neuron as a component of the Associative Network regarding a technique for determining similarity by the Associative Network.

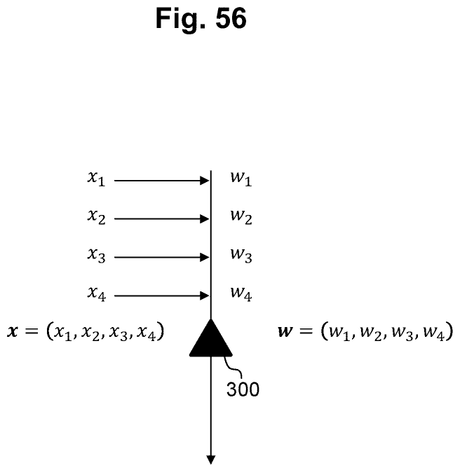

FIG. 57A is a diagram for describing similarity calculation in the conventional art.

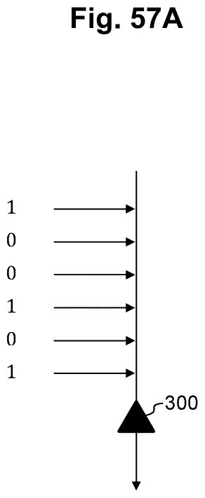

FIG. 57B is a diagram for describing similarity calculation in the conventional art.

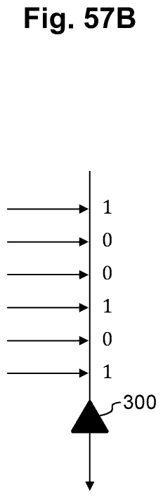

FIG. 57C is a diagram for describing similarity calculation in the conventional art.

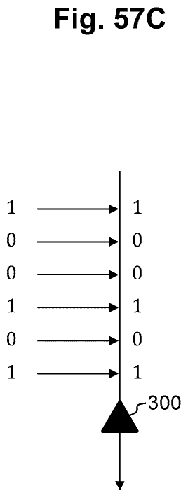

FIG. 57D is a diagram for describing similarity calculation in the conventional art.

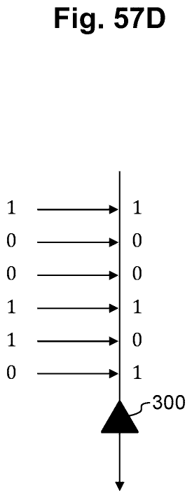

FIG. 57E is a diagram for describing similarity calculation in the conventional art.

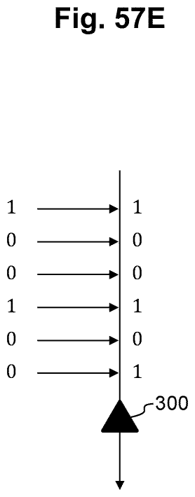

FIG. 57F is a diagram for describing similarity calculation in the conventional art.

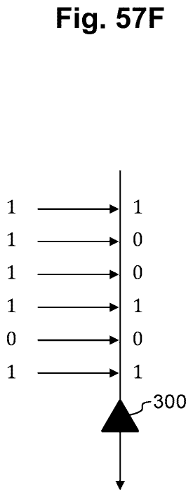

### DESCRIPTION OF EMBODIMENTS

Hereinafter, a similarity determination method, a similarity calculator, a diffusive learning network, and a neural network execution program in a mode for carrying out the present invention (hereinafter, referred to as the “first embodiment”) will be described with reference to the drawings.

### First Embodiment

The present invention is achieved by combining [divisive normalization similarity determination method] and [diffusive learning network method].

### [Divisive Normalization Similarity Determination Method]

First, a divisive normalization similarity determination method (similarity determination method) will be described.

In the similarity determination by the Associative Network described as the existing technology, the similarity is calculated by the inner product of the input vector at the time of learning and the input vector at the time of similarity determination. Thus, each neuron has a capability of calculating (that is, as an operation, multiplication), for each input, the product of the input value and the value of the synaptic weight and adding the value of the product for all inputs. In general, assuming that the input value can take any real number value, since the input value and the value of the synaptic weight can also be a negative value, in practice, it has a capability of multiplication, addition, and subtraction.

On the other hand, in the divisive normalization similarity determination method, in addition to multiplication, addition, and subtraction, an operation caused by a phenomenon called a shunt effect (Non Patent Literature 4) of nerve cells (neurons) is incorporated into the model of perceptron. The shunt effect is caused by inhibitory synapses formed in the nerve cell near the cell body. The shunt effect is the effect of dividing an overall added signal transmitted to the neuron by a signal transmitted via an inhibitory synapse formed near the cell body. The division caused by the shunt effect is also used in a model called divisive normalization for describing visual sensitivity adjustment as described in Non Patent Literature 5.

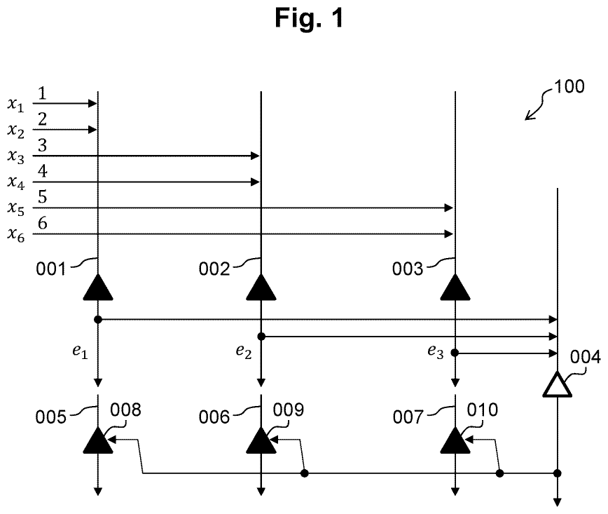

FIG. 1 is a diagram illustrating an example of a divisive normalization similarity calculator for divisive normalization, and illustrates an example of a neural circuit that performs a divisive normalization operation. In FIG. 1, neurons 001, 002, and 003 including black triangles form excitatory synapses with respect to 005, 006, and 007, respectively, and a neuron 004 including a white triangle (A) forms inhibitory synapses 008, 009, and 010. Here, the excitatory synapse is a synapse having an action of directing the activation state of the neuron on the side receiving the synapse to firing. In addition, the inhibitory synapse is, conversely, a synapse having an action of directing the activation state to resting. In FIG. 1, the inhibitory synapses 008, 009, and 010 formed by the neuron 004 are connected to the black triangles, which indicates that the inhibitory synapses 008, 009, and 010 exhibit the shunt effect.

The neurons 001, 002, and 003 in FIG. 1 receive inputs 1 and 2, 3 and 4, and 5 and 6, respectively, and input values x₁ and x₂, x₃ and x₄, and x₅ and x₆ are input, respectively. It is assumed that output values of the neurons 001, 002, and 003 become e₁, e₂, and e₃ by these inputs, respectively. The output values e₁, e₂, and e₃ are sent to neurons 005, 006, and 007, respectively. Here, it is assumed that these output values are directly transmitted to the neurons 005, 006, and 007, and become the respective activation degrees. In addition, it is assumed that the neuron 004 receives e₁, e₂, and e₃ as they are and sets the activation degree to a value of Σ³ⱼ₌₁eⱼ. Then, it is assumed that the activation degree of the neuron 004 is output as it is and sent to the neurons 005, 006, and 007 to cause the shunt effect at the synapses 008, 009, and 010. At this time, the effect of divisive normalization is expressed by the following formula, and the neurons 005, 006, and 007 have the activation degree expressed by Formula (3). Here, k is 1, 2, or 3.

$$[ Formula 3 ]$$

$$\frac{{e}_{k}}{C + {\sum }_{j = 1}^{3} {e}_{j}} \qquad ( 3 )$$

At this time, the activation degrees of the neurons 005, 006, and 007 are values when numerators are set to e₁, e₂, and e₃, respectively, in Formula (3) described above. In this manner, in divisive normalization, the activation degree of a certain neuron is divided by the sum of the outputs of a plurality of neurons (in the example of FIG. 1, the neurons 001, 002, and 003) called a neuronal pool. This effect describes the visual sensitivity adjustment. At this time, in a divisive normalization model, a change due to learning of the synaptic weight is not considered, and further, the value of C is experimentally determined so that the current input to vision is not saturated, and thus, a clear determination method according to the input at the time of learning or the like is not defined.

[Divisive normalization similarity determination method] of the present invention is achieved by (A) a method of determining a synaptic weight, (B) a method of determining a constant C of divisive normalization, and (C) a method of determining a perceptron set (hereinafter, referred to as a perceptron pool) corresponding to a neuronal pool in divisive normalization described below.

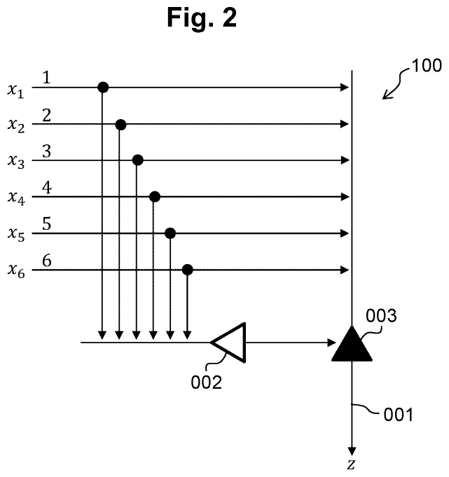

FIG. 2 is a diagram illustrating an example of a divisive normalization similarity calculator (similarity calculator) that performs the divisive normalization similarity determination method, and illustrates a learning phase in the example of the divisive normalization similarity determination method. Hereinafter, a module that executes the processing of the divisive normalization similarity determination method is referred to as a divisive normalization similarity calculator 100 (similarity calculator).

The input values x₁, x₂, x₃, x₄, x₅, and x₆ to the inputs 1, 2, 3, 4, 5, and 6 illustrated in FIG. 2 represent input values to the divisive normalization similarity calculator 100. These are equally input to perceptrons 001 and 002. As described above, in the divisive normalization similarity determination method, only all the inputs to the divisive normalization similarity calculator are used as the perceptron pool in (C) divisive normalization. Each input takes two types of values when a preceding perceptron is in the resting state and in the firing state, and these are represented by 0 and 1, respectively, in the present specification. That is, xᵢϵ{0,1} (i=1, 2, 3, 4, 5, 6) holds.

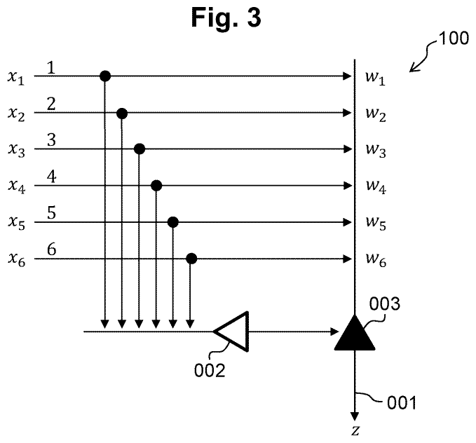

FIG. 3 is a diagram illustrating setting of synaptic weights in the divisive normalization similarity determination method. FIG. 3 illustrates that, as a result of the learning phase of FIG. 2, the synaptic weights formed in the perceptron 001 by the input values x₁, x₂, x₃, x₄, x₅, and x₆ are w₁, w₂, w₃, w₄, w₅, and w₆.

In (A) a method of determining a synaptic weight of the divisive normalization similarity determination method, the synaptic weight is set as wᵢ=xᵢ. That is, the weight of the synapse that has received the input signal corresponding to the firing state in the learning phase is 1, and the weight of the synapse that has received the input signal corresponding to the resting state is 0.

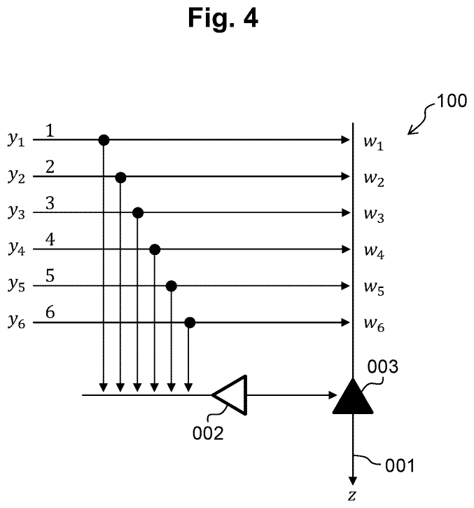

FIG. 4 is a diagram illustrating a similarity determination phase in the divisive normalization similarity determination method. FIG. 4 illustrates a similarity determination phase when the input values y₁, y₂, y₃, y₄, y₅, and y₆ arrive. At this time, the input to the perceptron 001 is calculated by Σ⁶ⱼ=₁yⱼ·wⱼ. On the other hand, there is no change in the synaptic weight, and τ⁶ⱼ=₁yⱼ is input to a perceptron 002. The output of the perceptron 002 generates the shunt effect in the perceptron 001 through a synapse 003 formed with respect to the perceptron 001, and calculates the following operation.

$$[ Formula 4 ]$$

$$\frac{2 {\sum }_{j = 1}^{6} {y}_{j} \cdot {w}_{j}}{C + {\sum }_{j = 1}^{6} {y}_{j}} \qquad ( 4 )$$

Further, as (B) a method of determining a constant C of divisive normalization, the constant C is set to a value calculated as described below in the learning phase.

$$[ Formula 5 ]$$

$$C = {‖ x ‖}^{2} \qquad ( 5 )$$

Here, x=(x₁, x₂, x₃, x₄, x₅, x₆), and ∥x∥ represents the norm of a vector x. When Formula (5) is substituted into Formula (4), Formula (4) is converted into Formula (6) described below.

$$[ Formula 6 ]$$

$$\frac{2 {\sum }_{j = 1}^{6} {y}_{j} \cdot {w}_{j}}{{‖ x ‖}^{2} + {\sum }_{j = 1}^{6} {y}_{j}} = \frac{2 ( y \cdot w )}{{‖ w ‖}^{2} + {‖ y ‖}^{2}} \qquad ( 6 )$$

where y=(y₁, y₂, y₃, y₄, y₅, y₆)^{T} and w=(w₁, w₂, w₃, w₄, w₅, w₆)^{T}.

Formula (6) includes the square of the norm and the inner product of the two vectors as vector operations. In general, when there are a vector v=(v₁, v₂, . . . , v_{N})^{T} and a vector u=(u₁, u₂, . . . , u_{N})^{T}, ∥u∥²=u₁²+u₂²+ . . . +u_{N}² and u·v=u₁v₁+u₂v₂+ . . . +u_{N}v_{N}.

Now, if uᵢϵ{0,1} and vᵢϵ{0, 1}, ∥u∥²=u₁²+u₂²+ . . . +u_{N}²=u₁+u₂+ . . . +u_{N}, and uᵥ=u₁v₁+u₂v₂+ . . . +u_{N}v_{N}=Σ^{N}ᵢ=₁uᵢvᵢ=Σ^{N}ᵢ₌₁(uⱼANDvᵢ) can also be calculated. uⱼANDvᵢ represents a logical conjunction operation of uᵢ and vᵢ.

Here, n₁₁, n₁₀, n₀₁, and n₀₀ are the number of inputs satisfying xᵢ=1 and yᵢ=1, the number of inputs satisfying xᵢ=1 and yᵢ=0, the number of inputs satisfying xᵢ=0 and yᵢ=1, and the number of inputs satisfying xᵢ=0 and yᵢ=0, respectively. In addition, N=n₁₁+n₁₀+n₀₁+n₀₀ represents the entire number of inputs and is therefore constant. Formula (6) descried above can be modified as described below.

$$[ Formula 7 ]$$

$$\frac{2 ( y \cdot w )}{{‖ w ‖}^{2} + {‖ y ‖}^{2}} = \frac{2 {n}_{11}}{{n}_{11} + {n}_{10} + {n}_{11} + {n}_{01}} = \frac{2 {n}_{11}}{2 {n}_{11} + {n}_{10} + {n}_{01}} \qquad ( 7 )$$

In the calculation of Formula (7), when the denominator is 0, since all of n₁₁, n₁₀, and not are 0, the numerator is also n₁₁, and the value thereof is also 0. The calculation result of Formula (7) in this case is calculated as 0 because there is no similarity between the two vectors.

Now, when the same input is obtained in the learning phase and the similarity determination phase, since n₁₀=n₀₁₌₀, Formula (8) is obtained.

$$[ Formula 8 ]$$

$$\frac{2 {n}_{11}}{2 {n}_{11} + {n}_{10} + {n}_{01}} = \frac{2 {n}_{11}}{2 {n}_{11}} = 1 \qquad ( 8 )$$

Next, a case where inputs are different between the learning phase and the similarity determination phase will be considered. N_{f}=n₁₁+n₁₀ is the number in which 1 is input at the time of learning and is constant in the similarity determination phase after the learning phase. Using this N_{f}, Formula (7) can be modified as described below.

$$[ Formula 9 ]$$

$$\frac{2 {n}_{11}}{2 {n}_{11} + {n}_{10} + {n}_{01}} = \frac{2 ( {N}_{f} - {n}_{10} )}{2 {N}_{f} - {n}_{10} + {n}_{01}} \qquad ( 9 )$$

From Formula (9), it can be seen that the value calculated by Formula (9) changes only by n₁₀ and n₀₁. From here, how the value of Formula (9) changes due to changes in n₁₀ and n₀₁ will be described.

<Change in n₁₀>

First, a change in Formula (9) with respect to a change in n₁₀ is considered. Formula (9) is modified into Formula (10) described below.

$$[ Formula 10 ]$$

$$\begin{matrix}\frac{2 ( {N}_{f} - {n}_{10} )}{2 {N}_{f} - {n}_{10} + {n}_{01}} = \frac{2 ( 2 {N}_{f} - {n}_{10} + {n}_{01} ) - 2 {N}_{f} - 2 {n}_{01}}{2 {N}_{f} - {n}_{10} + {n}_{01}} \\ = 2 - \frac{2 ( {N}_{f} + {n}_{01} )}{2 {N}_{f} - {n}_{10} + {n}_{01}}\end{matrix} \qquad ( 10 )$$

In Formula (10), when n₀₁ is constant, it can be seen that the value of the above formula monotonically decreases with respect to an increase in n₁₀.

<Change in n₀₁>

Secondly, a change in Formula (9) with respect to a change in nor is considered. In Formula (9), when n₁₀ is constant, it can be seen that the value of Formula (9) monotonically decreases with respect to an increase in n₀₁.

From the above, it can be seen that Formula (7) has a value of 1 with n₁₀=n₀₁₌₀, monotonically decreases with respect to an increase in n₁₀ and n₀₁, and represents the degree of similarity to solve the problem that the degree of similarity does not change even when n₁₀ and n₀₁, which is a problem in the existing technology, change.

### <Exact Meaning of Value Calculated by Divisive Normalization Similarity Calculation Method>

Next, the exact meaning of the value calculated by the divisive normalization similarity calculation method will be described.

The two formulas S_{d} and S_{c} described below are considered.

$$[ Formula 11 ]$$

$${S}_{d} = \frac{2 {n}_{11}}{{c}_{1} + {n}_{11} + {n}_{01}} \qquad ( 11 )$$

Formula (11) is a formula that becomes the divisive normalization similarity calculation method of the present invention when c₁ is n₁₁+n₁₀.

$$[ Formula 12 ]$$

$${S}_{c} = \frac{{n}_{11}}{\sqrt{{c}_{2}} \sqrt{{n}_{11} + {n}_{01}}} \qquad ( 12 )$$

Formula (12) expresses cosine similarity between the vectors x and y when c₂ is n₁₁+n₁₀. Cosine similarity represents the similarity of “how similar” two vectors are. Specifically, it is a cosine value of an angle formed by two vectors in a vector space. This value is calculated by dividing an inner product of two vectors (operation of adding a product of corresponding components of two vectors for all components) by a product of magnitude (norm) of the two vectors.

First, u and v are denoted by n₁₁ and n₀₁, respectively. When these are substituted into the above Formulas (11) and (12), S_{d} and S_{c} are expressed as functions of u and v, and become as described below.

$$[ Formula 13 ]$$

$${S}_{d} ( u , v ) = \frac{2 u}{{c}_{1} + u + v} \qquad ( 13 )$$

$$[ Formula 14 ]$$

$${S}_{d} ( u , v ) = \frac{u}{\sqrt{{c}_{2}} \sqrt{u + v}} \qquad ( 14 )$$

Now, in general, considering up to a linear term as Taylor expansion about (u, v) of the function f(u, v), a Taylor series f⁽¹⁾(u+h, v+k) up to the linear term is expressed as described below.

$$[ Formula 15 ]$$

$${f}^{( 1 )} ( u + h , v + k ) = \frac{1}{0 !} f ( u , v ) + \frac{1}{1 !} ( \frac{\partial f ( u , v )}{\partial u} h + \frac{\partial f ( u , v )}{\partial v} k ) \qquad ( 15 )$$

Using this, Taylor series S_{d}⁽¹⁾(u+h, v+k) and S_{c}⁽¹⁾(u+h, v+k) up to the linear term about (u, v) of S_{d}(u, v) and S_{d}(u, v) are obtained as described below.

$$[ Formula 16 ]$$

$${S}_{d}^{( 1 )} ( u + h , v + k ) = \frac{1}{0 !} \cdot \frac{2 u}{{c}_{1} + u + v} + \frac{1}{1 !} \cdot \frac{2}{{( {c}_{1} + u + v )}^{2}} [ ( {c}_{1} + v ) h - uk ] \qquad ( 16 )$$

$$[ Formula 17 ]$$

$$\begin{matrix}{S}_{c}^{( 1 )} ( u + h , v + k ) \\ = \frac{1}{0 !} \cdot \frac{u}{\sqrt{{c}_{2}} \sqrt{u + v}} + \frac{1}{1 !} \cdot \frac{1}{2 \sqrt{{c}_{1}} {( u + v )}^{2}} [ ( {v}_{1} + 2 v ) h - uk ]\end{matrix} \qquad ( 17 )$$

Substituting c₁=c₂=n₁₁+n₁₀=N_{f}, u=N_{f}, and v=0 into the above Formulas (16) and (17) results in the following.

$$[ Formula 18 ]$$

$$\begin{matrix}{S}_{d}^{( 1 )} ( {N}_{f} + h , k ) = \frac{1}{0 !} \cdot \frac{2 {N}_{f}}{{N}_{f} + {N}_{f}} + \frac{1}{1 !} \cdot \frac{2}{{( {N}_{f} + {N}_{f} )}^{2}} ( {N}_{f} h - {N}_{f} k ) \\ = 1 + \frac{1}{2 {N}_{f}} ( h - k )\end{matrix} \qquad ( 18 )$$

$$[ Formula 19 ]$$

$$\begin{matrix}{S}_{c}^{( 1 )} ( {N}_{f} + h , k ) = \frac{1}{0 !} \cdot \frac{2 {N}_{f}}{\sqrt{{c}_{2}} \sqrt{u + v}} + \frac{1}{1 !} \cdot \frac{1}{2 \sqrt{{c}_{2}} {( u + v )}^{\frac{3}{2}}} [ ( u - 2 v ) h - uk ] \\ = \frac{{N}_{f}}{\sqrt{{N}_{f}} \sqrt{{N}_{f}}} + \frac{1}{2 \sqrt{{N}_{f}} {N}_{f}^{\frac{3}{2}}} ( {N}_{f} h - {N}_{f} k ) = 1 + \frac{1}{2 {N}_{f}} ( h - k )\end{matrix} \qquad ( 19 )$$

Thus, when c₁=c₂=n₁₁+n₁₀=N_{f}, u=N_{f}, and v=0, the following equation holds.

$$[ Formula 20 ]$$

$${S}_{d}^{( 1 )} ( {N}_{f} + h , k ) = {S}_{c}^{( 1 )} ( {N}_{f} + h , k ) \qquad ( 20 )$$

From the above, it can be seen that the value calculated by the divisive normalization similarity determination method of the present invention is an approximate value of cosine similarity. As a result, the similarity calculated by the divisive normalization similarity determination method can calculate the similarity more accurately than the existing technology.

### [Diffusive Learning Network Method]

Next, a diffusive learning network method will be described.

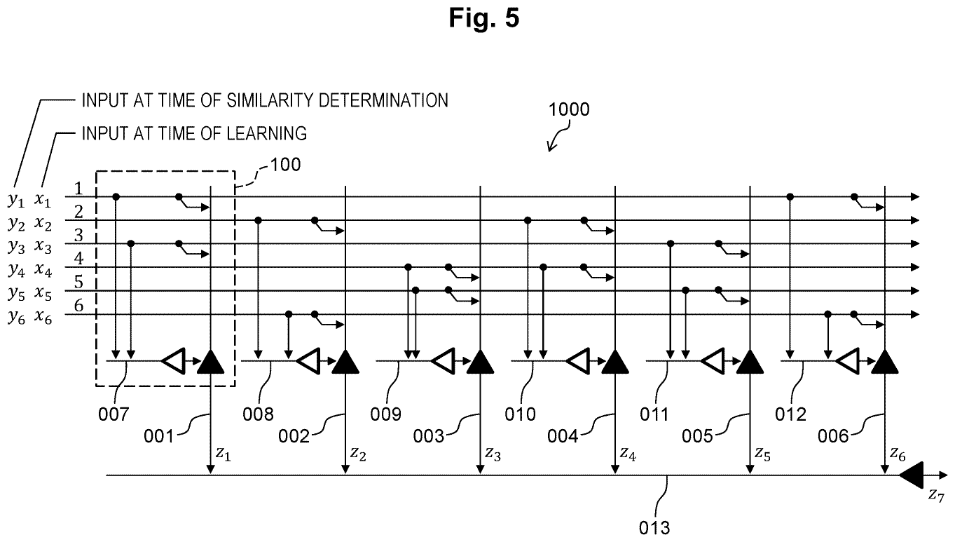

FIG. 5 is a diagram illustrating an example of the diffusive learning network.

As illustrated in FIG. 5, in a diffusive learning network 1000, a plurality of divisive normalization similarity calculators 100 having some or all of inputs with respect to inputs (in FIG. 5, a portion to which input values x₁, x₂, x₃, x₄, x₅, x₆, and the like are input) is connected, and outputs of the respective divisive normalization similarity calculators 100 output output values z₁, z₂, z₃, z₄, z₅, and z₆, which are input to a perceptron 013.

As a result, in the diffusive learning network 1000, after the output values z₁, z₂, z₃, z₄, z₅, and z₆ are added by the perceptron 013, an output value corresponding to the activation function of the perceptron 013 is output from z₇.

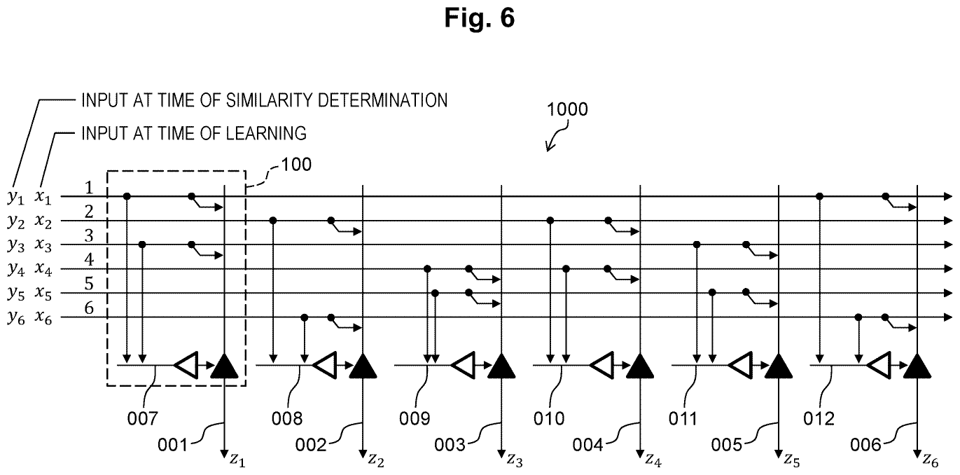

Hereinafter, operations other than the perceptron 013 will be described with reference to FIG. 6 in which the perceptron 013 is removed from the diffusive learning network 1000.

FIG. 6 is a diagram illustrating a diffusive learning network in which a perceptron that adds outputs of respective perceptrons is excluded from the diffusive learning network of FIG. 5. For convenience of description, the diffusive learning network 1000 in FIG. 6 in which the perceptron 013 is removed from the diffusive learning network 1000 is also denoted by the same reference numeral.

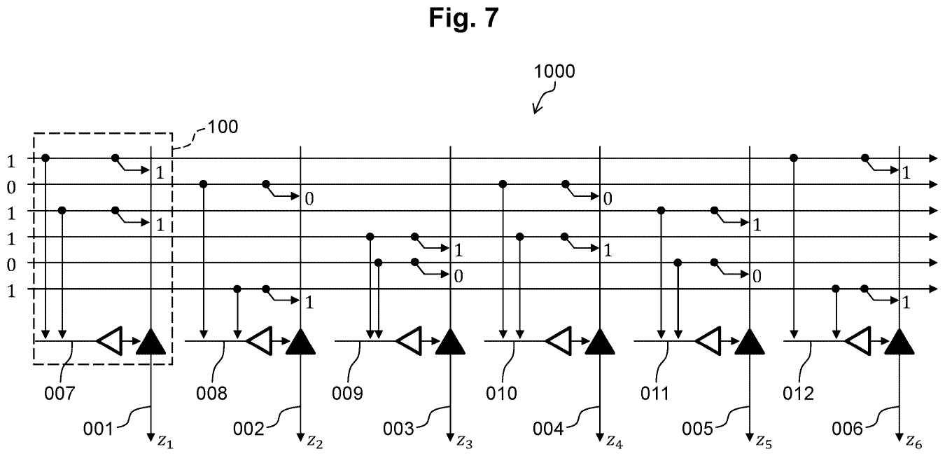

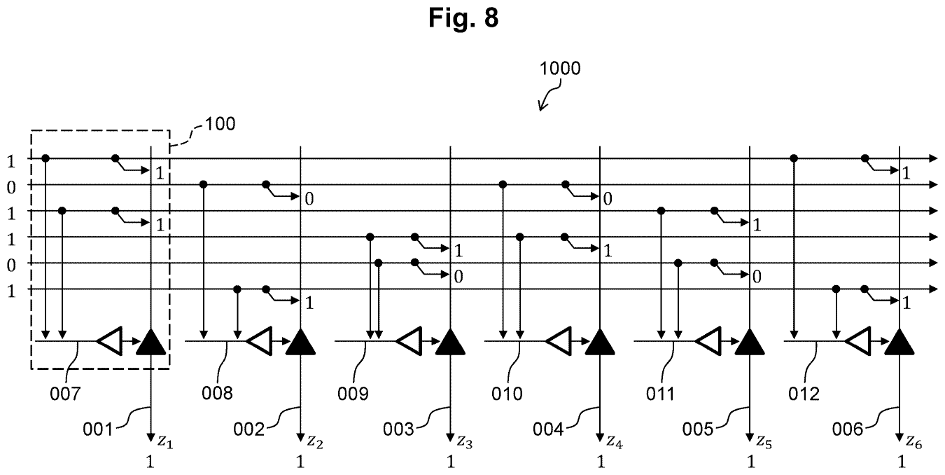

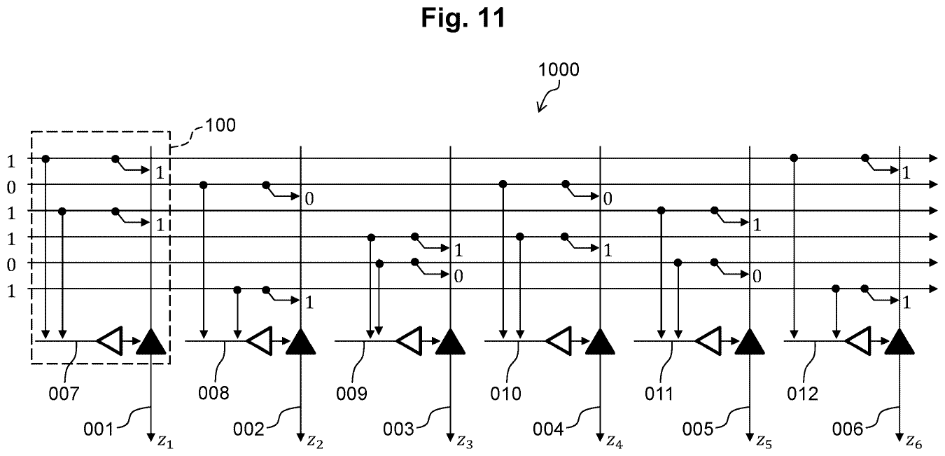

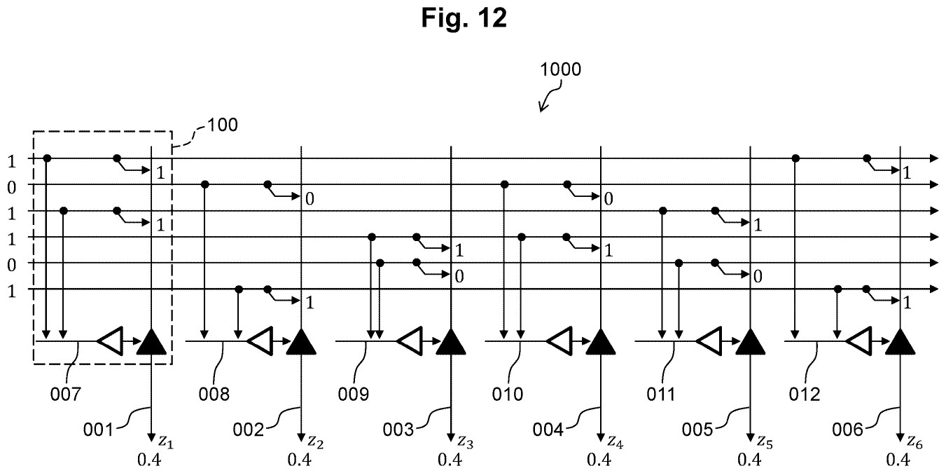

Examples of the operation of the diffusive learning network include a first operation example (FIGS. 7 to 10) in the case of using (step function) and a second operation example (FIGS. 11 to 14) in the case of using (linear function), and each of the first and second operation examples is further divided into <learning phase> (FIGS. 7 and 11), <similarity determination phase> (FIGS. 8 to 10) of (step function), and <similarity determination phase> (FIGS. 12 to 14) of (linear function). Description thereof will be made in order.

### First Operation Example (Step Function)

First, the first operation example (step function) of the diffusive learning network will be described.

FIG. 7 is a diagram for describing <learning phase> of the first operation example (step function) of the diffusive learning network illustrated in FIG. 6.

FIG. 7 illustrates a state when x=(x₁, x₂, x₃, x₄, x₅, x₆)^{T}=(1, 0, 1, 1, 0, 1)^{T} is input as <learning phase>.

At this time, the activation functions of perceptrons 001, 002, 003, 004, 005, and 006 are a step function having a threshold of 0.6.

With this learning phase, the synaptic weights of the perceptrons 001, 002, 003, 004, 005, and 006 change as in the learning phase of the divisive normalization similarity determination method. That is, when the input at the time of learning is 1, the synaptic weight related to the input is set to 1, and when the input is 0, the synaptic weight is set to 0. As a result, the perceptrons 001, 002, 003, 004, 005, and 006 each have two, one, one, one, one, and two synapses having a weight of 1.

FIG. 8 is a diagram for describing a first example of <similarity determination phase> of the first operation example (step function) of the diffusive learning network illustrated in FIG. 6.

The first example of <similarity determination phase> in FIG. 8 illustrates a state when (y₁, y₂, y₃, y₄, y₅, y₆)^{T}=(1, 0, 1, 1, 0, 1) is input. This input is the same input as in <learning phase> in FIG. 7. At this time, the perceptrons 001 to 006 calculate similarity as described below according to the synaptic weights changed by the input value of <learning phase> and the input values of the similarity determination phase.

### (1) in Case of Perceptrons 001 and 006

The value calculated by the divisive normalization similarity determination method is as described below. In the following formula, the final comparison with 0.6 is made because 0.6 is set as the threshold of the activation function of the perceptron.

$$[ Formula 21 ]$$

$${S}_{d} = \frac{2 {n}_{11}}{2 {n}_{11} + {n}_{10} + {n}_{01}} = \frac{2 \cdot 2}{2 \cdot 2 + 0 + 0} = 1 > 0.6 \qquad ( 21 )$$

### (2) in Case of Perceptrons 002, 003, 004, and 005

The value calculated by the divisive normalization similarity determination method is as described below.

$$[ Formula 22 ]$$

$${S}_{d} = \frac{2 {n}_{11}}{2 {n}_{11} + {n}_{10} + {n}_{01}} = \frac{2 \cdot 1}{2 \cdot 1 + 0 + 0} = 1 > 0.6 \qquad ( 22 )$$

As described above, all perceptrons have inputs exceeding the threshold, and the activation function is a step function, so that the output is 1. Thus, all perceptrons 001, 002, 003, 004, 005, and 006 output 1. As illustrated in FIG. 5, when the outputs of perceptrons 001, 002, 003, 004, 005, and 006 are input to the perceptron 013, the activation degree of the perceptrons is represented by the sum of the input values, and the activation function is represented by a linear function having a threshold of 0, the perceptron 013 outputs 6.

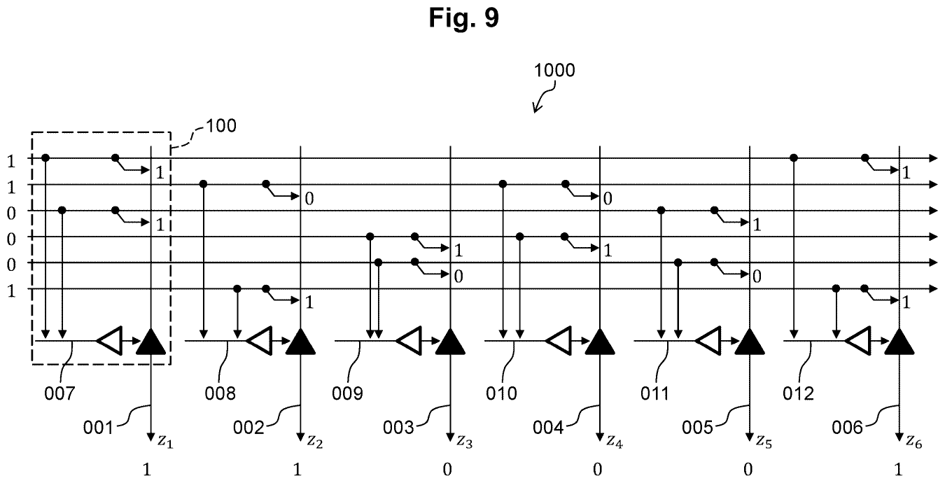

FIG. 9 is a diagram for describing a second example of <similarity determination phase> of the first operation example (step function) of the diffusive learning network illustrated in FIG. 6.

The second example of <similarity determination phase> in FIG. 9 is a case where an input of (y₁, y₂, y₃, y₄, y₅, y₆)^{T}=(1, 1, 0, 0, 0, 1)^{T} is given to the similarity determination phase.

### (1) In Case of Perceptron 001

The value calculated by the divisive normalization similarity determination method is as described below.

$$[ Formula 23 ]$$

$${S}_{d} = \frac{2 {n}_{11}}{2 {n}_{11} + {n}_{10} + {n}_{01}} = \frac{2 \cdot 1}{2 \cdot 1 + 1 + 0} = \frac{2}{3} > 0.6 \qquad ( 23 )$$

### (2) In Case of Perceptron 002

The value calculated by the divisive normalization similarity determination method is as described below.

$$[ Formula 24 ]$$

$${S}_{d} = \frac{2 {n}_{11}}{2 {n}_{11} + {n}_{10} + {n}_{01}} = \frac{2 \cdot 1}{2 \cdot 1 + 0 + 1} = \frac{2}{3} > 0.6 \qquad ( 24 )$$

### (3) In Case of Perceptrons 003 and 005

The value calculated by the divisive normalization similarity determination method is as described below.

$$[ Formula 25 ]$$

$${S}_{d} = \frac{2 {n}_{11}}{2 {n}_{11} + {n}_{10} + {n}_{01}} = \frac{2 \cdot 0}{2 \cdot 0 + 1 + 0} = \frac{0}{1} < 0.6 \qquad ( 25 )$$

### (4) In Case of Perceptron 004

The value calculated by the divisive normalization similarity determination method is as described below.

$$[ Formula 26 ]$$

$${S}_{d} = \frac{2 {n}_{11}}{2 {n}_{11} + {n}_{10} + {n}_{01}} = \frac{2 \cdot 0}{2 \cdot 0 + 1 + 1} = \frac{0}{2} < 0.6 \qquad ( 26 )$$

### (5) In Case of Perceptron 006

The value calculated by the divisive normalization similarity determination method is as described below.

$$[ Formula 27 ]$$

$${S}_{d} = \frac{2 {n}_{11}}{2 {n}_{11} + {n}_{10} + {n}_{01}} = \frac{2 \cdot 2}{2 \cdot 2 + 0 + 0} = \frac{4}{4} > 0.6 \qquad ( 27 )$$

As described above, the outputs of the three perceptrons: the perceptrons 001, 002, and 006 become 1. As illustrated in FIG. 5, when the outputs of perceptrons 001, 002, 003, 004, 005, and 006 are input to the perceptron 013, the activation degree of the perceptrons is represented by the sum of the input values, and the activation function is represented by a linear function having a threshold of 0, the perceptron 013 outputs 3.

Here, if considering a case where all the inputs are connected to one perceptron, the value calculated by the divisive normalization similarity determination method is as described below.

$$[ Formula 28 ]$$

$${S}_{d} = \frac{2 {n}_{11}}{2 {n}_{11} + {n}_{10} + {n}_{01}} = \frac{2 \cdot 2}{2 \cdot 2 + 2 + 1} = \frac{4}{7} < 0.6 \qquad ( 28 )$$

In this case, the similarity cannot be calculated without the diffusive learning network. On the other hand, in the example of FIG. 9, it can be seen that, due to the effect of the diffusive learning network, the situation where the inputs are 1 for some perceptrons both at the time of learning and at the time of similarity determination is biased, and thus, the three perceptrons are in the firing state, so that similarity can be determined.

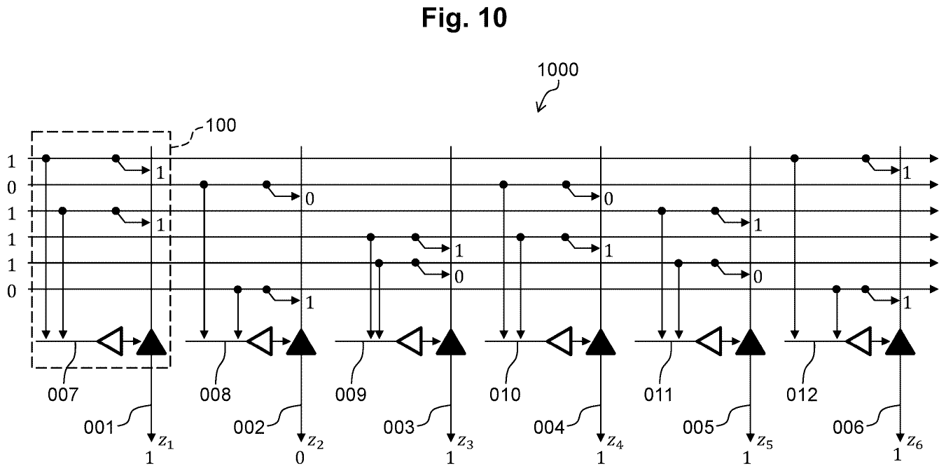

FIG. 10 is a diagram for describing a third example of <similarity determination phase> of the first operation example (step function) of the diffusive learning network illustrated in FIG. 6.

The third example of <similarity determination phase> in FIG. 10 is a case where an input of (y₁, y₂, y₃, y₄, y₅, y₆)^{T}=(1, 0, 1, 1, 1, 0)^{T} is given to the similarity determination phase.

### (1) In Case of Perceptron 001

The value calculated by the divisive normalization similarity determination method is as described below.

$$[ Formula 29 ]$$

$${S}_{d} = \frac{2 {n}_{11}}{2 {n}_{11} + {n}_{10} + {n}_{01}} = \frac{2 \cdot 2}{2 \cdot 2 + 0 + 0} = \frac{4}{4} > 0.6 \qquad ( 29 )$$

### (2) In Case of Perceptron 002

The value calculated by the divisive normalization similarity determination method is as described below.

$$[ Formula 30 ]$$

$${S}_{d} = \frac{2 {n}_{11}}{2 {n}_{11} + {n}_{10} + {n}_{01}} = \frac{2 \cdot 0}{2 \cdot 0 + 1 + 0} = 0 < 0.6 \qquad ( 30 )$$

### (3) In Case of Perceptron 003

The value calculated by the divisive normalization similarity determination method is as described below.

$$[ Formula 31 ]$$

$${S}_{d} = \frac{2 {n}_{11}}{2 {n}_{11} + {n}_{10} + {n}_{01}} = \frac{2 \cdot 1}{2 \cdot 1 + 0 + 1} = \frac{2}{3} > 0.6 \qquad ( 31 )$$

### (4) In Case of Perceptron 004

The value calculated by the divisive normalization similarity determination method is as described below.

$$[ Formula 32 ]$$

$${S}_{d} = \frac{2 {n}_{11}}{2 {n}_{11} + {n}_{10} + {n}_{01}} = \frac{2 \cdot 1}{2 \cdot 1 + 0 + 0} = \frac{2}{2} > 0.6 \qquad ( 32 )$$

### (5) In Case of Perceptron 005

The value calculated by the divisive normalization similarity determination method is as described below.

$$[ Formula 33 ]$$

$${S}_{d} = \frac{2 {n}_{11}}{2 {n}_{11} + {n}_{10} + {n}_{01}} = \frac{2 \cdot 1}{2 \cdot 1 + 0 + 1} = \frac{2}{3} > 0.6 \qquad ( 33 )$$

### (6) In Case of Perceptron 006

The value calculated by the divisive normalization similarity determination method is as described below.

$$[ Formula 34 ]$$

$${S}_{d} = \frac{2 {n}_{11}}{2 {n}_{11} + {n}_{10} + {n}_{01}} = \frac{2 \cdot 1}{2 \cdot 1 + 1 + 0} = \frac{2}{3} > 0.6 \qquad ( 34 )$$

As described above, the outputs of the five perceptrons: the perceptrons 001, 003, 004, 005, and 006 become 1. As illustrated in FIG. 5, when the outputs of perceptrons 001, 002, 003, 004, 005, and 006 are input to the perceptron 013, the activation degree of the perceptrons is represented by the sum of the input values, and the activation function is represented by a linear function having a threshold of 0, the perceptron 013 outputs 5.

Here, if considering a case where all the inputs are connected to one perceptron, the value calculated by the divisive normalization similarity determination method is as described below.

$$[ Formula 35 ]$$

$${S}_{d} = \frac{2 {n}_{11}}{2 {n}_{11} + {n}_{10} + {n}_{01}} = \frac{2 \cdot 3}{2 \cdot 3 + 1 + 1} = \frac{6}{8} > 0.6 \qquad ( 35 )$$

In this case, the similarity can be determined without the diffusive learning network. On the other hand, in this example, the output is 5, and in the previous example, the output is 3. This is because some inputs of the entire input are input to the divisive normalization similarity determination method by a so-called sparse distributed learning network, and changes are made depending on the degree of bias. Therefore, as the similarity is higher, there are more cases where input to the divisive normalization similarity determination method occurs such that the activation degree exceeds the threshold of the activation function even when the bias is small. Thus, the output in this example is large. From this, it can be seen that the similarity with respect to a wide range of inputs can be determined by the diffusive learning network.

The operation with the step function of the threshold of 0.6 as the activation function has been described above. Hereinafter, the operation with the linear function of the threshold of 0.6 will be described with reference to FIG. 11.

FIG. 11 is a diagram for describing <learning phase> of a second operation example (linear function) of the diffusive learning network illustrated in FIG. 6.

FIG. 11 illustrates a state when x=(x₁, x₂, x₃, x₄, x₅, x₆)^{T}=(1, 0, 1, 1, 0, 1)^{T} is input as <learning phase>.

At this time, the activation functions of perceptrons 001, 002, 003, 004, 005, and 006 are a linear function having a threshold of 0.6 and a gradient of 1.

With this learning phase, the synaptic weights of the perceptrons 001, 002, 003, 004, 005, and 006 change as in the learning phase of the divisive normalization similarity determination method. That is, when the input at the time of learning is 1, the synaptic weight related to the input changes to 1, and when the input is 0, the synaptic weight is 0. As a result, the perceptrons 001, 002, 003, 004, 005, and 006 each have two, one, one, one, one, and two synapses having a weight of 1.

FIG. 12 is a diagram for describing a first example of <similarity determination phase> of the second operation example (linear function) of the diffusive learning network illustrated in FIG. 6.

The first example of <similarity determination phase> in FIG. 12 illustrates a state when (y₁, y₂, y₃, y₄, y₅, y₆)^{T}=(1, 0, 1, 1, 0, 1)^{T} is input. This input is the same input as in the learning phase.

At this time, the perceptrons 001 to 006 calculate similarity and output as described below according to the synaptic weights changed by the input value of the learning phase and the input values of the similarity determination phase. Hereinafter, the linear function having a threshold of 0.6 and a gradient of 1 is represented by f₁(a).

### (1) In Case of Perceptrons 001 and 006

The value calculated by the divisive normalization similarity determination method is as described below.

$$[ Formula 36 ]$$

$${S}_{d} = \frac{2 {n}_{11}}{2 {n}_{11} + {n}_{10} + {n}_{01}} = \frac{2 \cdot 2}{2 \cdot 2 + 0 + 0} = 1 > 0. 6 \qquad ( 36 )$$

Thus, f₁(S_{d})=f₁(1)=0.4 is output.

### (2) In Case of Perceptrons 002, 003, 004, and 005

The value calculated by the divisive normalization similarity determination method is as described below.

$$[ Formula 37 ]$$

$${S}_{d} = \frac{2 {n}_{11}}{2 {n}_{11} + {n}_{10} + {n}_{01}} = \frac{2 \cdot 1}{2 \cdot 1 + 0 + 0} = 1 > 0. 6 \qquad ( 37 )$$

Thus, f₁(S_{d})=f₁(1)=0.4 is output.

As described above, all the perceptrons have inputs exceeding the threshold, and generate an output proportional to the similarity. As illustrated in FIG. 5, when the outputs of perceptrons 001, 002, 003, 004, 005, and 006 are input to the perceptron 013, the activation degree of the perceptrons is represented by the sum of the input values, and the activation function is represented by a linear function having a threshold of 0, the perceptron 013 outputs 2.4.

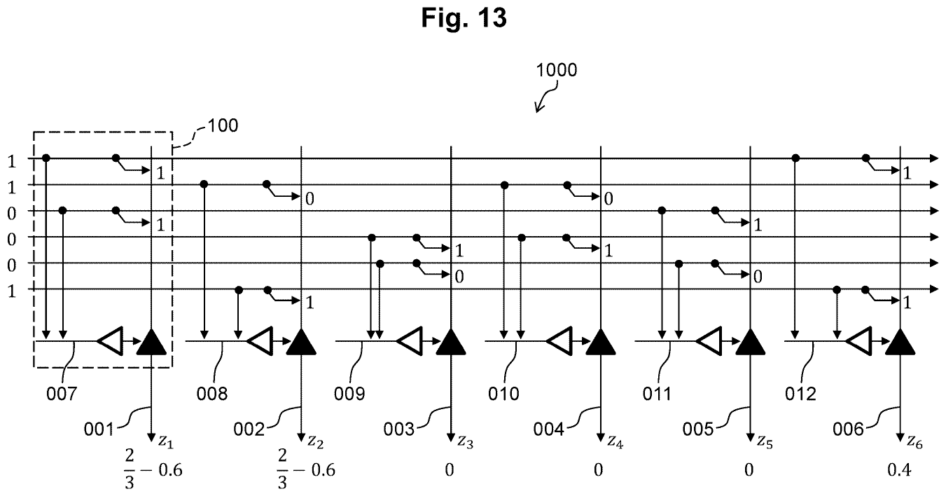

FIG. 13 is a diagram for describing a second example of <similarity determination phase> of the second operation example (linear function) of the diffusive learning network illustrated in FIG. 6.

The second example of <similarity determination phase> in FIG. 13 illustrates a state when (y₁, y₂, y₃, y₄, y₅, y₆)^{T}=(1, 1, 0, 0, 0, 1)^{T} is input.

### (1) In Case of Perceptron 001

The value calculated by the divisive normalization similarity determination method is as described below.

$$[ Formula 38 ]$$

$${S}_{d} = \frac{2 {n}_{11}}{2 {n}_{11} + {n}_{10} + {n}_{01}} = \frac{2 \cdot 1}{2 \cdot 1 + 1 + 0} = \frac{2}{3} > 0.6 \qquad ( 38 )$$

Thus, f₁(S_{d})=f₁(2/3)=2/3−0.6 is output.

### (2) In Case of Perceptron 002

The value calculated by the divisive normalization similarity determination method is as described below.

$$[ Formula 39 ]$$

$${S}_{d} = \frac{2 {n}_{11}}{2 {n}_{11} + {n}_{10} + {n}_{01}} = \frac{2 \cdot 1}{2 \cdot 1 + 0 + 1} = \frac{2}{3} > 0.6 \qquad ( 39 )$$

Thus, f₁(S_{d})=f₁(2/3)=2/3−0.6 is output.

### (3) In Case of Perceptrons 003 and 005

The value calculated by the divisive normalization similarity determination method is as described below.

$$[ Formula 40 ]$$

$${S}_{d} = \frac{2 {n}_{11}}{2 {n}_{11} + {n}_{10} + {n}_{01}} = \frac{2 \cdot 0}{2 \cdot 0 + 0 + 0} = 0 > 0. 6 \qquad ( 40 )$$

Thus, f₁(S_{d})=f₁(0)=0 is output.

### (4) In Case of Perceptron 004

The value calculated by the divisive normalization similarity determination method is as described below.

$$[ Formula 41 ]$$

$${S}_{d} = \frac{2 {n}_{11}}{2 {n}_{11} + {n}_{10} + {n}_{01}} = \frac{2 \cdot 0}{2 \cdot 0 + 1 + 1} = \frac{0}{2} > 0.6 \qquad ( 41 )$$

Thus, f₁(S_{d})=f₁(0)=0 is output.

### (5) In Case of Perceptron 006

The value calculated by the divisive normalization similarity determination method is as described below.

$$[ Formula 42 ]$$

$${S}_{d} = \frac{2 {n}_{11}}{2 {n}_{11} + {n}_{10} + {n}_{01}} = \frac{2 \cdot 2}{2 \cdot 2 + 0 + 0} = \frac{4}{4} > 0.6 \qquad ( 42 )$$

Thus, f₁(S_{d})=f₁(1)=0.4 is output.

As illustrated in FIG. 5, when the outputs of perceptrons 001, 002, 003, 004, 005, and 006 are input to the perceptron 013, the activation degree of the perceptrons is represented by the sum of the input values, and the activation function is represented by a linear function having a threshold of 0, the perceptron 013 outputs 4/3−0.8≈0.53.

$$[ Formula 43 ]$$

$$0.4 + 2 + ( \frac{2}{3} - 0.6 ) = 0.4 + \frac{4}{3} - 1.2 = \frac{4}{3} - 0 , 8 \approx 0.5 \; 33 \qquad ( 43 )$$

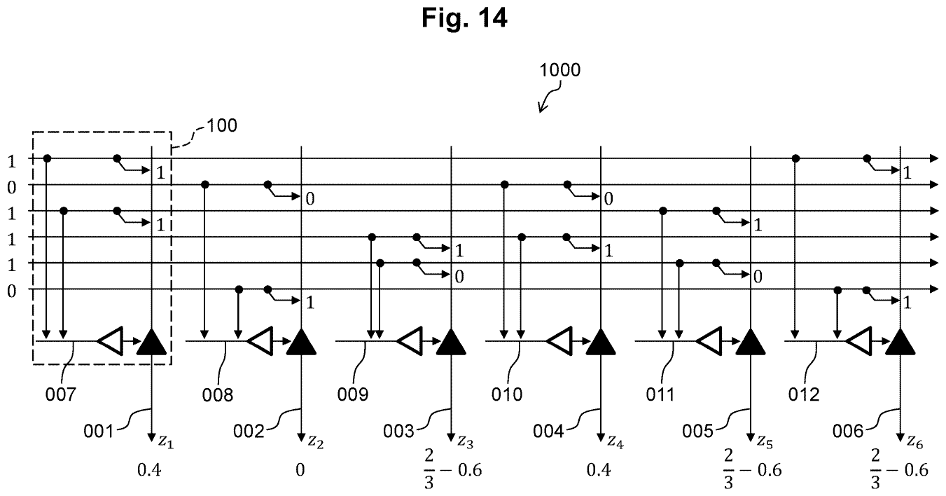

FIG. 14 is a diagram for describing a third example of <similarity determination phase> of the second operation example (linear function) of the diffusive learning network illustrated in FIG. 6.

The third example of <similarity determination phase> in FIG. 14 illustrates a state when (y₁, y₂, y₃, y₄, y₅, y₆)^{T}=(1, 0, 1, 1, 1, 0)^{T} is input.

### (1) In Case of Perceptron 001

The value calculated by the divisive normalization similarity determination method is as described below.

$$[ Formula 44 ]$$

$${S}_{d} = \frac{2 {n}_{11}}{2 {n}_{11} + {n}_{10} + {n}_{01}} = \frac{2 \cdot 2}{2 \cdot 2 + 0 + 0} = \frac{4}{4} > 0.6 \qquad ( 44 )$$

Thus, f₁(S_{d})=f₁(1)=0.4 is output.

### (2) In Case of Perceptron 002

The value calculated by the divisive normalization similarity determination method is as described below.

$$[ Formula 45 ]$$

$${S}_{d} = \frac{2 {n}_{11}}{2 {n}_{11} + {n}_{10} + {n}_{01}} = \frac{2 \cdot 0}{2 \cdot 0 + 1 + 0} = 0 > 0. 6 \qquad ( 45 )$$

Thus, f₁(S_{d})=f₁(0)=0 is output.

### (3) In Case of Perceptron 003

The value calculated by the divisive normalization similarity determination method is as described below.

$$[ Formula 46 ]$$

$${S}_{d} = \frac{2 {n}_{11}}{2 {n}_{11} + {n}_{10} + {n}_{01}} = \frac{2 \cdot 1}{2 \cdot 1 + 0 + 1} = \frac{2}{3} > 0.6 \qquad ( 46 )$$

Thus, f₁(S_{d})=f₁(2/3)=2/3−0.6 is output.

### (4) In Case of Perceptron 004

The value calculated by the divisive normalization similarity determination method is as described below.

$$[ Formula 47 ]$$

$${S}_{d} = \frac{2 {n}_{11}}{2 {n}_{11} + {n}_{10} + {n}_{01}} = \frac{2 \cdot 1}{2 \cdot 1 + 0 + 0} = \frac{2}{2} > 0.6 \qquad ( 47 )$$

Thus, f₁(S_{d})=f₁(1)=0.4 is output.

### (5) In Case of Perceptron 005

The value calculated by the divisive normalization similarity determination method is as described below.

$$[ Formula 48 ]$$

$${S}_{d} = \frac{2 {n}_{11}}{2 {n}_{11} + {n}_{10} + {n}_{01}} = \frac{2 \cdot 1}{2 \cdot 1 + 0 + 1} = \frac{2}{3} > 0.6 \qquad ( 48 )$$

Thus, f₁(S_{d})=f₁(2/3)=2/3−0.6 is output.

### (6) In Case of Perceptron 006

The value calculated by the divisive normalization similarity determination method is as described below.

$$[ Formula 49 ]$$

$${S}_{d} = \frac{2 {n}_{11}}{2 {n}_{11} + {n}_{10} + {n}_{01}} = \frac{2 \cdot 1}{2 \cdot 1 + 1 + 0} = \frac{2}{3} > 0.6 \qquad ( 49 )$$

Thus, f₁(S_{d})=f₁(2/3)=2/3−0.6 is output.

As illustrated in FIG. 5, when the outputs of perceptrons 001, 002, 003, 004, 005, and 006 are input to the perceptron 013, the activation degree of the perceptrons is represented by the sum of the input values, and the activation function is represented by a linear function having a threshold of 0, the perceptron 013 is as described below.

$$[ Formula 50 ]$$

$$0.4 + 0.4 + 3 ( \frac{2}{3} - 0.6 ) = 0.8 + 2 - 1.8 = 1 \qquad ( 50 )$$

[Divisive normalization similarity determination method] and [diffusive learning network method] have been described above. Hereinafter, the divisive normalization similarity calculator of the diffusive learning network will be described.

### [Divisive Normalization Similarity Calculator of Diffusive Learning Network]

In the diffusive learning network, there are one or more divisive normalization similarity calculators. In the following description, it will be described how the input to the diffusive learning network connects to the divisive normalization similarity calculators, and as a result, what value an average output value of the divisive normalization similarity calculators is.

First, the following set of six: I_{N}, Iₖ, Iₘ, Iₙ, I_{d}, and I₁ having inputs (in the example of FIG. 5, the input values xᵢ are input to the input i) to the diffusive learning network or some of them as elements are considered.

$$[ Formula 51 ]$$

$${I}_{N} = \{ i \vert {x}_{i} = 1 \} \qquad ( 51 )$$

$$[ Formula 52 ]$$

$${I}_{k} = \{ i \vert {x}_{i} = 0 ∧ {y}_{1} = 1 \} \qquad ( 52 )$$

$$[ Formula 53 ]$$

$${I}_{m} = \{ i \vert {x}_{i} = 1 ∧ {y}_{i} = 0 \} \qquad ( 53 )$$

$$[ Formula 54 ]$$

$${I}_{n} = \{ i \vert i is connected to divisive normalization similarity calculator \} \qquad ( 54 )$$

$$[ Formula 55 ]$$

$${I}_{d} = \{ i \vert i ∈ {I}_{n} ∧ i ∈ {I}_{m} \} \qquad ( 55 )$$

$$[ Formula 56 ]$$

$${I}_{l} = \{ i \vert i ∈ {I}_{n} ∧ i ∈ {I}_{k} \} \qquad ( 56 )$$

I_{N} is a set of inputs in which the input value is 1 in the learning phase. Iₖ is a set of inputs in which the input values of the learning phase and the similarity determination phase are 0 and 1, respectively. Iₘ is a set of inputs in which the input values of the learning phase and the similarity determination phase are 1 and 0, respectively. Iₙ is a set of inputs connected to the divisive normalization similarity calculator. I_{d} is a set of inputs included in both sets Iₙ and Iₘ. Iₗ is a set of inputs included in both sets Iₙ and Iₖ.

Now, N, k, m, n, d, and l are the numbers of elements included in the sets I_{N}, Iₖ, Iₘ, Iₙ, I_{d}, and I₁, respectively. At this time, the number of inputs in which the input value becomes 1 in at least one of the learning phase and the similarity determination phase is N+k. Iₙ the divisive normalization similarity determination method, as can be seen from Formula (7), only the N+k inputs affect the similarity. Thus, focusing on the N+k inputs, the connection status of the inputs to the divisive normalization similarity calculator is analyzed. Since the number of inputs connected to the divisive normalization similarity calculator is n, the number of patterns when n of the N+k inputs are connected is expressed by the formula described below.

$$[ Formula 57 ]$$

$${}_{N + k} {C}_{n} \qquad ( 57 )$$

Secondly, the number of inputs in which the input value is 1 in both the learning phase and the similarity determination phase is N−m. In addition, among them, n−d−l are input to the divisive normalization similarity calculator. Thus, the number of patterns is expressed by the formula described below.

$$[ Formula 58 ]$$

$${}_{N - m} {C}_{n - d - l} \qquad ( 58 )$$

Thirdly, there are m inputs in which the input values of the learning phase and the similarity determination phase are 1 and 0, respectively, and among them, d are input to the divisive normalization similarity calculator. Thus, the number of patterns is expressed by the formula described below.

$$[ Formula 59 ]$$

$${}_{m} {C}_{d} \qquad ( 59 )$$

Fourthly, there are k inputs in which the input values of the learning phase and the similarity determination phase are 0 and 1, respectively, and among them, 1 are input to the divisive normalization similarity calculator. Thus, the number of patterns is expressed by the formula described below.

$$[ Formula 60 ]$$

$${}_{k} {C}_{l} \qquad ( 60 )$$

Then, the probability that the numbers of elements of the sets Iₘ, Iₙ, and I_{d} in the input patterns connected to the divisive normalization similarity calculator are m, n, and d, respectively, are expressed by the formula described below.

$$[ Formula 61 ]$$

$$\frac{{}_{N - m} {C}_{n - d - l} \cdot {}_{m} {C}_{d} \cdot {}_{k} {C}_{l}}{{}_{N + k} {C}_{n}} \qquad ( 61 )$$

At this time, the similarity calculated by the divisive normalization similarity determination method is as described below.

$$[ Formula 62 ]$$

$$\frac{2 {n}_{11}}{2 {n}_{11} + {n}_{10} + {n}_{01}} = \frac{2 ( n - d - l )}{2 ( n - d - l ) + d + l} = \frac{2 ( n - d - l )}{2 n - d - l} \qquad ( 62 )$$

When this value is represented as S(n, d, l) as the activation degree and the activation function is represented as f(a), the output can be calculated as f(S(n, d, l)). From the above, the output of the divisive normalization similarity calculator is expressed by the formula described below.

$$[ Formula 63 ]$$

$${\sum }_{C} \frac{{}_{N - m} {C}_{n - d - l} \cdot {}_{m} {C}_{d} \cdot {}_{k} {C}_{l}}{{}_{N + k} {C}_{n}} f ( S ( n , d , l ) ) \qquad ( 63 )$$

Here, C (C representing the addition range described below symbol Σ) is a set of combinations of n, d, and l that simultaneously satisfy the following conditions with a threshold of the activation function as t.

The number of inputs in which the value in the learning phase is 1 is N, and some of them is 0 in the similarity determination phase. Since the number is m, the following inequality holds.

$$[ Formula 64 ]$$

$$0 ≦ m ≦ N \qquad ( 64 )$$

The number of inputs in which the value of the learning phase is 1 and the value of the similarity determination phase is 0 is m as a whole. Since some of them are connected to the divisive normalization similarity calculator and its number is d, the following inequality holds.

$$[ Formula 65 ]$$

$$0 ≦ d ≦ m \qquad ( 65 )$$

The number of inputs in which the value of the learning phase is 0 and the value of the similarity determination phase is 1 is k as a whole. Since some of them are connected to the divisive normalization similarity calculator and its number is 1, the following inequality holds.

$$[ Formula 66 ]$$

$$0 ≦ l ≦ k \qquad ( 66 )$$

The number of inputs connected to the divisive normalization similarity calculator is n. Since some of them are d, 1, and d+l, the following three inequalities hold.

$$[ Formula 67 ]$$

$$0 ≦ d ≦ l ≦ n \qquad ( 67 )$$

$$[ Formula 68 ]$$

$$0 ≦ d ≦ n \qquad ( 68 )$$

$$[ Equation 69 ]$$

$$0 ≦ l ≦ n \qquad ( 69 )$$

The number of inputs in which the value of the learning phase is 1 and the value of the similarity determination phase is 1 is N−m as a whole. Since some of them are connected to the divisive normalization similarity calculator and its number is n−d−l, the following inequality holds.

$$[ Formula 70 ]$$

$$n - d - l ≦ N - m \qquad ( 70 )$$

In order for the divisive normalization similarity calculator to be in the firing state and to have an output value larger than 0, its activation degree must exceed the threshold t. Thus, the following inequality holds.

$$[ Formula 71 ]$$

$$S ( n , d , l ) ≧ τ \qquad ( 71 )$$

In the above discussion regarding the expected value of the output calculated by the divisive normalization similarity calculator, the expected value was obtained using n as a constant. Now, an expected value of an output in a case where each input is connected to the divisive normalization similarity calculator with a constant probability p is obtained. The inputs focused on in the discussion so far are inputs in which the value is 1 in at least one of the learning phase and the similarity determination phase, the total number of which is N+k. Among them, the probability that the n inputs are connected to the divisive normalization similarity calculator is expressed by the following formula.

$$[ Formula 72 ]$$

$${}_{N + k} {C}_{n} \cdot {{p}^{n} ( 1 - p )}^{N + k - n} \qquad ( 72 )$$

Thus, from Formulas (63) and (72), the expected value of the output of the divisive normalization similarity calculator is expressed by the formula described below.

$$[ Formula 73 ]$$

$${\sum }_{n = 0}^{N + k} [ {}_{N + k} {C}_{n} \cdot {{p}^{n} ( 1 - p )}^{N + k - n} \cdot {\sum }_{C} \frac{{}_{N - m} {C}_{n - d - l} \cdot {}_{m} {C}_{d} \cdot {}_{k} {C}_{l}}{{}_{N + k} {C}_{n}} f ( S ( n , d , l ) ) ] \qquad ( 73 )$$

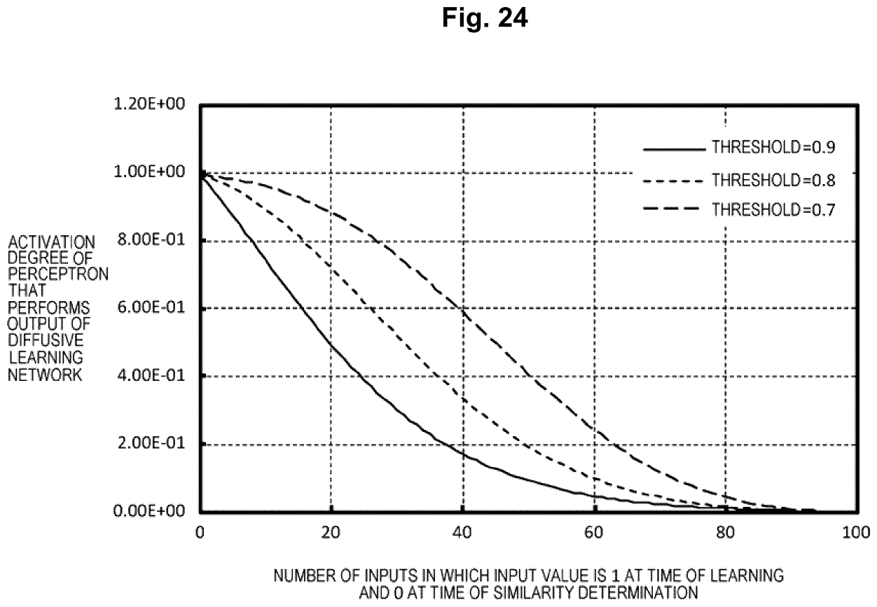

Since Formula (73) represents the expected value of the output of the divisive normalization similarity calculator, the activation degree of the perceptron (013 in FIG. 5) that performs the output of the diffusive information network is proportional to Formula (73) since the activation degree is obtained by adding the output of the divisive normalization similarity calculator. An effect of the diffusive information network will be described below with reference to FIGS. 24 to 35.

### [Processing of Learning Phase and Similarity Determination Phase of Diffusive Learning Network]

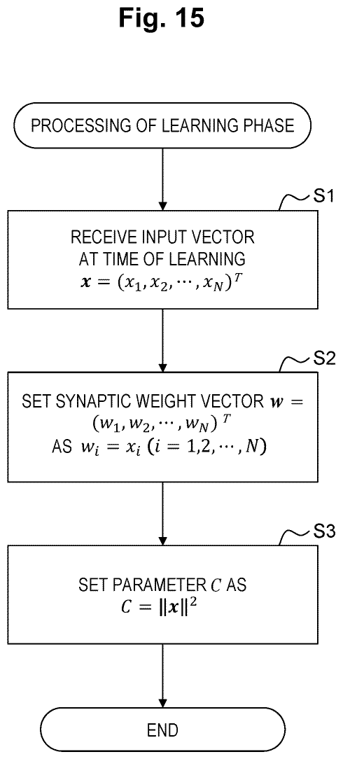

Hereinafter, processing of the learning phase and the similarity determination phase of the diffusive learning network will be described with reference to FIGS. 15 to 23.

### Example 1

<Example 1> describes a first example of the divisive normalization similarity determination method.

First, learning phase processing of the diffusive learning network will be described.

FIG. 15 is a flowchart illustrating processing in the learning phase of the divisive normalization similarity calculator.

In step S1, the divisive normalization similarity calculator 100 (FIGS. 2 to 14) receives the input vector x=(x₁, x₂, . . . , x_{N})^{T} in the learning phase.

In step S2, the divisive normalization similarity calculator 100 sets the synaptic weight vector w=(w₁, w₂, . . . , w_{N})^{T} as wᵢ=xᵢ (i=1, 2, . . . , N).

In step S3, the divisive normalization similarity calculator 100 calculates and sets a parameter C used in the similarity determination phase as C=∥x∥².

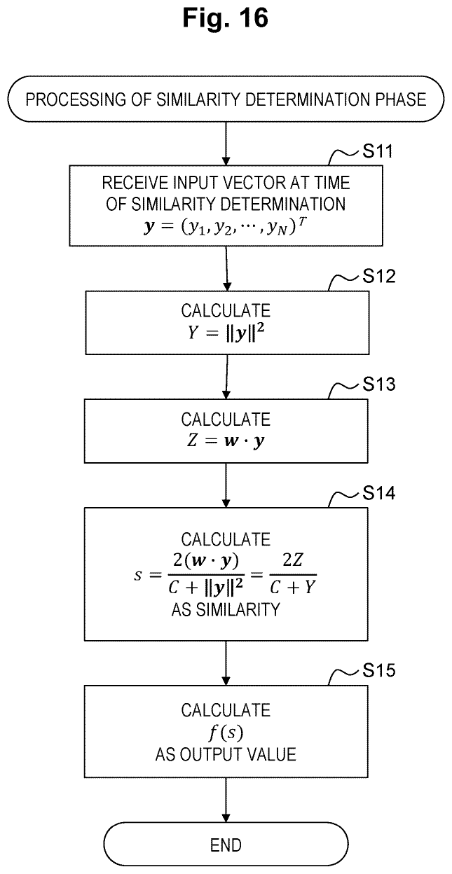

After the learning phase of FIG. 15, the operation of the similarity determination phase illustrated in FIG. 16 is performed.

Next, similarity determination phase processing of the diffusive learning network will be described.

FIG. 16 is a flowchart illustrating processing in the similarity determination phase of the divisive normalization similarity calculator.

In step S11, the divisive normalization similarity calculator 100 receives the input vector y=(y₁, y₂, . . . , y_{N})^{T} in the similarity determination phase.

In step S12, the divisive normalization similarity calculator 100 calculates Y=∥y∥² necessary for calculating the similarity.

In step S13, the divisive normalization similarity calculator 100 calculates Z=w·y necessary for calculating the similarity.

In step S14, the divisive normalization similarity calculator 100 calculates similarity s according to Formula (74) described below using the parameter C calculated in step S3 of FIG. 15 in addition to the calculated Y and Z.

$$[ Formula 74 ]$$

$$s = \frac{2 ( w \cdot y )}{C + {‖ y ‖}^{2}} = \frac{2 Z}{C + Y} \qquad ( 74 )$$

In step S15, the divisive normalization similarity calculator 100 inputs the calculated similarity s to the activation function f(a) to obtain an output value f(s). The output value f(s) is an output of the divisive normalization similarity calculator 100.

Here, the activation function may be a frequently used ReLU or a step function. In addition, a simple linear function, a linear function with a threshold (Threshold-linear), a sigmoid function, and Radial-basis described in Non Patent Literature 2 may be used.

In addition, in these functions, a function having a threshold of 0 may be a function using any other value as a threshold.

### Example 2

<Example 2> describes a second example of the divisive normalization similarity determination method.

In <Example 2>, an example of efficiently calculating an inner product ((w·y) in Formula (74) and square of norm (C=∥x∥² and ∥y∥² in Formula (74))) between vectors included in Formula (74) in <Example 1> will be described.

Now, it is assumed that there are vectors v=(v₁, v₂, . . . , v_{N})^{T} and u=(u₁, u₂, . . . , u_{N})^{T}. Then, when vᵢϵ{0,1} and uᵢϵ{0,1}, an inner product (u·v) is (u·v)=v₁u₁+v₂u₂+ . . . +u_{N}v_{N}. Since vᵢϵ{0, 1} and u₁ϵ{0, 1}, vᵢuᵢ is equal to the logical product of vᵢ and uᵢ, and thus (u·v) is a value obtained by adding the logical product of vᵢ and uᵢ over all i.

In addition, since the square of the norm of the vector v=(v₁, v₂, . . . , v_{N})^{T} is ∥v∥²=v₁v₁+v₂v₂+ . . . +v_{N}v_{N} and vᵢϵ{0, 1}, ∥v∥²=v₁+v₂+ . . . +v_{N} is obtained. Thus, ∥v∥² is a value obtained by adding vᵢ over all i.

<Example 2> is an example in which the above-described calculation method of the inner product between vectors and the square of the norm of the vector is applied.

First, learning phase processing of the diffusive learning network will be described.

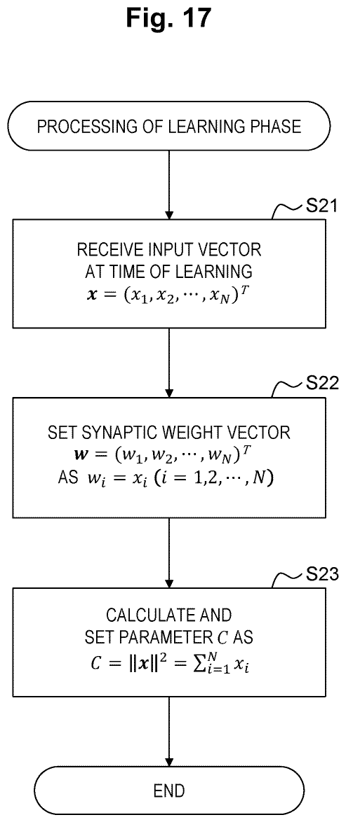

FIG. 17 is a flowchart illustrating processing in the learning phase of the divisive normalization similarity calculator. Steps that perform the same processing as those in FIG. 15 are denoted by the same reference numerals, and description thereof is omitted.

In step S21, the divisive normalization similarity calculator 100 receives the input vector x=(x₁, x₂, . . . , x_{N})^{T} in the learning phase.

In step S22, the divisive normalization similarity calculator 100 sets the synaptic weight vector w=(w₁, w₂, . . . , w_{N})^{T} as wᵢ=xᵢ(i=1, 2, . . . , N).

In step S23, the divisive normalization similarity calculator 100 calculates a parameter C=∥x∥² used in the similarity determination phase as C=Σ^{N}ᵢ=₁xᵢ.

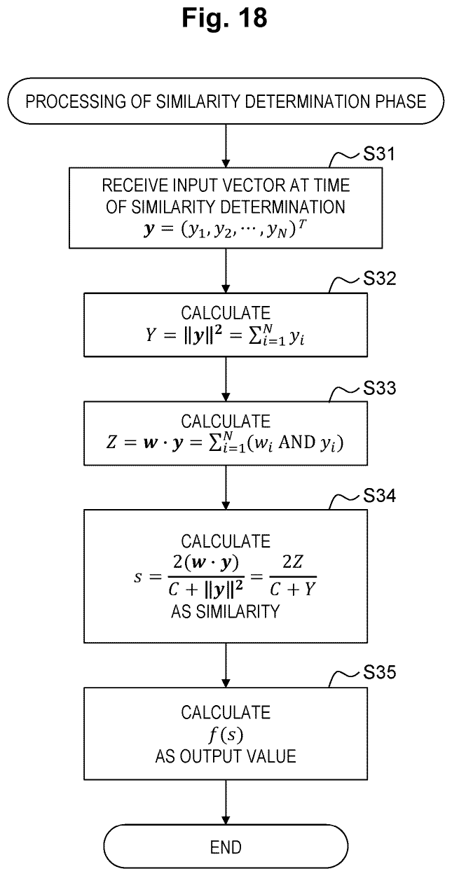

After the learning phase of FIG. 17, the operation of the similarity determination phase illustrated in FIG. 18 is performed.

Next, similarity determination phase processing of the diffusive learning network will be described.

FIG. 18 is a flowchart illustrating processing in the similarity determination phase of the divisive normalization similarity calculator.

In step S31, the divisive normalization similarity calculator 100 receives the input vector y=(y₁, y₂, . . . , y_{N})^{T} in the similarity determination phase.

In step S32, the divisive normalization similarity calculator 100 calculates Y=∥y∥² necessary for calculating the similarity. At this time, calculation is performed as Y=Σ^{N}ᵢ=₁yᵢ.

In step S33, the divisive normalization similarity calculator 100 calculates Z=w·y necessary for calculating the similarity. At this time, calculation is performed as Z=Σ^{N}ᵢ=₁wᵢANDyᵢ. Here, wᵢANDyᵢ represents a logical conjunction operation of wᵢ and yᵢ.

In step S34, the divisive normalization similarity calculator 100 calculates similarity s according to Formula (74) using the parameter C calculated in step S23 of FIG. 17 in addition to the calculated Y and Z.

In step S35, the divisive normalization similarity calculator 100 inputs the calculated similarity s to the activation function f(a) to obtain an output value f(s). The output value f(s) is an output of the divisive normalization similarity calculator 100.

Here, the activation function may be a frequently used ReLU or a step function. In addition, a simple linear function, a linear function with a threshold (Threshold-linear), a sigmoid function, and Radial-basis described in Non Patent Literature 2 may be used.

In addition, in these functions, a function having a threshold of 0 may be a function using any other value as a threshold.

### Example 3

<Example 3> describes a third example of the divisive normalization similarity determination method.

<Example 3> describes an implementation method in a case where the divisive normalization similarity calculation method and the diffusive learning network are combined.

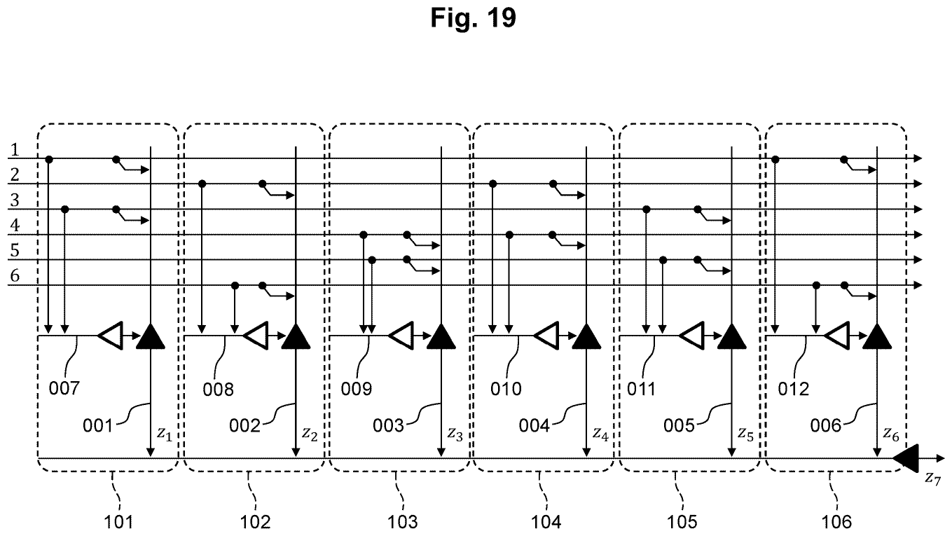

FIG. 19 is a diagram illustrating a neural network in a case where the divisive normalization similarity calculation method and the diffusive learning network are combined.

In the diffusive learning network, one or more divisive normalization similarity calculators are included. First, the presence or absence of connection of an input to each divisive normalization similarity calculator is determined. In the determination of the presence or absence of the connection of the input, the combination of the inputs to each divisive normalization similarity calculator is made as different as possible. For example, the presence or absence of connection may be determined with a certain probability for each combination of the input and the divisive normalization similarity calculator. In the case of FIG. 17, six divisive normalization similarity calculators 101 to 106 (hereinafter, referred to as the units) are included. All or some of all inputs are connected to each of the units 101 to 106. Therefore, in general, each of the units 101 to 106 receives a combination of different inputs as an input.

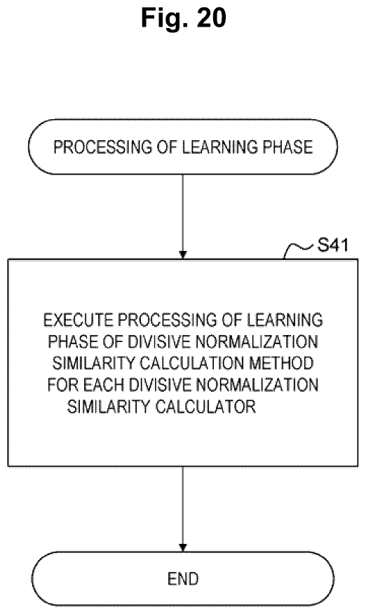

Therefore, in <Example 3>, regarding the input vector of the learning phase, the synaptic weight vector, and the input vector of the similarity determination phase of each unit, the processing (FIGS. 15 and 17) of the learning phase of <Example 1> and <Example 2> is performed only for the connected components. This processing will be described with reference to FIG. 20.

FIG. 20 is a flowchart illustrating processing in the learning phase of <Example 3>.

Among inputs 1, 2, 3, 4, 5, and 6, only 1 and 3 are connected to the unit 101 illustrated in FIG. 19.

In step S41, the processing of the learning phase of the divisive normalization similarity determination method is executed for each divisive normalization similarity calculator. Specifically, it is as described below.

In the learning phase, when the entire input vector is x=(x₁, x₂, x₃, x₄, x₅, x₆), the input vector x₁ of the learning phase to the unit 101 is x₁=(x₁, x₃)^{T}. As a result, the synaptic weight vector wᵢ becomes w₁=(w₁, w₃)^{T}=x₁. In addition, when the constant C of the unit 101 is C₁, C₁=∥x₁∥² is obtained as in <Example 1> and <Example 2>. Thereafter, synaptic weight vectors w₂, w₃, w₄, w₅, and w₆ and constants C₂, C₃, C₄, C₅, and C₆ are similarly obtained for the units 102 to 106.

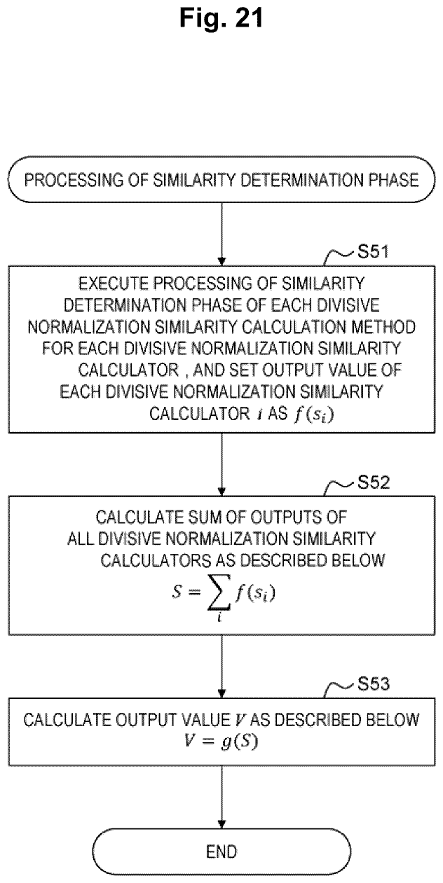

After the learning phase of FIG. 20, the operation of the similarity determination phase illustrated in FIG. 21 is performed.

Next, similarity determination phase processing of <Example 3> will be described.

FIG. 21 is a flowchart illustrating processing in the similarity determination phase of <Example 3>.

In step S51, the processing of the similarity determination phase of each divisive normalization similarity determination method is executed for each divisive normalization similarity calculator, and the output value of each divisive normalization similarity calculator i is set as f(sᵢ). Specifically, it is as described below.

The unit 101 will be described as a representative. In the similarity determination phase, when the entire input vector is y=(y₁, y₂, y₃, y₄, y₅, y₆)^{T}, the input vector yᵢ of the similarity determination phase to the unit 101 is y₁=(y₁, y₃)^{T}. Using these vectors, similarity s₁ of the unit 101 is calculated in the same manner as in <Example 1> and <Example 2> as in the formula described below.

$$[ Formula 75 ]$$

$${s}_{1} = \frac{2 ( {w}_{1} \cdot {y}_{1} )}{{C}_{1} + {‖ {y}_{1} ‖}^{2}} \qquad ( 75 )$$

Thereafter, the similarity is similarly obtained for the units 102 to 106. Next, the output value of the unit is calculated as f(sᵢ).

Here, f(x) represents an activation function. The activation function may be a frequently used ReLU or a step function. In addition, a simple linear function, a linear function with a threshold (Threshold-linear), a sigmoid function, and Radial-basis described in Non Patent Literature 2 may be used.

In addition, in these functions, a function having a threshold of 0 may be a function using any other value as a threshold.

In step S52, the sum (the value obtained by aggregating the outputs calculated in each unit) S of the outputs of the all divisive normalization similarity calculators is calculated as described below.

$$[ Formula 76 ]$$

$$S = {\sum }_{i} f ( {s}_{i} ) \qquad ( 76 )$$

In step S53, based on the obtained S, an output value V=g(S) of the diffusive learning network is calculated by inputting to an activation function g(⋅). Here, the activation function may be a frequently used ReLU or a step function. In addition, a simple linear function, a linear function with a threshold (Threshold-linear), a sigmoid function, and Radial-basis described in Non Patent Literature 2 may be used. Additionally, the activation function may be k-Winner-Take-All (kWTA) or Winner-Take-All (WTA) described in Non Patent Literature 3. Further, in these functions, a function having a threshold of 0 may be a function using any other value as a threshold.

### Example 4

<Example 4> describes a fourth example of the divisive normalization similarity determination method.

<Example 4> describes an implementation method in a case where the divisive normalization similarity calculation method and the diffusive learning network are combined.

In <Example 4>, as described in <Example 3>, the similarity is not obtained by individually creating the input vector of the learning phase, the synaptic weight vector, and the input vector of the similarity determination phase for each unit, but the similarity is calculated using the input vector of the learning phase, the synaptic weight vector, and the input vector of the similarity determination phase related to the entire input.

First, the presence or absence of connection of an input to each divisive normalization similarity calculator is determined. In the determination of the presence or absence of the connection of the input, the combination of the inputs to each divisive normalization similarity calculator is made as different as possible. For example, the presence or absence of connection may be determined with a certain probability for each combination of the input and the divisive normalization similarity calculator.

Secondly, a matrix is created that represents which input is connected to which divisive normalization similarity calculator. Hereinafter, this matrix is referred to as a connection matrix. A component of i-th row and j-th column of the connection matrix is represented as Xᵢⱼ, and this component represents whether or not the input i is connected to a unit j. Xᵢⱼ=1 and Xᵢⱼ=0 represent that the input i is connected to the unit j and that the input i is not connected to the unit j, respectively. The connection matrix X is expressed as described below.

$$[ Formula 77 ]$$

$$X = ( \begin{matrix}1 & 0 & 0 & 0 & 0 & 1 \\ 0 & 1 & 0 & 1 & 0 & 0 \\ 1 & 0 & 0 & 0 & 1 & 0 \\ 0 & 0 & 1 & 1 & 0 & 0 \\ 0 & 0 & 1 & 0 & 1 & 0 \\ 0 & 1 & 0 & 0 & 0 & 1\end{matrix} ) \qquad ( 77 )$$

Here, for the following description, a vector including components of j columns of the connection matrix is represented by Xⱼ.

Thirdly, when the input vector of the learning phase is x=(x₁, x₂, x₃, x₄, x₅, x₆)^{T}, w=x is set as the synaptic weight vector w. w=(w₁, w₂, w₃, w₄, w₅, w₆)^{T}.

Here, assuming that a Hadamard product of vectors v and u is represented as vou for two vectors v=(v₁, v₂, . . . , v_{N})^{T} and u=(u₁, u₂, . . . , u_{N})^{T} in general, vou=(v₁u₁, v₂u₂, . . . v_{N}u_{N})^{T} is obtained. Now, when each component of the vectors v and u is represented by binary values of 0 and 1, focusing on each component i, the Hadamard product vᵢuᵢ can be considered as a logical product when vᵢ and uᵢ are considered as logical variables. Thus, the processing of the Hadamard product described below may be calculated as a logical product for each component.

Using the expression of the Hadamard product, w₁·y₁/C₁, and ∥y₁∥² in Formula (75) are (woX₁)·y, c₁=∥x₁∥²=∥xoX₁∥², and ∥y₁∥²=∥yoX₁∥², respectively. Thus, fourthly, in the similarity determination phase, similarity sᵢ calculated by the unit i can be calculated as described below.

$$[ Formula 78 ]$$

$${s}_{i} = \frac{2 ( ( w ∘ {χ}_{j} ) \cdot y )}{{C}_{i} + {‖ y ∘ {χ}_{j} ‖}^{2}} \qquad ( 78 )$$

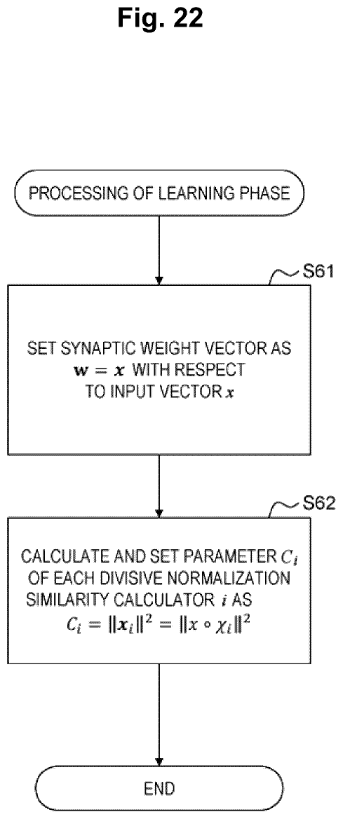

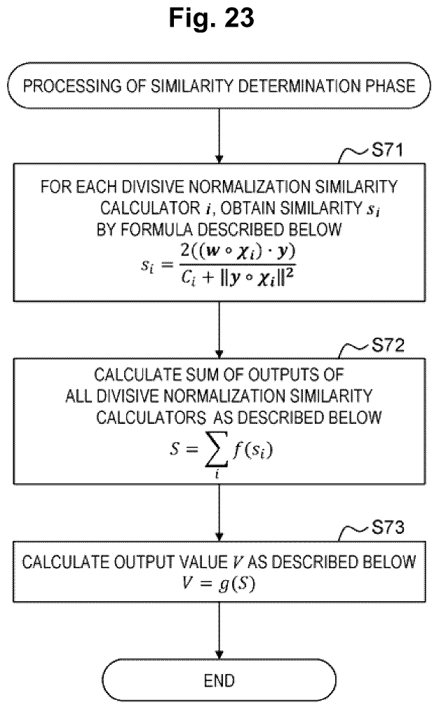

The processing of the learning phase and the similarity determination phase based on the above is illustrated in FIGS. 22 and 23, respectively.

FIG. 22 is a flowchart illustrating processing in the learning phase of <Example 4>.

In the learning phase, as described above, the synaptic weight vector w is set as w=x by using the input vector x of the learning phase (step S61).

In step S62, a parameter C₁ of each divisive normalization similarity calculator i is calculated and set as C₁=∥xᵢ∥²=∥xOXᵢ∥².

Next, similarity determination phase processing of <Example 4> will be described.

FIG. 23 is a flowchart illustrating processing in the similarity determination phase of <Example 4>.

In step S71, for each divisive normalization similarity calculator i, the similarity sᵢ is obtained by Formula (78).

In step S72, the sum S of the outputs of the all divisive normalization similarity calculators is calculated by Formula (76).

In step S73, based on the obtained S, an output value V=g(S) of the diffusive learning network is calculated by inputting to an activation function g(⋅).

Note that steps S72 and S73 in FIG. 23 are the same as steps S52 and S53 in FIG. 21 of <Example 3>.

In FIGS. 22 and 23, the relationship between the “learning phase” and the “similarity determination phase” in the divisive normalization similarity calculator i will be described.

In the diffusive learning network 1000 of the first embodiment, a plurality of the divisive normalization similarity calculators i having some or all of inputs with respect to a plurality of inputs of the diffusive learning network is connected, and further, outputs of the respective divisive normalization similarity calculators i are input to a perceptron. Then, the divisive normalization similarity calculator i receives one or more input values, in which one of a value L and a value H is input to each input, when a value of the i-th input in the learning phase is represented as xᵢ and a value of the i-th input in the similarity determination phase is represented as yᵢ, a value wᵢ is assigned to the i-th input, one of the two values of the value L and the value H is set to the value wᵢ, in the learning phase, sets the value wᵢ of a weight assigned to the i-th input to the value of xᵢ, and in the similarity determination phase, performs similarity calculation that calculates the number of inputs in which the value of xᵢ is the value H, the number of inputs in which both wᵢ and yᵢ are the value H, and the number of inputs in which the value of yᵢ is the value H, and calculates a value obtained by dividing the number of inputs in which both wᵢ and yᵢ are the value H by a value obtained by adding the number of inputs in which yᵢ is the value H to the number of inputs in which wᵢ is the value H as similarity representing the degree of similarity.

In addition, in the present divisive normalization similarity determination method, in the similarity determination phase, the divisive normalization similarity is calculated using Formula (6) described above in which the operation caused by the phenomenon called the shunt effect of the nerve cell is incorporated into the model of the perceptron.

Here, the “learning phase” described above corresponds to steps S1 and S2 in FIG. 15, and the “similarity determination phase” described above corresponds to step S3 in FIG. 15 and steps S11 to S15 in FIG. 16. That is, the “learning phase” is calculated in steps S1 and S2 of FIG. 15, and the “similarity determination phase” is calculated in step S3 of FIG. 15 and steps S11 to S15 of FIG. 16.

Formulas (7) to (10) described above are obtained by dividing and modifying Formula (6) described above by cases. By analyzing these formulas, it can be seen that the value calculated by the divisive normalization similarity calculation method is an approximate value of cosine similarity. That is, the similarity calculated by the divisive normalization similarity calculation method can calculate the similarity more accurately than the existing technology. As a result, by accurately measuring the similarity between the information stored in the learning phase and the information input to the similarity determination phase by the divisive normalization similarity calculation method, it is possible to remove the difference in information and a discrepancy of the degree of similarity to be calculated in the prior art and to perform similarity calculation on the basis of the degree of similarity. Hereinafter, a specific description will be given.

### [Effects of Diffusive Learning Network]

Effects of the diffusive learning network of <Example 1> to <Example 4> will be described.

Since Formula (73) described above represents the expected value of the output of the divisive normalization similarity calculator, the activation degree of the perceptron (013 in FIG. 5) that performs the output of the diffusive information network is proportional to Formula (73) since the activation degree is obtained by adding the output of the divisive normalization similarity calculator. An effect of the diffusive information network will be described with reference to FIGS. 24 to 35.

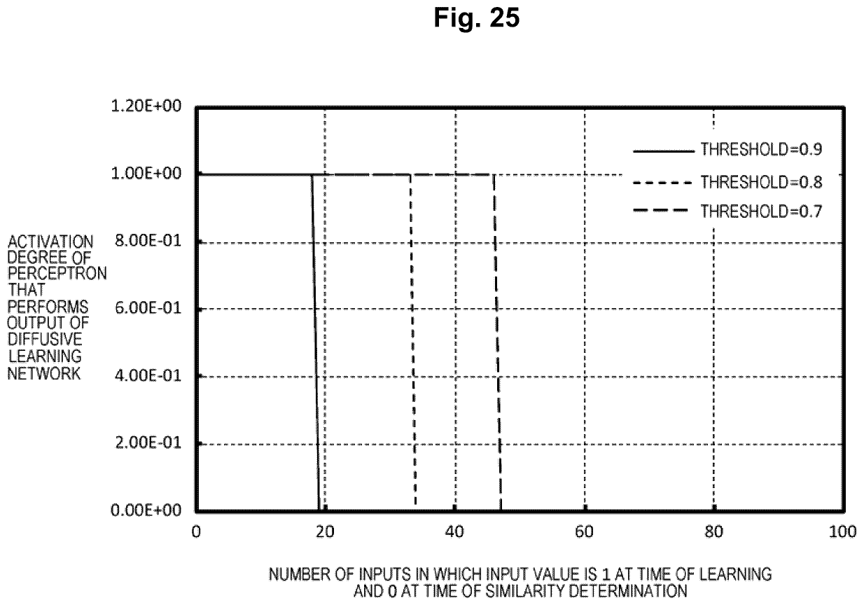

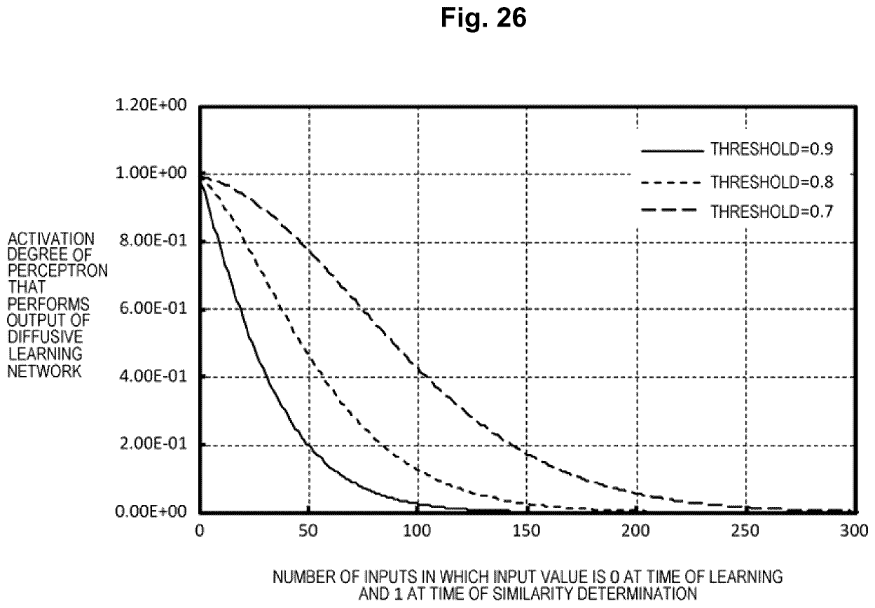

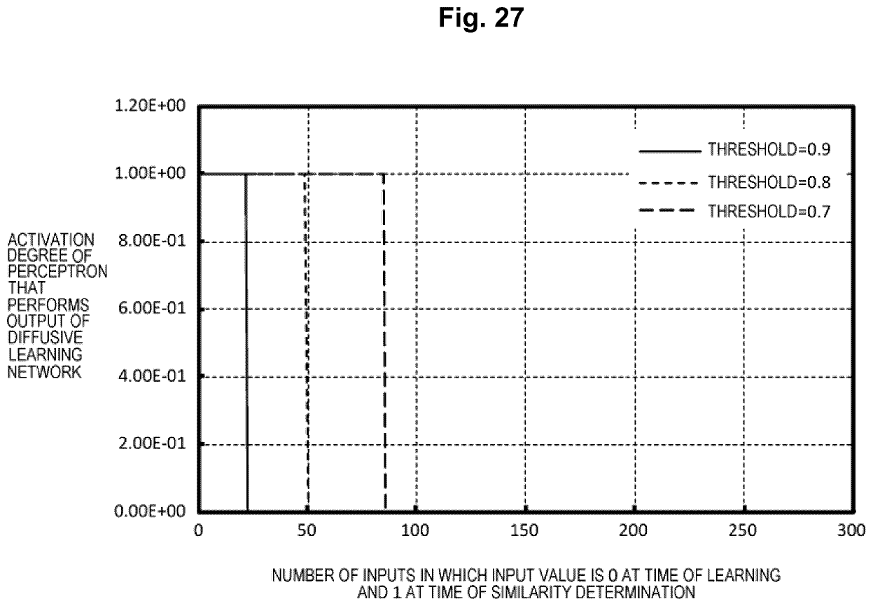

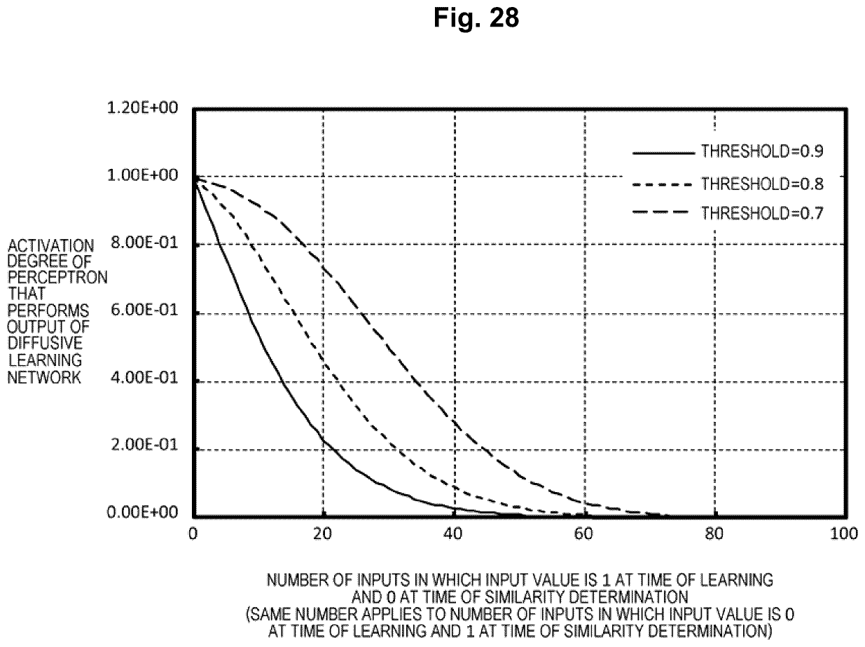

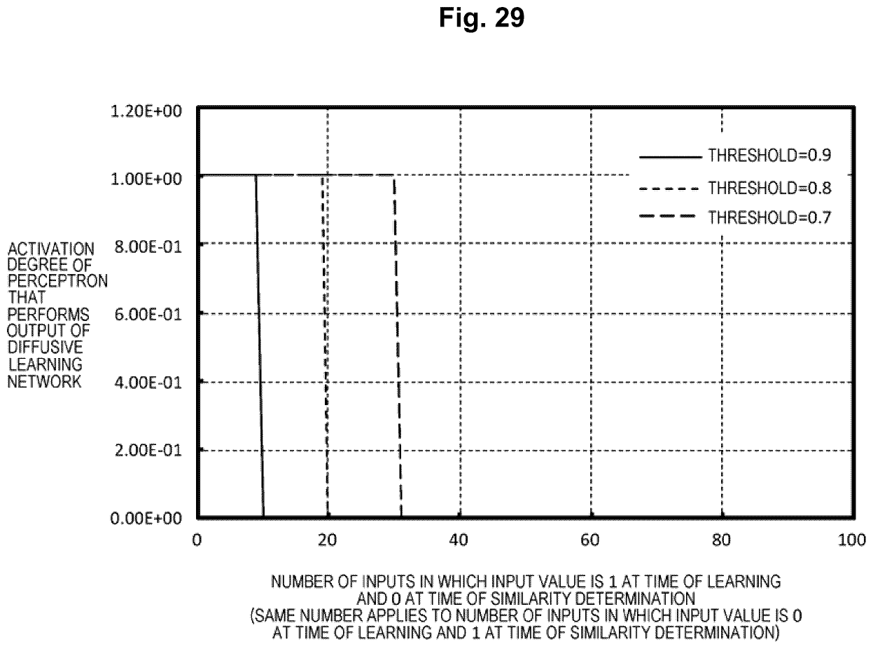

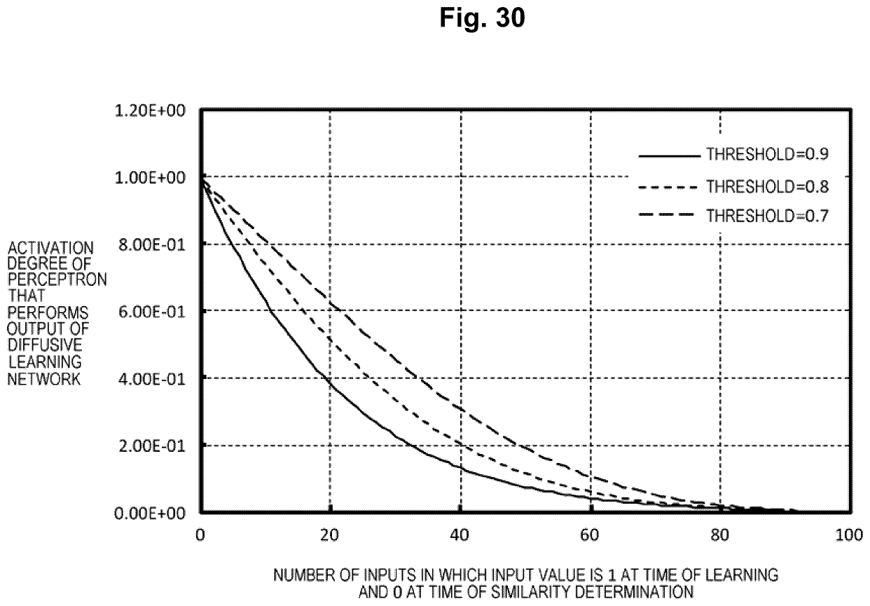

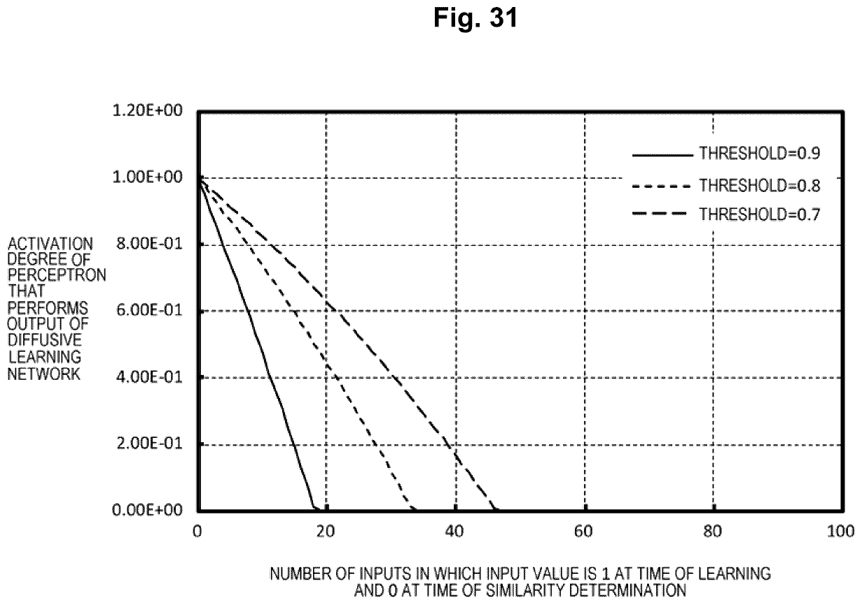

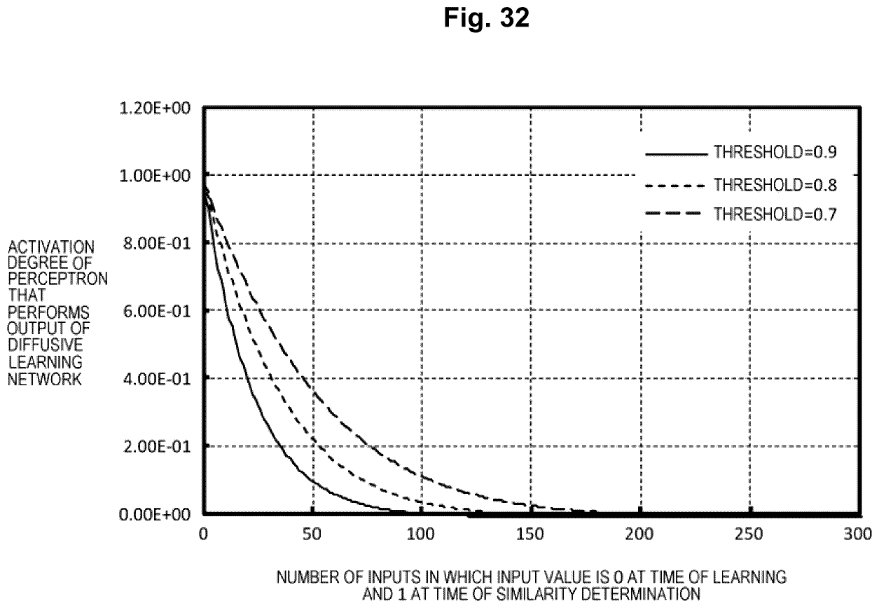

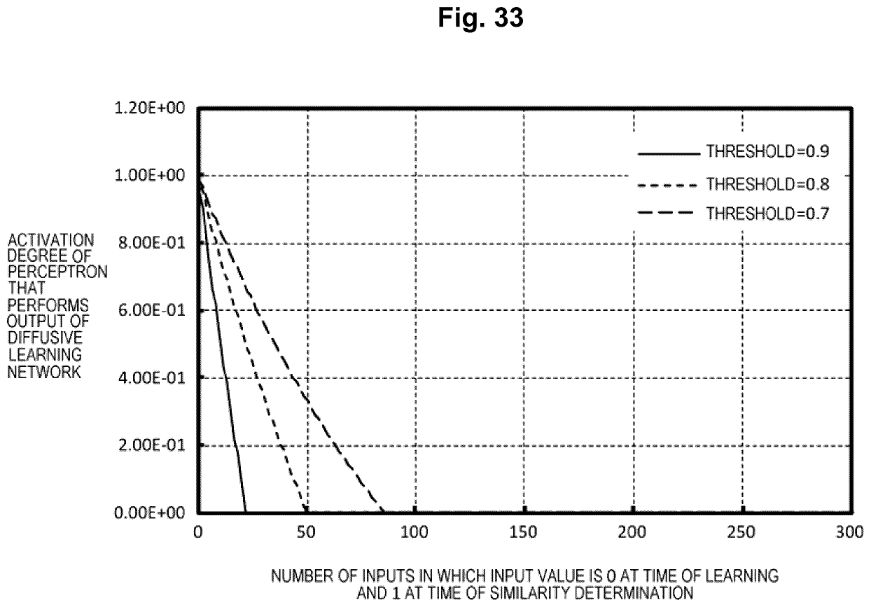

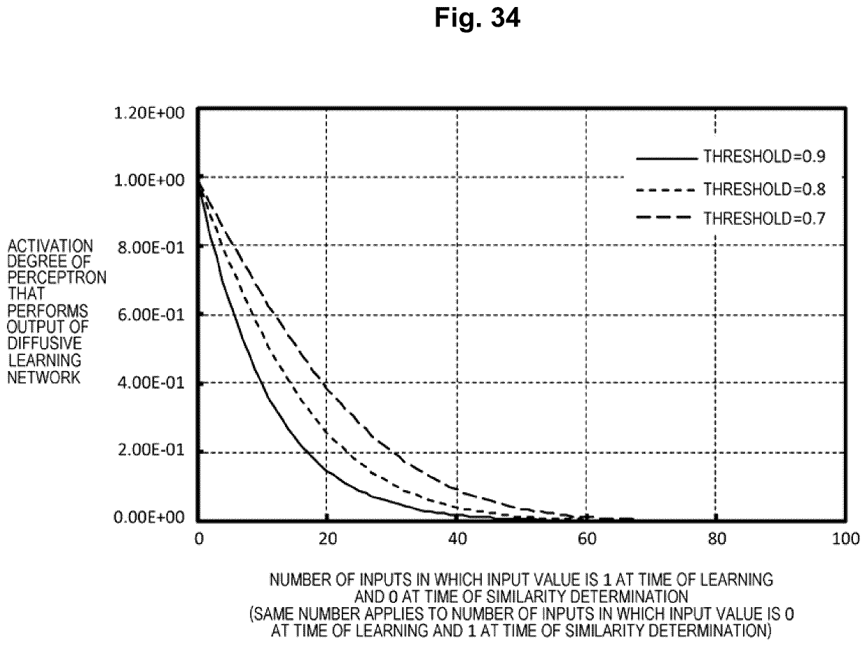

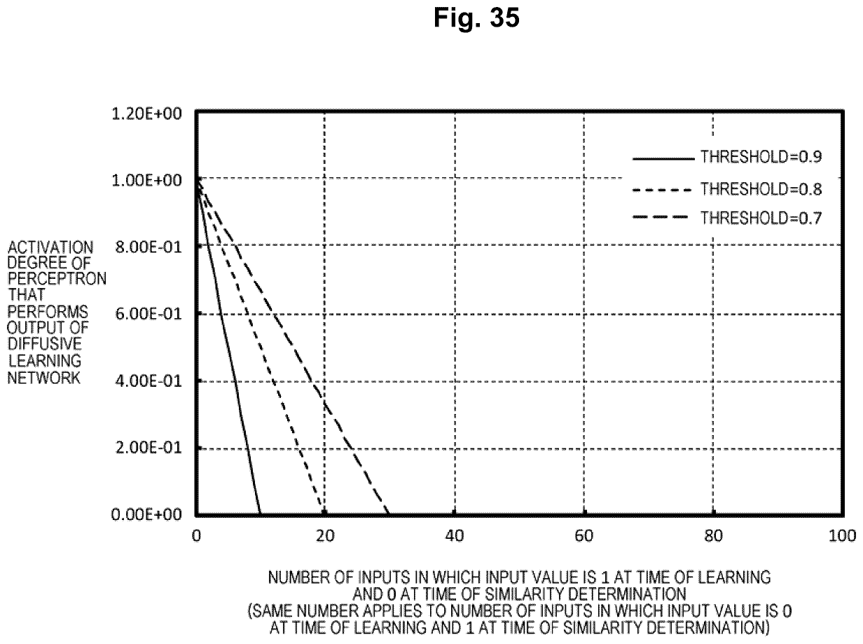

FIG. 24 is a diagram illustrating the effect of the diffusive learning network (in the case of a step function, p=0.05, and k=0), FIG. 25 is a diagram illustrating the effect of the diffusive learning network (in the case of a step function, p=1.0, and k=0), FIG. 26 is a diagram illustrating the effect of the diffusive learning network (in the case of a step function, p=0.05, and m=0), FIG. 27 is a diagram illustrating the effect of the diffusive learning network (in the case of a step function, p=1.0, and m=0), FIG. 28 is a diagram illustrating the effect of the diffusive learning network (in the case of a step function, p=0.05, and m=k), and FIG. 29 is a diagram illustrating the effect of the diffusive learning network (in the case of a step function, p=1.0, and m=k). FIG. 30 is a diagram illustrating the effect of the diffusive learning network (in the case of a linear function, p=0.05, and k=0), FIG. 31 is a diagram illustrating the effect of the diffusive learning network (in the case of a linear function, p=1.0, and k=0), FIG. 32 is a diagram illustrating the effect of the diffusive learning network (in the case of a linear function, p=0.05, and m=0), FIG. 33 is a diagram illustrating the effect of the diffusive learning network (in the case of a linear function, p=1.0, and m=0), FIG. 34 is a diagram illustrating the effect of the diffusive learning network (in the case of a linear function, p=0.05, and m=k), and FIG. 35 is a diagram illustrating the effect of the diffusive learning network (in the case of a linear function, p=1.0, and m=k).

FIG. 24 is, in the above description, an effect of the diffusive information network when m is changed with the activation function of the perceptron in the divisive normalization similarity calculator 100 as a step function, N=100, p=0.05, and k=0. Note that a case where the threshold of the activation function is 0.9, 0.8, and 0.7 is illustrated.

The vertical axis in FIG. 24 is a value (a value obtained by dividing the activation degree of the perceptron that performs output of the diffusive learning network by the number of divisive normalization similarity calculators 100, and is a value calculated by Formula (73) described above) obtained by normalizing the activation degree of the perceptron that performs output of the diffusive information network. The horizontal axis in FIG. 24 represents the number (value of m) of inputs in which the value is 1 at the time of learning and 0 at the time of similarity determination. That is, when the horizontal axis is 0, it indicates that the same input as that at the time of learning comes at the time of similarity determination, and as the value of the horizontal axis increases, the difference between the inputs at the time of learning and at the time of similarity determination increases.

As can be seen from FIG. 24, as the difference between the inputs at the time of learning and at the time of similarity determination increases, the activation degree of the perceptron that performs output of the diffusive learning network gradually decreases, and it can be seen that the similarity between the inputs at the time of learning and at the time of similarity determination can be accurately determined.

FIG. 25 is a diagram illustrating an effect of the diffusive information network when p=1.0 with respect to FIG. 24. In this case, since all inputs are connected to all divisive normalization similarity calculators in a similar manner, the situation is similar to when the diffusive learning network is not used. The vertical axis and the horizontal axis in FIG. 25 are the same as those in FIG. 24. As can be seen from FIG. 25, from 0 on the horizontal axis to a value determined by the threshold of the activation function of the perceptron in the divisive normalization similarity calculator, 1 on the vertical axis, and 0 thereafter. Therefore, as compared with the case where the diffusive information network is used with p<1.0, it can be seen that the range in which the similarity of the inputs at the time of learning and at the time of similarity determination can be determined is narrowed, and the degree of similarity is determined by only two values of 1 and 0, resulting in rough determination.

FIGS. 26 and 27 are diagrams when the value of k is changed with m=0 in FIGS. 24 and 25, respectively. Therefore, the horizontal axis represents the number (value of k) of inputs whose values are 0 at the time of learning and 1 at the time of similarity determination. That is, when the horizontal axis is 0, it indicates that the same input as that at the time of learning comes at the time of similarity determination, and as the value of the horizontal axis increases, the difference between the inputs at the time of learning and at the time of similarity determination increases. Also in FIGS. 26 and 27, similarly to the comparison in FIGS. 24 and 25, it can be seen that the similarity of the inputs at the time of learning and at the time of similarity determination can be accurately determined in a case where the diffusive information network is used with p<1.0.

FIGS. 28 and 29 are diagrams when the values of m and k are changed simultaneously with m=k in FIGS. 24 and 25.

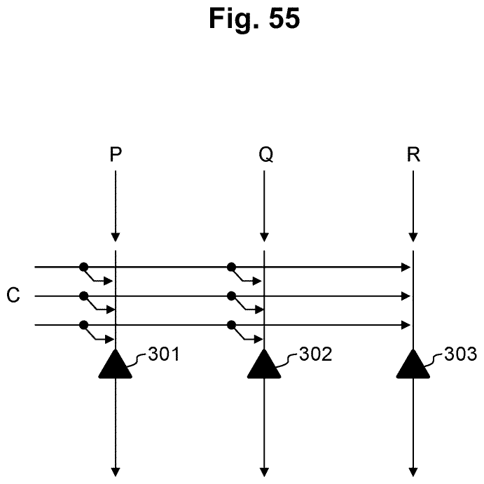

The horizontal axis indicates that, when the horizontal axis is 0, the same input as that at the time of learning comes at the time of similarity determination, and as the value of the horizontal axis increases, the difference between the inputs at the time of learning and at the time of similarity determination increases. Also in FIGS. 55 and 29, similarly to the comparison in FIGS. 24 and 25, it can be seen that the similarity of the inputs at the time of learning and at the time of similarity determination can be accurately determined in a case where the diffusive information network is used with p<1.0.

FIGS. 30 to 35 are diagrams when the activation function of the perceptron in the divisive normalization similarity calculator is a linear function in FIGS. 24 to 29, respectively. When the activation function is a linear function, a large difference from the case of the step function is the effect of the diffusive information network when p=1.0. That is, there is substantially a large difference in the situation similar to the case of not using the diffusive information network. In the step function, the output is 0 when the value is equal to or less than the threshold, and the output is 1 when the threshold is exceeded. On the other hand, in the case of the linear function, when the threshold is exceeded, a value proportional to the activation degree is output. Thus, as illustrated in FIGS. 25, 27, 29, 31, 33, and 35, similarity can be accurately determined when the threshold is exceeded. On the other hand, similarity cannot be determined when equal to or less than the threshold.

From the above, it can be seen that even in a case where the activation function is a linear function, the similarity of the inputs at the time of learning and at the time of similarity determination can be accurately determined in a case where the diffusive information network is used with p<1.0.

### Effects of First Embodiment

As described above, the similarity determination method (divisive normalization similarity calculation method) (FIGS. 15 to 18) according to the first embodiment is a similarity determination method for calculating the degree of similarity between the input of the learning phase and the input of the similarity determination phase using the perceptron obtained by modeling a nerve cell, the similarity determination method having one or more inputs, one of the two different values: the value L or the value H is input to each input, when the value of the i-th input in the learning phase is represented as xᵢ and the value of the i-th input in the similarity determination phase is represented as yᵢ, the value wᵢ is assigned to the i-th input, one of the two values of the value L and the value H is set to the value wᵢ, in the learning phase, setting the value wᵢ of the weight assigned to the i-th input to the value of xᵢ, and in the similarity determination phase, calculating the number of inputs in which xᵢ is the value H, the number of inputs in which both wᵢ and yᵢ are the value H, and the number of inputs in which yᵢ is the value H, and calculating and outputting a value obtained by dividing the number of inputs in which both wᵢ and yᵢ are the value H by a value obtained by adding the number of inputs in which yᵢ is the value H to the number of inputs in which wᵢ is the value H as similarity representing the degree of similarity.

In this way, the similarity between the information stored in the learning phase and the information input to the similarity determination phase can be accurately measured by the divisive normalization similarity calculation method (FIGS. 15 to 18). Thus, it is possible to remove the difference in information and a discrepancy of the degree of similarity to be calculated in the prior art and to perform similarity calculation on the basis of the degree of similarity. The value calculated by the divisive normalization similarity calculation method is an approximate value of cosine similarity. As a result, the similarity calculated by the divisive normalization similarity calculation method can calculate the similarity more accurately than the existing technology as described with reference to FIGS. 26 to 35. As a result, in an artificial neural network including a perceptron obtained by modeling a nerve cell, similarity between information stored in the network and information newly input to the network can be accurately determined.

In addition, the similarity determination method (FIGS. 15 to 18) according to the first embodiment is a similarity determination method for calculating the degree of similarity between the input of the learning phase and the input of the similarity determination phase using the perceptron obtained by modeling a nerve cell, and in the similarity determination phase, the divisive normalization similarity is calculated using Formula (6) that incorporates an operation caused by the phenomenon called the shunt effect of the nerve cell into the model of the perceptron.

Here, the divisive normalization similarity calculation method is achieved by (A) a method of determining a synaptic weight, (B) a method of determining a constant C of divisive normalization, and (C) a method of determining a perceptron set corresponding to a neuronal pool in divisive normalization. FIGS. 1 and 2 are examples of a circuit that performs the divisive normalization similarity calculation method. Examples of the operation of the diffusive learning network include the first operation example (FIGS. 7 to 10) in the case of using (step function) and the second operation example (FIGS. 11 to 14) in the case of using (linear function), and each of the first and second operation examples is further divided into <learning phase> (FIGS. 7 and 11) and <similarity determination phase> (FIGS. 7 to 10).

The output of the perceptron is calculated by Formula (4), and the constant C for divisive normalization is calculated by Formula (5). When Formula (5) is substituted into Formula (4) to be modified, Formula (6) is obtained. Formulas (7) to (10) are obtained by dividing and modifying Formula (6) by cases. By analyzing these formulas, it can be seen that the value calculated by the divisive normalization similarity calculation method is an approximate value of cosine similarity. That is, the similarity calculated by the divisive normalization similarity calculation method can calculate the similarity more accurately than the existing technology. Thus, the similarity between the information stored in the learning phase and the information input to the similarity determination phase can be accurately measured by the divisive normalization similarity calculation method. As result, it is possible to remove the difference in information and a discrepancy of the degree of similarity to be calculated in the prior art and to perform similarity calculation on the basis of the degree of similarity.

In the similarity determination method (divisive normalization similarity calculation method) (FIGS. 15 to 18) according to the first embodiment, the value L of the input is set to 0, the value H is set to 1, and in the similarity determination phase, the number of inputs in which xᵢ is the value H is calculated as the sum of xᵢ for all i, the number of inputs in which both wᵢ and yᵢ are the value H is calculated as the total sum of the products of wᵢ and yᵢ for all i or the total sum of the logical products of wᵢ and yᵢ, and the number of inputs in which yᵢ is the value H is calculated as the sum of yᵢ for all i.

In this way, the value calculated by the divisive normalization similarity calculation method is an approximate value of cosine similarity. Thus, the similarity between the information stored in the learning phase and the information input to the similarity determination phase can be accurately measured by the divisive normalization similarity calculation method.

In the similarity determination method (divisive normalization similarity calculation method) (FIGS. 15 to 18) according to the first embodiment, the calculated similarity is used as an input value to the activation function for defining the operation of the perceptron and the neuron, and the resulting value calculated by the activation function is output as a value indicating the degree of similarity.

In this way, the value calculated by the divisive normalization similarity calculation method is an approximate value of cosine similarity. Note that the value of the activation function having the similarity as an input is not the cosine similarity. Thus, the similarity between the information stored in the learning phase and the information input to the similarity determination phase can be accurately measured by the divisive normalization similarity calculation method.

In the similarity determination method (divisive normalization similarity calculation method) according to the first embodiment, when the value L of the input is set to 0, the value H is set to 1, the fact that the i-th input is connected to the j-th similarity calculator among the plurality of similarity calculators (divisive normalization similarity calculators 100) (FIGS. 1 to 14) that performs the similarity calculation processing is represented by the value Xᵢⱼ, the value Xᵢⱼ is set to 1 when connected, the value Xᵢⱼ is set to 0 when not connected, when the vector having Xᵢⱼ, X₂ⱼ, . . . as components is represented by x, the vector having inputs x₁, x₂, . . . of the learning phase as components is represented by x, and the vector having inputs y₁, y₂′ . . . of the similarity determination phase as components is represented by y, the vector w having w₁, w₂, . . . as components is set as w=x, when the j-th similarity calculator calculates the similarity by the similarity determination method according to any one of claims 1 to 4, the number of inputs in which the value of xᵢ is 1 is calculated as the square of the norm of a Hadamard product xoXⱼ of the vectors x and xᵢ, and the number of inputs in which both wᵢ and yᵢ are 1 is calculated as an inner product of the vector represented by a Hadamard product woXⱼ and the vector y, and the number of inputs in which the value of yᵢ is 1 is calculated as the square of the norm of a Hadamard product yoXⱼ.

In the conventional art, when similarity is determined by calculating an input vector at the time of learning and an inner product of input vectors for determining similarity, the inner product similarity may be the same value even when there is a difference in distance with respect to the input vector at the time of learning between the two input vectors for determining similarity. That is, in the similarity calculation in the conventional art, there is a problem that the difference between the input vector at the time of learning and the input vector at the time of similarity determination cannot be accurately determined for the inner product similarity.

On the other hand, in the divisive normalization similarity calculation method according to the first embodiment, when the similarity is calculated, in addition to multiplication, addition, and subtraction, at the time of division by an operation caused by the phenomenon called the shunt effect of the nerve cell (neuron), the division calculates the number of inputs in which the value of xᵢ is 1 as the square of the norm of the Hadamard product xoXⱼ of the vectors x and xⱼ, calculates the number of inputs in which both wᵢ and yᵢ are 1 as the inner product of the vector represented by the Hadamard product woXⱼ and the vector y, and calculates the number of inputs in which the value of yᵢ is 1 as the square of the norm of the Hadamard product yoXⱼ. As a result, the value calculated by the divisive normalization similarity calculation method becomes an approximate value of the cosine similarity, so that the similarity calculated by the divisive normalization similarity calculation method can calculate the similarity more accurately than the existing technology. In addition, by using the Hadamard product, the calculation speed can be significantly improved, or the circuit scale can be significantly reduced.

The similarity calculator according to the first embodiment performs similarity calculation based on the above-described similarity determination method (FIGS. 15 to 18).

In this way, it is possible to achieve a unit circuit device capable of calculating similarity more accurately than the existing technology.

In the diffusive learning network 1000 (FIGS. 5 to 14), a plurality of the similarity calculators (divisive normalization similarity calculators 100) (FIGS. 1 to 14) having some or all of inputs with respect to a plurality of inputs is connected, and further, outputs of the respective similarity calculators are input to a perceptron, the similarity calculator has one or more inputs, one of the two different values: the value L or the value H is input to each input, when the value of the i-th input in the learning phase is represented as xᵢ and the value of the i-th input in the similarity determination phase is represented as yᵢ, the value wᵢ is assigned to the i-th input, one of the two values of the value L and the value H is set to the value wᵢ, in the learning phase, sets the value wᵢ of the weight assigned to the i-th input to the value of xᵢ, and in the similarity determination phase, performs similarity calculation that calculates the number of inputs in which xᵢ is the value H, the number of inputs in which both wᵢ and yᵢ are the value H, and the number of inputs in which yᵢ is the value H, and calculates a value obtained by dividing the number of inputs in which both wᵢ and yᵢ are the value H by a value obtained by adding the number of inputs in which yᵢ is the value H to the number of inputs in which wᵢ is the value H as similarity representing the degree of similarity.

In this way, it is possible to achieve a diffusive learning network capable of calculating similarity more accurately than the existing technology. For example, when it is applied to an artificial neural network including a perceptron obtained by modeling a nerve cell, similarity between information stored in the network and information newly input to the network can be accurately determined.

In the diffusive learning network 1000 (FIGS. 5 to 14), the plurality of similarity calculators 100 is combined, one or more of the entire inputs are used as inputs to each of the similarity calculators, and each of the similarity calculators calculates similarity and outputs a value obtained by summing the similarities calculated by all the similarity calculators as a final similarity.

In this way, it is possible to achieve a diffusive learning network capable of calculating similarity more accurately than the existing technology.

Here, in the calculation of the Hadamard product of the two vectors, when a vector having u₁, u₂, . . . as components is represented by u, a vector having v₁, v₂, . . . as components is represented by v, the i-th component of the Hadamard product uov is calculated by a logical product of vᵢ and uᵢ, so that the calculation speed can be remarkably improved or the circuit scale can be significantly reduced.

In the diffusive learning network 1000 (FIGS. 5 to 14), instead of setting the value obtained by summing the similarities calculated by all the similarity calculators as the similarity, a value obtained by dividing the value obtained by summing the similarities by the number of all the similarity calculators or the sum of values obtained by dividing each of the similarities calculated by all the similarity calculators by the number of all the similarity calculators in advance is set as the similarity.

In this way, it is possible to achieve a diffusive learning network capable of calculating similarity more accurately than the existing technology. In addition, by setting the value obtained by dividing the value obtained by summing the similarities by the number of the similarity calculators as the similarity or by setting the sum of values obtained by dividing each of the similarities calculated by all the similarity calculators by the number of all the similarity calculators in advance as the similarity, for example, it is possible to prevent overflow in a case of using a calculator by division by the number of all the similarity calculators in advance. Further, when comparing the values calculated by the plurality of diffusive learning networks, when there is a sufficient number of similarity calculators, the values of the plurality of diffusive learning networks can be compared even when the number of similarity calculators is different by a certain number in the plurality of diffusive learning networks, as can be seen from the fact that the values calculated by the respective diffusive learning networks converge to Formula (73).

The present invention is not limited to the above-described first exemplary embodiment, and includes other modifications and application examples without departing from the gist of the present invention described in the claims.

For example, a look-up table (LUT) may be used instead of the logic gate as the multiplier circuit. The LUT is a basic component of a field programmable gate array (FPGA) which is an accelerator, has high affinity at the time of FPGA synthesis, and is easily implemented by the FPGA. In addition, as the accelerator, a graphics processing unit (GPU)/an application specific integrated circuit (ASIC) or the like may be used.

### Second Embodiment

In the first embodiment, [divisive normalization similarity determination method] and [diffusive learning network method] are combined.

In the second embodiment, [noise addition sensitivity characteristic improvement method] is further combined with [divisive normalization similarity determination method] and [diffusive learning network method].

### [Divisive Normalization Similarity Determination Method]

First, the noise addition sensitivity characteristic improvement method will be described.

In general, the sensitivity of a measuring instrument is represented by a ratio of an indication amount of the measuring instrument to an observation value. On the other hand, [divisive normalization similarity determination method] and [diffusive learning network method] described in the first embodiment can be regarded as a measuring instrument for measuring the similarity between data of the learning phase and the similarity determination phase.

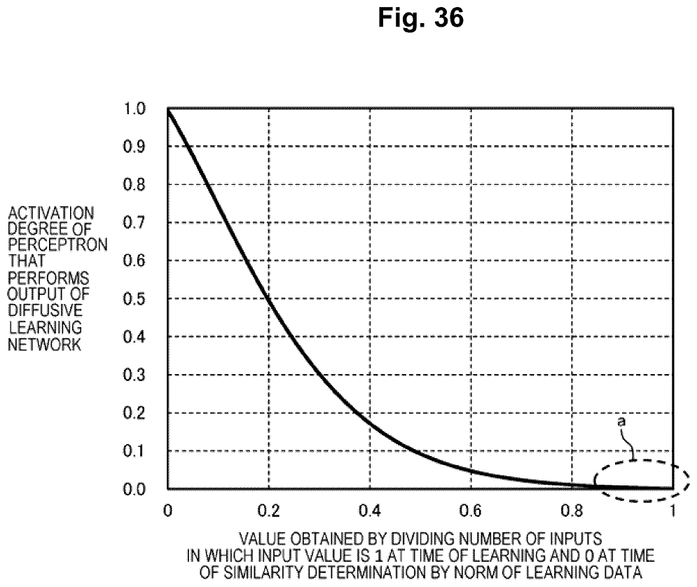

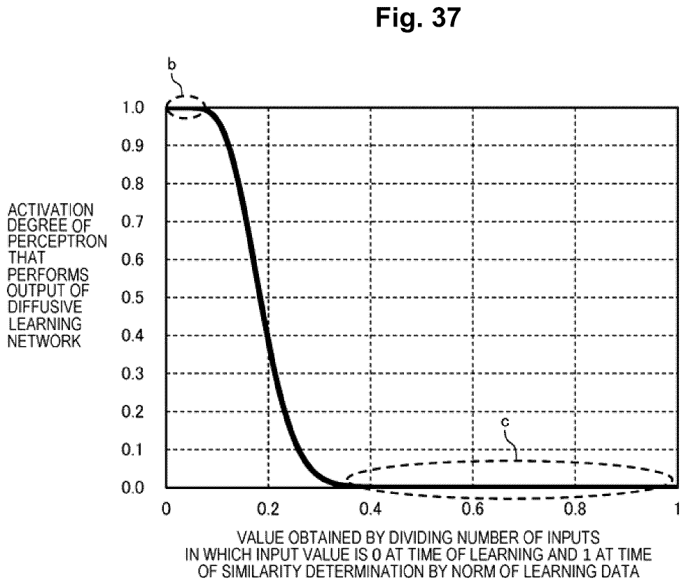

FIGS. 36 and 37 are used to describe characteristics of the measuring instrument.

FIG. 36 is a diagram illustrating an activation degree (N=100) of a perceptron that performs the output of the diffusive information network when only the divisive normalization similarity calculation method and the diffusive learning network are used. FIG. 37 is a diagram illustrating an activation degree (N=1000) of a perceptron that performs the output of the diffusive information network when only the divisive normalization similarity calculation method and the diffusive learning network are used.

FIGS. 36 and 37 illustrate that the difference in data between the learning phase and the similarity determination phase increases as the horizontal axis goes to the right. The vertical axis represents the similarity calculated when [divisive normalization similarity determination method] and [diffusive learning network method] are used, and represents a value calculated by Formula (73). The activation function included in Formula (73) used in FIGS. 36 and 37 is a sigmoid function. The sigmoid function is expressed by Formula (79) described below. In this formula, B and t are a parameter representing a gradient and a threshold, respectively.

$$[ Formula 79 ]$$

$$f ( x ) = \frac{1}{1 + {e}^{- β ( x - τ )}} \qquad ( 79 )$$

Parameters included in Formulas (73) and (79) are p=0.05, β=1.0×10⁴, and τ=0.9. In addition, the value of N is 100 and 1000 in FIGS. 36 and 37, respectively. As indicated by the broken line circle a in FIG. 36 and the broken line circles b and c in FIG. 37, the gradient of the curve is almost 0 and is nearly horizontal at the positions where the activation degree of the perceptron is close to 0.0 and the activation degree of the perceptron is close to 1.0.

The fact that the gradient of the curve illustrated in FIG. 36 is horizontal means that the similarity calculated by the difference in data between the learning phase and the similarity determination phase does not change and the sensitivity is poor. As described above, in a case where only [divisive normalization similarity determination method] and [diffusive learning network method] of the first embodiment are used, a problem that a part having poor sensitivity for partially measuring similarity is generated (Note 1) occurs.

In addition, comparing FIGS. 36 and 37, different curves are obtained due to a difference in N representing the square of the norm of the learning data. For example, when the value of the horizontal axis is 0.3, the values of the vertical axis are 0.302 and 0.0287 in FIGS. 36 and 37, respectively. Therefore, in a case where various pieces of learning data have different values of N, even when the same level of difference occurs in terms of the rate with respect to the data at the time of learning, different similarities are output. This causes a problem that it becomes difficult to compare the similarities with different learning data having different values of N (Note 2).

Further, Formula (7) used in [divisive normalization similarity determination method] of the first embodiment is an approximation of cosine similarity that is mathematically defined and whose characteristics are sufficiently analyzed and whose effectiveness is shown. However, after the activation degree is calculated by Formula (7), conversion is performed by an activation function, and in addition, processing is performed by [diffusive learning network method] of the first embodiment, thereby causing a problem that mathematically defined characteristics become unclear (Note 3).

Hereinafter, [noise addition sensitivity characteristic improvement method] described in the second embodiment is a technique for solving these Notes 1 to 3.

In [noise addition sensitivity characteristic improvement method], after the calculation of similarity Sd represented by Formula (7) used in [divisive normalization similarity determination method] and [diffusive learning network method] of the first embodiment is performed, similarity Sg obtained by adding noise to Sd is calculated as in Formula (80) described below.

$$[ Formula 80 ]$$

$${S}_{g} = {S}_{d} + G = \frac{2 {n}_{11}}{2 {n}_{11} + {n}_{10} + {n}_{01}} + G \qquad ( 80 )$$

Here, when a probability density function that generates a random variable X is represented by P(X), G is a value of the random variable randomly generated according to the probability density function. This value is newly generated every time Sg is calculated. In addition, after calculating Sg, Sg is used instead of Sd when performing the processing of [divisive normalization similarity determination method] and [diffusive learning network method].

In this way, the expected value of the output of the divisive normalization similarity calculator when Sg is used instead of Sd is considered. In a certain divisive normalization similarity calculator, a probability that the random variable X occurs is P(X)dX. Assuming that S(n, d, 1) and f(⋅) represent the activation degree and the activation function in the case of not adding noise as in Formula (73) as represented in Formula (73), respectively, the output of the divisive normalization similarity calculator is f(S(n, d, l)+X) in the case of using S. In this formula, the value G of the randomly generated random variable described above is represented by X.

Now, in a case where there are a sufficiently large number of divisive normalization similarity calculators, it can be considered that there are also a sufficient number of divisive normalization similarity calculators in which the activation degree S(n, d, l) is the same. Thus, the expected value of the output of the divisive normalization similarity calculator having the activation degree of S(n, d, l) is expressed by Formula (81).

$$[ Formula 81 ]$$

$${\int }_{- ∞}^{+ ∞} f ( S ( n , d , l ) + X ) P ( X ) dX \qquad ( 81 )$$

Further, since the probability that the activation degree is S(n, d, l) is calculated in obtaining Formula (73), when the probability that the activation degree is S(n, d, l) is used, the expected value of the output of the divisive normalization similarity calculator can be expressed by Formula (82) as described below.

$$[ Formula 82 ]$$

$${\sum }_{n = 0}^{N + k} [ {}_{N + k} {C}_{n} \cdot {{p}^{n} ( 1 - p )}^{N + k - n} \cdot {\sum }_{𝒞} \frac{{}_{N - m} {C}_{n - d - l} \cdot {}_{m} {C}_{d} \cdot {}_{k} {C}_{l}}{{}_{N + k} {C}_{n}} {\int }_{- ∞}^{+ ∞} f ( S ( n , d , l ) + X ) P ( X ) dX ] \qquad ( 82 )$$

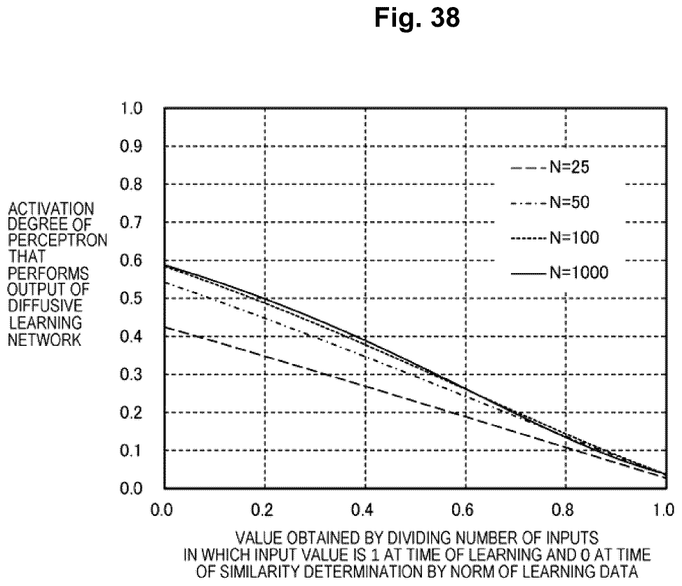

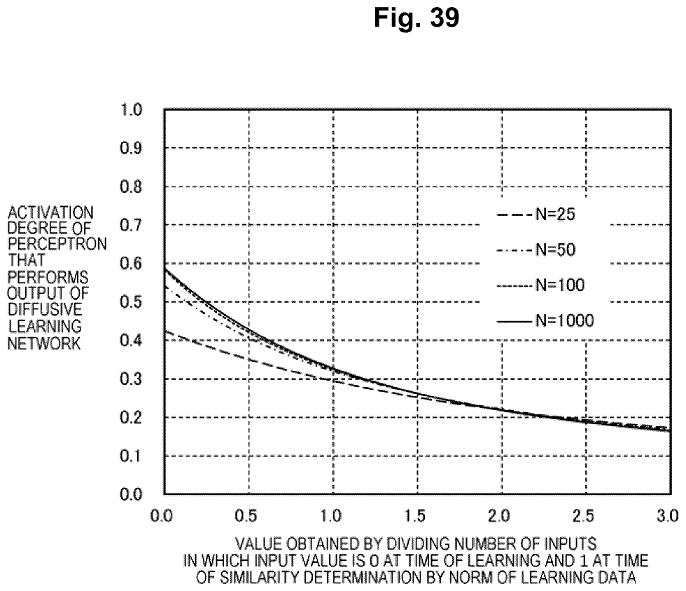

Features of the similarity actually calculated by the divisive normalization similarity calculator using Formula (82) will be described with reference to FIGS. 38 and 39.

FIG. 38 is a diagram illustrating an activation degree (output change when the number of inputs in which input value is 1 at the time of learning and 0 at the time of similarity determination is changed) of the perceptron that performs output of the diffusive information network when the divisive normalization similarity calculation method, the diffusive learning network, and the noise addition sensitivity characteristic improvement method are used. FIG. 39 is a diagram illustrating an activation degree (output change when the number of inputs in which input value is 0 at the time of learning and 1 at the time of similarity determination is changed) of the perceptron that performs output of the diffusive information network when the divisive normalization similarity calculation method, the diffusive learning network, and the noise addition sensitivity characteristic improvement method are used.

In FIGS. 38 and 39, the vertical axis represents the activation degree of the perceptron that performs output of the diffusive learning network, and the horizontal axis represents the rate at which the data in the similarity determination phase is different from the data in the learning phase.

In FIGS. 38 and 39, a sigmoid function is used as the activation function, and the parameters included in Formula (82) and the parameter included in Formula (79) representing f(⋅) included in Formula (82) are p=0.05, =1.0×10⁴, and t=0.9. In addition, regarding the value of N, cases of 25, 50, 100, and 1000 are illustrated. Further, for the probability density function P(X) in Formula (82), a probability density function of Gaussian distribution with an average value and standard deviation of 0.01 and 0.5, respectively, are used.

FIGS. 38 and 39 illustrate that the difference in data between the learning phase and the similarity determination phase increases as the horizontal axis goes to the right. The vertical axis represents the activation degree of the perceptron that performs output of the diffusive learning network that is calculated by Formula (82).

As can be seen from FIGS. 38 and 39, the activation degree of the perceptron that performs output of the diffusive learning network always has a negative gradient with respect to an increase in value on the horizontal axis. From this, it can be seen that the problem of (Note 1) a part having poor sensitivity for partially measuring similarity is generated has been solved by setting the activation degree of the perceptron that performs output of the diffusive learning network as the similarity. Further, in FIGS. 38 and 39, when N=100 or more, they hardly depend on N, and it can be seen that the problem of (Note 2) it becomes difficult to compare the similarities with different learning data having different values of N has been solved.

In order to describe that (Note 3) has been solved, a method of representing the degree of similarity between two sets called Tanimoto similarity or Jaccard similarity described in Non Patent Literature 6 and Non Patent Literature 7 will be described.

In the present specification, these similarities that are equivalent definitions are abbreviated as Tanimoto similarity. Now, two sets A and B are considered. Tanimoto similarity S_{T} is expressed by Formula (83) described below.

$$[ Formula 83 ]$$

$${S}_{T} = \frac{\vert A ⋂ B \vert}{\vert A \vert + \vert B \vert - \vert A ⋂ B \vert} \qquad ( 83 )$$

In Formula (83), |A| represents the number of elements included in the set A. Here, it is considered to express the Tanimoto similarity Sr using the symbols used in Formula (7). In this case, when the two sets are considered as a set of components having a value of 1 in the input vector w of the learning phase and a set of components having a value of 1 in the input vector y of the similarity determination phase, |A∩B|=n₁₁, |A|=n₁₁+n₁₀/|B|=n₁₁+n₀₁ are obtained using the symbols used in Formula (7). When these are substituted into Formula (83), Formula (84) described below is obtained.

$$[ Formula 84 ]$$

$${S}_{T} = \frac{{n}_{11}}{{n}_{11} + {n}_{10} + {n}_{11} + {n}_{01} - {n}_{11}} = \frac{{n}_{11}}{{n}_{11} + {n}_{10} + {n}_{01}} \qquad ( 84 )$$

Since the number N of components having a value of 1 in w is N=n₁₁+n₁₀, substituting n₁₁=N−n₁₀ obtained by modifying this formula into Formula (84) causes the Tanimoto similarity Sr to be expressed by Formula (85) described below.

$$[ Formula 85 ]$$

$${S}_{T} = \frac{N - {n}_{10}}{N - {n}_{10} + {n}_{10} + {n}_{01}} = \frac{N - {n}_{10}}{N + {n}_{01}} \qquad ( 85 )$$

Here, the constant C is introduced to define SRI represented by Formula (86) described below.

$$[ Formula 86 ]$$

$${S}_{RT} = ( 1 - C ) {S}_{T} + C \qquad ( 86 )$$

S_{RT} in Formula (86) is hereinafter referred to as raised Tanimoto similarity. Here, Tanimoto similarities included in the two raised Tanimoto similarities are defined as S_{T}⁽¹⁾ and S_{T}⁽²⁾. At this time, the difference in raised Tanimoto similarity calculated from these is expressed by Formula (87) described below.

$$[ Formula 87 ]$$

$$\{ ( 1 - C ) {S}_{T}^{( 1 )} + C \} - \{ ( 1 - C ) {S}_{T}^{( 2 )} + C \} = ( 1 - C ) ( {S}_{T}^{( 1 )} - {S}_{T}^{( 2 )} ) \qquad ( 87 )$$

From the above, it can be seen that the difference in raised Tanimoto similarity is a constant multiple of the difference in Tanimoto similarity. From this, it can be seen that when comparing the magnitude of the difference between the two sets, Tanimoto similarity and raised Tanimoto similarity can be similarly compared.

Tanimoto similarity is mathematically defined and widely applied similarity, and has shown effectiveness in various fields.

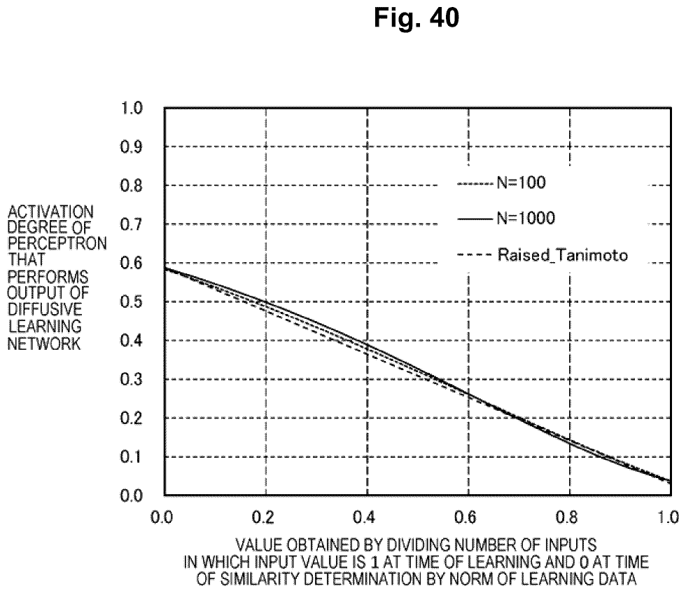

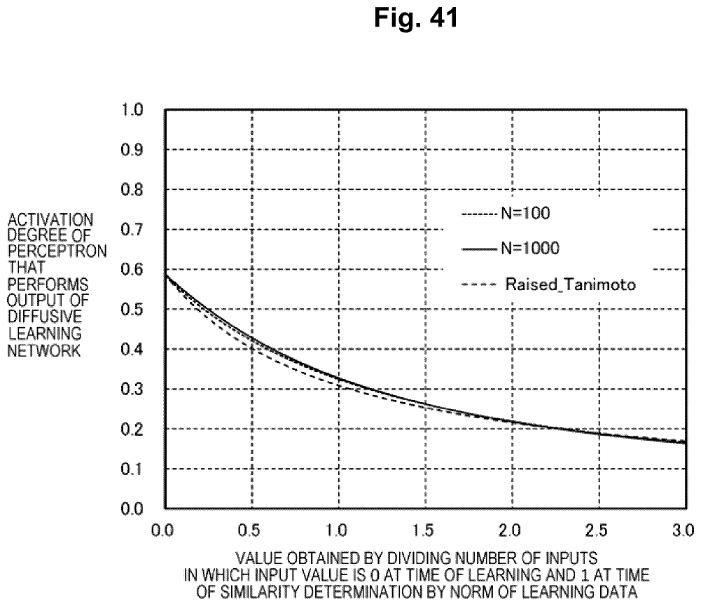

FIG. 40 is a diagram comparing an activation degree (output change when the number of inputs in which input value is 1 at the time of learning and 0 at the time of similarity determination is changed) of the perceptron that performs output of the diffusive information network and raised Tanimoto similarity when the divisive normalization similarity calculation method, the diffusive learning network, and the noise addition sensitivity characteristic improvement method are used. FIG. 41 is a diagram comparing an activation degree (output change when the number of inputs in which input value is 0 at the time of learning and 1 at the time of similarity determination is changed) of the perceptron that performs output of the diffusive information network and raised Tanimoto similarity when the divisive normalization similarity calculation method, the diffusive learning network, and the noise addition sensitivity characteristic improvement method are used.

In raised Tanimoto in FIGS. 40 and 41, the value of C in Formula (86) is 0.03. In FIGS. 40 and 41, raised Tanimoto similarity is represented by Raised-Tanimoto. In addition, for comparison, the value of raised Tanimoto similarity above is calculated with a coefficient (1−C) of Tanimoto similarity Sr included in Formula (86) as (D−C). Here, D represents the activation degree of the perceptron that performs output of the diffusive learning network when the horizontal axis is 0.

As can be seen from FIGS. 40 and 41, the gradient of the activation degree of the perceptron that performs output of the diffusive learning network is always a negative value, and (Note 1) can be solved. In addition, even when there is a different value of N as data at the time of learning, as can be seen from the fact that the activation degree of the perceptron that performs output of the diffusive learning network is a close value when N=100 or more, (Note 2) can be solved. Further, it can be seen that the activation degree of the perceptron that performs output of the diffusive learning network has a value close to raised Tanimoto similarity, and (Note 3) can be solved.

### Example 5

<Example 5> describes a fifth example of the processing of the similarity determination phase.

The learning phase of <Example 5> of the second embodiment is the same as that of <Example 1> of the first embodiment, and the processing described with reference to FIG. 15 described above is performed.

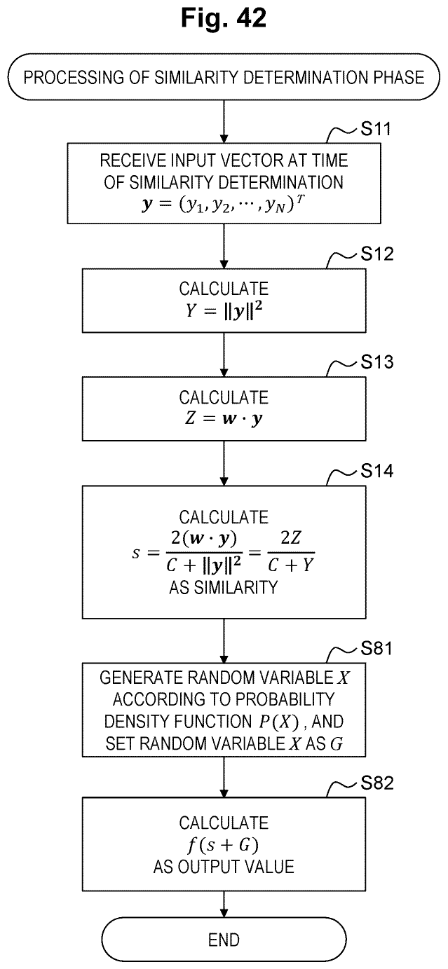

After the learning phase of FIG. 15 described above, the operation of the similarity determination phase illustrated in FIG. 42 is performed.

FIG. 42 is a flowchart illustrating processing in the similarity determination phase of the divisive normalization similarity calculator according to the second embodiment. Steps that perform the same processing as those in FIG. 16 are denoted by the same reference numerals.

In step S11, the divisive normalization similarity calculator 100 receives the input vector y=(y₁, y₂, . . . , y_{N})^{T} in the similarity determination phase.

In step S12, the divisive normalization similarity calculator 100 calculates Y=∥y∥² necessary for calculating the similarity.

In step S13, the divisive normalization similarity calculator 100 calculates Z=w·y necessary for calculating the similarity.

In step S14, the divisive normalization similarity calculator 100 calculates similarity s according to Formula (74) described above using the parameter C calculated in step S3 of FIG. 15 described above in addition to the calculated Y and Z.

After the processing of steps S11 to S14 described above is performed, the random variable X according to the probability density function P(X) is randomly generated, and the generated random variable is set to G (step S81).

That is, in step S81, the divisive normalization similarity calculator 100 generates the random variable X according to the probability density function P(X), and sets the random variable X as G.

In step S82, the divisive normalization similarity calculator 100 inputs the calculated similarity s and G generated from the random variable X to the activation function f(a) to obtain an output value f(s+G). The output value f(s+G) is an output of the divisive normalization similarity calculator 100.

For the probability density function used here, the distribution is not limited, but a Gaussian distribution, a normal distribution, a Poisson distribution, a Weibull distribution, or other distributions may be used. Then, f(s+G) is calculated using G, the similarity s calculated in step S14, and the activation function f(a), and this value is used as an output.

The activation function may be a frequently used ReLU or a step function. In addition, a simple linear function, a linear function with a threshold (Threshold-linear), a sigmoid function, and Radial-basis described in Non Patent Literature 2 may be used. Further, in these functions, a function having a threshold of 0 may be a function using any other value as a threshold.

### Example 6

<Example 6> describes a sixth example of the processing of the similarity determination phase.

The learning phase of <Example 6> of the second embodiment is the same as that of <Example 2> of the first embodiment, and the processing described with reference to FIG. 17 described above is performed.

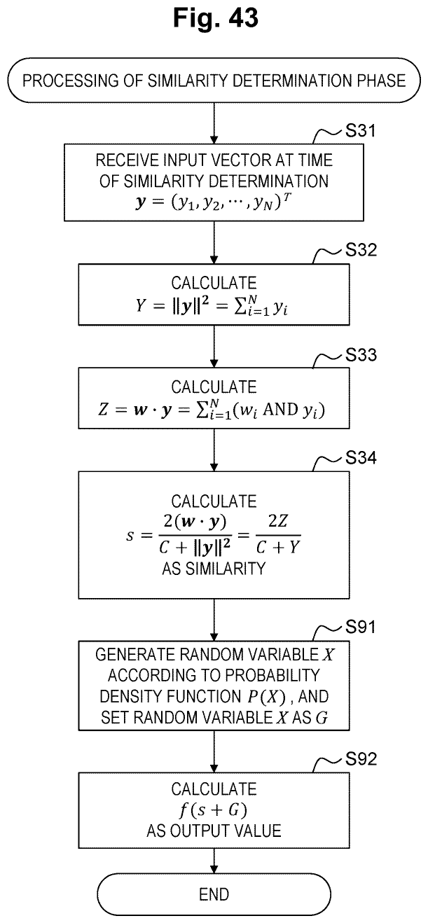

After the learning phase of FIG. 17 described above, the operation of the similarity determination phase illustrated in FIG. 43 is performed.

FIG. 43 is a flowchart illustrating processing in the similarity determination phase of the divisive normalization similarity calculator according to the second embodiment. Steps that perform the same processing as those in FIG. 18 are denoted by the same reference numerals.

In step S31, the divisive normalization similarity calculator 100 receives the input vector y=(y₁, y₂, . . . , y_{N})^{T} in the similarity determination phase.

In step S32, the divisive normalization similarity calculator 100 calculates Y=∥y∥² necessary for calculating the similarity. At this time, calculation is performed as Y=Σ^{N}ᵢ=₁yᵢ.

In step S33, the divisive normalization similarity calculator 100 calculates Z=w·y necessary for calculating the similarity. At this time, calculation is performed as Z=Σ^{N}ᵢ=₁(wᵢANDyᵢ). Here, wᵢANDyᵢ represents a logical conjunction operation of wᵢ and yᵢ.

In step S34, the divisive normalization similarity calculator 100 calculates similarity s according to Formula (74) using the parameter C calculated in step S23 of FIG. 17 described above in addition to the calculated Y and Z.

After the processing of steps S31 to S34 described above is performed, a random variable according to the probability density function P(X) is randomly generated and the generated random variable is set to G.

That is, in step S91, the divisive normalization similarity calculator 100 generates the random variable X according to the probability density function P(X), and sets the random variable X as G.

In step S92, the divisive normalization similarity calculator 100 inputs the calculated similarity s and G generated from the random variable X to the activation function f(a) to obtain an output value f(s+G). The output value f(s+G) is an output of the divisive normalization similarity calculator 100.

For the probability density function used here, the distribution is not limited, but a Gaussian distribution, a normal distribution, a Poisson distribution, a Weibull distribution, or other distributions may be used. Then, f(s+G) is calculated using G, the similarity s calculated in step S34, and the activation function f(?), and this value is used as an output.

The activation function may be a frequently used ReLU or a step function. In addition, a simple linear function, a linear function with a threshold (Threshold-linear), a sigmoid function, and Radial-basis described in Non Patent Literature 2 may be used. Further, in these functions, a function having a threshold of 0 may be a function using any other value as a threshold.

### Example 7

<Example 7> describes a seventh example of the processing of the similarity determination phase.

The learning phase of <Example 7> of the second embodiment is the same as that of <Example 3> of the first embodiment, and the processing described with reference to FIG. 20 described above is performed.

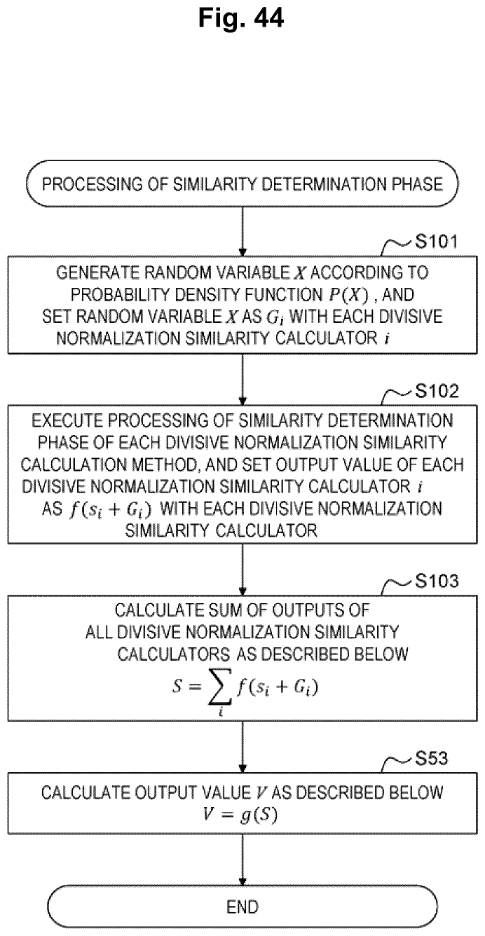

After the learning phase of FIG. 20 described above, the operation of the similarity determination phase illustrated in FIG. 44 is performed.

FIG. 44 is a flowchart illustrating processing in the similarity determination phase of the divisive normalization similarity calculator according to the second embodiment. Steps that perform the same processing as those in FIG. 21 are denoted by the same reference numerals.

In step S101, each divisive normalization similarity calculator i generates the random variable x according to the probability density function P(X), and sets the random variable X as Gᵢ.

In step S102, each divisive normalization similarity calculator i calculates similarity sᵢ, and the output of each divisive normalization similarity calculator i is set to f(sᵢ+Gᵢ). That is, in step S102, each divisive normalization similarity calculator i executes the processing of the similarity determination phase of each divisive normalization similarity calculation method, and sets the output value of each divisive normalization similarity calculator i as f(sᵢ+Gᵢ).

In step S103, each divisive normalization similarity calculator i calculates a sum S=Σᵢf(Sᵢ+Gᵢ) (Formula (83)) of the outputs of all divisive normalization similarity calculators.

In step S53, based on the obtained S, an output value V=g(S) of the diffusive learning network is calculated by inputting to an activation function g(⋅).

Here, the activation function may be a frequently used ReLU or a step function. In addition, a simple linear function, a linear function with a threshold (Threshold-linear), a sigmoid function, and Radial-basis described in Non Patent Literature 2 may be used. Additionally, the activation function may be k-Winner-Take-All (kWTA) or Winner-Take-All (WTA) described in Non Patent Literature 3. Further, in these functions, a function having a threshold of 0 may be a function using any other value as a threshold.

### Example 8

<Example 8> describes an eighth example of the processing of the similarity determination phase.

The learning phase of <Example 8> of the second embodiment is the same as that of <Example 4> of the first embodiment, and the processing described with reference to FIG. 22 described above is performed.

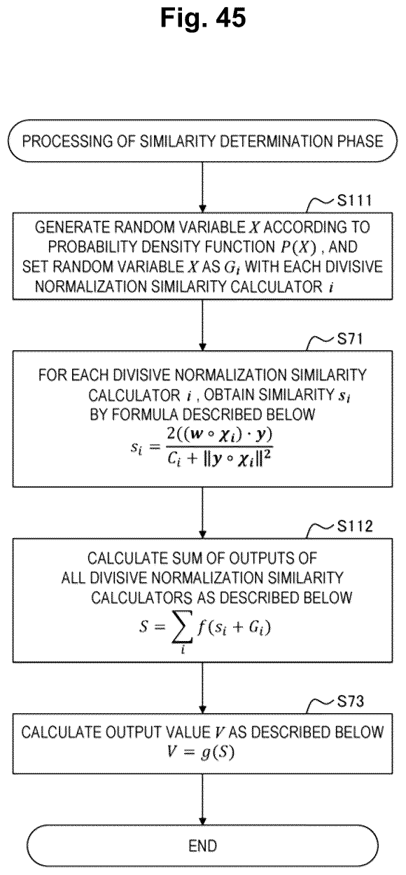

After the learning phase of FIG. 22 described above, the operation of the similarity determination phase illustrated in FIG. 45 is performed.

FIG. 45 is a flowchart illustrating processing in the similarity determination phase of the divisive normalization similarity calculator according to the second embodiment. Steps that perform the same processing as those in FIG. 23 are denoted by the same reference numerals.

In step S111, each divisive normalization similarity calculator i generates the random variable X according to the probability density function P(X), and sets the random variable X as Gᵢ.

In step S71, each divisive normalization similarity calculator i obtains the similarity sᵢ by Formula (78) described above.

In step S112, each divisive normalization similarity calculator i calculates a sum S=Σᵢf(Sᵢ+Gᵢ) (Formula (83)) of the outputs of all divisive normalization similarity calculators.

In step S73, based on the obtained S, an output value V=g(S) of the diffusive learning network is calculated by inputting to an activation function g(⋅).

### Effects of Second Embodiment

In the similarity determination method (FIGS. 36 to 45) according to the second embodiment, similarity obtained by adding predetermined noise to the calculated similarity is obtained, and thereafter, calculation is performed using the similarity to which the noise is added.

That is, in the second embodiment, after the calculation of the similarity Sd represented by the processing of (1) the divisive normalization similarity calculation method and (2) the diffusive learning network method is performed, the similarity Sg to which the noise is added is obtained, and thereafter, the calculation is performed using Sg instead of Sd.

In a case where only (1) the divisive normalization similarity calculation method and (2) the diffusive learning network method of the first embodiment are used, a part having poor sensitivity for partially measuring similarity is generated (Note 1), it becomes difficult to compare the similarities with different learning data having different values of N (the number of inputs) (Note 2), and mathematically defined characteristics become unclear by performing the processing of (1) and (2) (Note 3).

In the second embodiment, by performing calculation using the similarity Sg to which noise is added, as can be seen by comparing FIGS. 36 and 38 and FIGS. 37 and 39, a part having poor sensitivity for partially measuring similarity has been eliminated (solution to Note 1). In addition, as illustrated in FIGS. 40 and 41, the activation degree of the perceptron that performs output of the diffusive learning network has a close value (solution to Note 2). Further, it can be seen that the activation degree of the perceptron that performs output of the diffusive learning network has a value close to raised Tanimoto similarity (solution to Note 3).

In the similarity determination method (FIGS. 36 to 45) according to the second embodiment, similarity Sg obtained by adding predetermined noise to the calculated similarity Sd is obtained, and final similarity calculation is performed using the similarity Sg to which the noise is added.

In this way, (Note 1) to (Note 3) described above can be solved.

In the similarity determination method (FIGS. 36 to 45) according to the second embodiment, the noise is a random number generated randomly.

In this way, a random number to be randomly generated can be easily generated by, for example, a random number generation circuit, and by using this random number as noise, it is possible to reduce the calculation amount at the time of calculating the similarity.

### Third Embodiment

A third embodiment is an application example of a divisive normalization similarity calculation method using Fuzzy logic.

In the first and second embodiments, Formula (6) described above and Formula (7) described above are used to calculate the similarity between the vector w=(w₁, w₂, w₃, . . . )^{T} representing the synaptic weight set by the input of the learning phase and the vector y=(y₁, y₂, y₃, . . . )^{T} representing the input of the similarity determination phase. The use of Formula (88) described below has been described assuming that each component of the vectors w and y takes only a value of 0 or 1 in Formulas (6) and (7).

$$[ Formula 88 ]$$

$$\frac{2 ( y \cdot w )}{{‖ w ‖}^{2} + {‖ y ‖}^{2}} = \frac{2 ( y \cdot w )}{{\sum }_{i} {w}_{i} + {\sum }_{i} {y}_{i}} \qquad ( 88 )$$

Here, (y·w) in Formula (88) represents an inner product and is Σᵢwᵢyᵢ. In the case of using this Formula (88), the value of the input can only take a value of 0 or 1. Thus, for example, it cannot be applied to a case where multistage values are handled instead of two stages of brightness and darkness such as brightness of an image, or an application range where stepless values such as real numbers are handled.

In order to solve this problem, from here, Fuzzy logic described in Non Patent Literature 9 is used as in Non Patent Literature 8 so that any real number from 0 to 1 can be taken as the value of the input. In this way, for example, when the value xᵢ of the input is in the range from the minimum value L to the maximum value H, the value xᵢ can be converted into a real number from 0 to 1 by replacing with (xᵢ−L)/(H−L), so that the above problem can be solved using Fuzzy logic.

This replacement will be described. 0≤wᵢ≤1 and 0<yᵢ≤1 are set, and for the component of the input x=(x₁, x₂, x₃, . . . )^{T} at the time of learning when w is determined, 0<xᵢ≤1 is set, and Σwᵢyᵢ is also rewritten as Σᵢwᵢ∧^{F}yᵢ. Here, ∧^{F} in wᵢ∧^{F}yᵢ is an operator, and a value of p∧^{F}q is a smaller value of p and q. More specifically, when p≥q, the value of p∧^{F}q is q. By this replacement, Formula (88) becomes Formula (89).

$$[ Formula 89 ]$$

$$\frac{2 {\sum }_{i} {w}_{i} {∧}^{F} {y}_{i}}{{\sum }_{i} {w}_{i} + {\sum }_{i} {y}_{i}} = \frac{2 {\sum }_{i} {z}_{i}}{{\sum }_{i} {w}_{i} + {\sum }_{i} {y}_{i}} \qquad ( 89 )$$

In Formula (89), zᵢ=wᵢ∧^{F}yᵢ.

With respect to the characteristic of Formula (89), a range of possible values of Formula (89), a condition that the value of Formula (89) becomes the maximum value, and a change in the value of Formula (89) when deviating from the condition that the value becomes the maximum value will be described.

First, a range of possible values of Formula (89) will be described.

Since a range of possible values of variables used in Formula (89) is 0≤wᵢ≤1, 0≤yᵢ≤1, and 0≤zᵢ≤1, Formula (89) does not take a negative value. In addition, for any i, the value of Formula (89) is 0 when zᵢ=0, and thus, it can be seen that the value of Formula (89) is 0 or more.

Next, when Formula (89) is used, the maximum value becomes 1 by Formula (90).

$$[ Formula 90 ]$$

$$\frac{2 {\sum }_{i} {w}_{i} {∧}^{F} {y}_{i}}{{\sum }_{i} {w}_{i} + {\sum }_{i} {y}_{i}} = \frac{2 {\sum }_{i} {z}_{i}}{{\sum }_{i} {w}_{i} + {\sum }_{i} {y}_{i}} ≦ \frac{2 {\sum }_{i} {z}_{i}}{{\sum }_{i} {z}_{i} + {\sum }_{i} {z}_{i}} = \frac{2 {\sum }_{i} {z}_{i}}{2 {\sum }_{i} {z}_{i}} = 1 \qquad ( 90 )$$

From the above discussion, it can be seen that the value of Formula (89) is 0 or more and 1 or less.

Secondly, the condition that the value of Formula (89) becomes the maximum value will be described. Since the maximum value of the value of Formula (89) is 1, Conditional Formula (91) described below is obtained.

$$[ Formula 91 ]$$

$$\frac{2 {\sum }_{i} {w}_{i} {∧}^{F} {y}_{i}}{{\sum }_{i} {w}_{i} + {\sum }_{i} {y}_{i}} = \frac{2 {\sum }_{i} {z}_{i}}{{\sum }_{i} {w}_{i} + {\sum }_{i} {y}_{i}} = 1 \qquad ( 91 )$$

When this is modified, Formula (92) is obtained.

$$[ Formula 92 ]$$

$$2 {\sum }_{i} {z}_{i} = {\sum }_{i} {w}_{i} + {\sum }_{i} {y}_{i} \qquad ( 92 )$$

Further modification gives Formula (93) described below.

$$[ Formula 93 ]$$

$${\sum }_{i} ( {w}_{i} - {z}_{i} ) + {\sum }_{i} ( {y}_{i} - {z}_{i} ) = 0 \qquad ( 93 )$$

In Formula (93), since wᵢ−zᵢ≥0 and yᵢ−zᵢ≥0, the condition that satisfies Formula (93) is wᵢ=zᵢ and yᵢ=zᵢ for arbitrary i.

Thus, since wᵢ=yᵢ=zᵢ, the condition that the value of Formula (89) takes the maximum value is when wᵢ=yᵢ for arbitrary i.

Thirdly, a change in the value of Formula (89) when deviating from the condition that the value of Formula (89) becomes the maximum value will be described.

In Formula (89), wᵢ is determined in the learning phase, and is a constant in the similarity determination phase. Therefore, partial differentiation is performed on Formula (89) by yₖ as in Formula (94).

$$[ Formula 94 ]$$

$$\frac{\partial }{\partial {y}_{k}} \frac{2 {\sum }_{í} {z}_{i}}{{\sum }_{i} {w}_{i} + {\sum }_{i} {y}_{i}} = \frac{\partial }{\partial {y}_{k}} \frac{2 ( {\sum }_{i \neq k} {z}_{i} + {z}_{k} )}{{\sum }_{i} {w}_{i} + {\sum }_{i \neq k} {y}_{i} + {y}_{k}} \qquad ( 94 )$$

First, considering the case of wₖ<yₖ, zₖ wₖ holds. Then, Formula (94) becomes Formula (95) described below.

$$[ Formula 95 ]$$

$$\frac{\partial }{\partial {y}_{k}} \frac{2 ( {\sum }_{í \neq k} {y}_{i} + {w}_{k} )}{{\sum }_{i} {w}_{i} + {\sum }_{i \neq k} {y}_{i} + {y}_{k}} = \frac{- 2 ( {\sum }_{i \neq k} {z}_{i} + {z}_{k} )}{{( {\sum }_{i} {w}_{i} + {\sum }_{i \neq k} {y}_{i} + {y}_{k} )}^{2}} \qquad ( 95 )$$

Here, when all of wᵢ and yᵢ are not 0, the denominator of the above formula is obviously a positive value, and the numerator of Formula (95) is obviously a negative value. From this, it can be seen that, in the range of wₖ<yₖ, the value of Formula (89) monotonically decreases with respect to an increase in yₖ.

Next, considering the case of wₖ≥yₖ, zₖ=yₖ holds. Then, Formula (95) becomes Formula (96) described below.

$$[ Formula 96 ]$$

$$\begin{matrix}\frac{\partial }{\partial {y}_{k}} \frac{2 ( {\sum }_{í \neq k} {y}_{i} + {w}_{k} )}{{\sum }_{i} {w}_{i} + {\sum }_{i \neq k} {y}_{i} + {y}_{k}} \\ = \frac{2 \{ ( {\sum }_{i} {w}_{i} + {\sum }_{i \neq k} {y}_{i} + {y}_{k} - ( {\sum }_{i \neq k} {z}_{i} + {y}_{k} ) \}}{{( {\sum }_{i} {w}_{i} + {\sum }_{i \neq k} {y}_{i} + {y}_{k} )}^{2}} \\ = \frac{2 \{ ( {\sum }_{i \neq k} {w}_{i} + {w}_{k} + {\sum }_{i \neq k} {y}_{i} + {y}_{k} ) - ( {\sum }_{i \neq k} {z}_{i} + {y}_{k} ) \}}{{( {\sum }_{i} {w}_{i} + {\sum }_{i \neq k} {y}_{i} + {y}_{k} )}^{2}} \\ = \frac{2 \{ {\sum }_{í \neq k} {w}_{i} + {y}_{i} - {z}_{i} ) + {w}_{k} \}}{{( {\sum }_{i} {w}_{i} + {\sum }_{i \neq k} {y}_{i} + {y}_{k} )}^{2}} ≧ \frac{2 \{ {\sum }_{í \neq k} ( 2 {z}_{i} - {z}_{i} ) + {w}_{k} \}}{{( {\sum }_{i} {w}_{i} + {\sum }_{i \neq k} {y}_{i} + {y}_{k} )}^{2}} \\ = \frac{2 ( {\sum }_{í \neq k} {z}_{i} + {w}_{k} )}{{( {\sum }_{i} {w}_{i} + {\sum }_{i \neq k} {y}_{i} + {y}_{k} )}^{2}}\end{matrix} \qquad ( 96 )$$

Here, when all of wₖ and yₖ are not 0, the denominator of Formula (96) is obviously a positive value, and the numerator of Formula (96) is also obviously a positive value. From this, it can be seen that, in the range of wₖ≥yₖ, the value of Formula (89) monotonically increases with respect to an increase in yₖ. From the above discussion, it can be seen that when deviating from the condition that the value of Formula (89) becomes the maximum value, the value of Formula (89) behaves as monotonically decreasing as deviating.

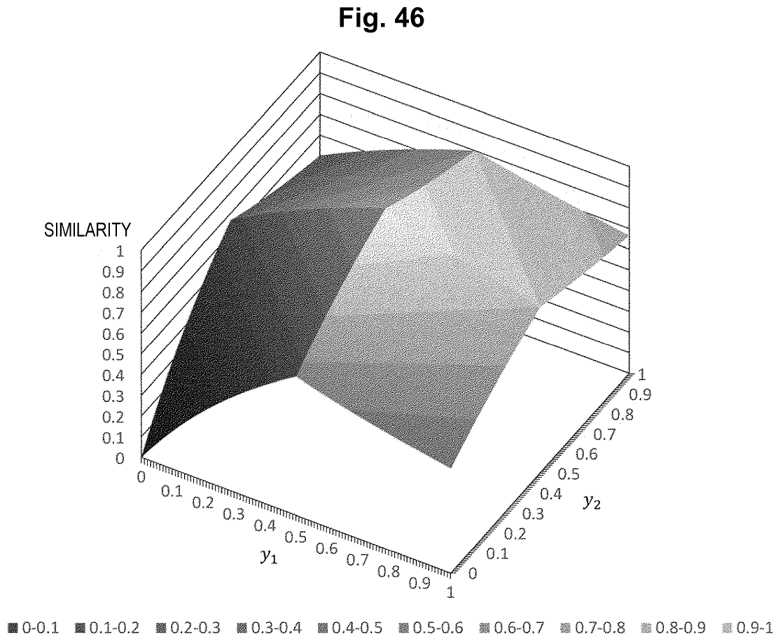

FIG. 46 is a diagram for describing an example of similarity by the divisive normalization similarity calculation method using Fuzzy logic. FIG. 46 illustrates a change in similarity when y=(y₁, y₂) is changed when w=(w₁, w₂)=(0.5, 0.5). Iₙ other words, it is a similarity calculation result when replaced with Fuzzy logic when w=(w₁, w₂)=(0.5, 0.5).

In FIG. 46, y=(y₁, y₂) is changed. In addition, the similarity in FIG. 46 is calculated based on Formula (89). As can be seen from FIG. 46, it can be seen that the similarity decreases as y=(y₁, y₂) deviates from y=(0.5, 0.5).

Here, in the case of not using Fuzzy logic, it has been described using Formulas (9) and (10) that the similarity represented by Formula (7) decreases as the change of the vector y from the vector w increases. In the above description, the change of the vector y from the vector w means a change of each element yᵢ from wᵢ. That is, it is the change of the element from 0 to 1 and the change from 1 to 0, and it has been described as the change in similarity when n₁₀ and n₀₁ increase accordingly. When Fuzzy logic is used, each element continuously changes, and thus, using partial differentiation, a change in the calculated similarity with respect to a change of each element yᵢ from wᵢ is described by Formulas (95) and (96), and a change in the numerical similarity is described with reference to FIG. 46.

From the above, it can be seen that the formula for calculating the similarity can be replaced with Formula (89) since what has been described here is the same characteristic as when the similarity is calculated by Formulas (6) and (7).

### Example 9

In <Example 9>, processing of the learning phase by the divisive normalization similarity calculation method using Fuzzy logic, processing of the similarity determination phase in a case where the noise addition sensitivity characteristic improvement method is not used, and processing of the similarity determination phase in a case where the noise addition sensitivity characteristic improvement method is used will be described.

The learning phase of <Example 9> of the third embodiment is the same as that of <Example 2> of the first embodiment, and the processing described with reference to FIG. 17 described above is performed.

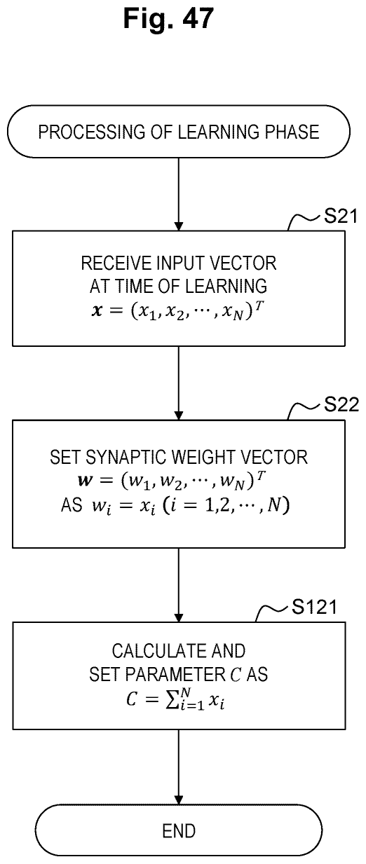

After the learning phase of FIG. 17 described above, the operation of the similarity determination phase illustrated in FIG. 47 is performed.

FIG. 47 is a flowchart illustrating processing of the learning phase by the divisive normalization similarity calculation method using Fuzzy logic. Steps that perform the same processing as those in FIG. 17 are denoted by the same reference numerals, and description thereof is omitted.

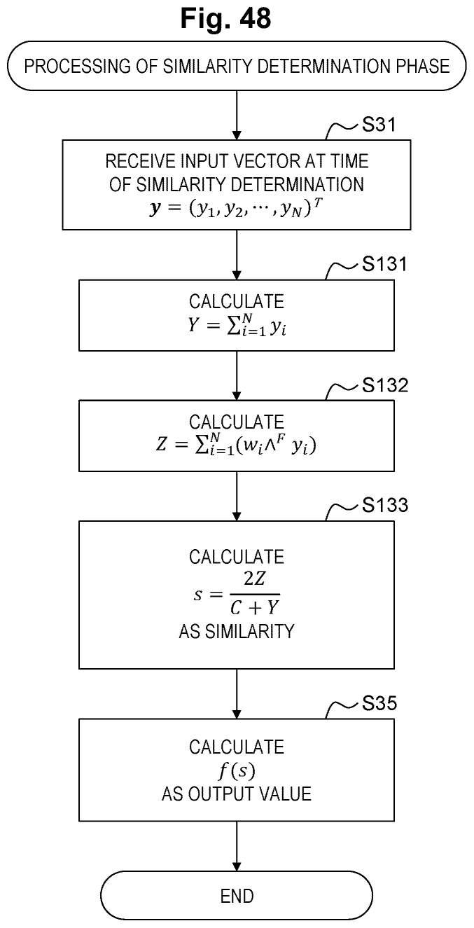

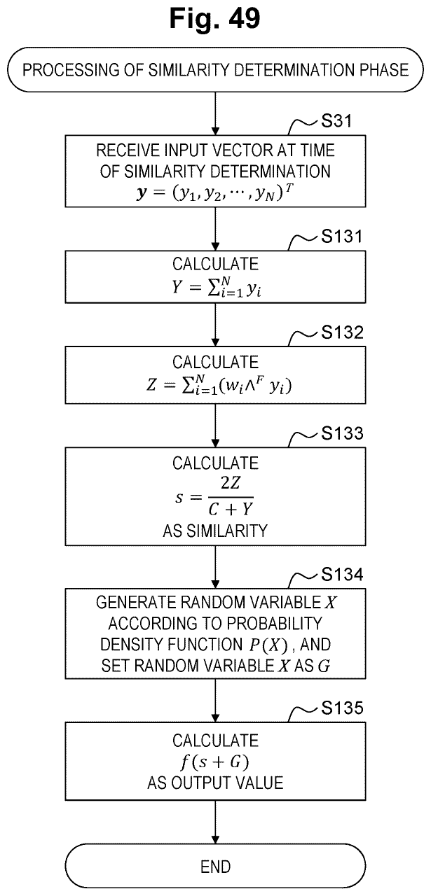

In step S121, the divisive normalization similarity calculator 100 calculates and sets a parameter C used in the similarity determination phase as C=Σ^{N}ᵢ=₁xᵢ. After the learning phase of FIG. 47 described above, the operation of the similarity determination phase illustrated in FIGS. 48 and 49 is performed.

Next, similarity determination phase processing of the diffusive learning network will be described.

FIG. 48 is a flowchart illustrating processing in the similarity determination phase of the divisive normalization similarity calculator when the noise addition sensitivity characteristic improvement method is not used. Steps that perform the same processing as those in FIG. 18 are denoted by the same reference numerals.

In step S31, the divisive normalization similarity calculator 100 receives the input vector y=(y₁, y₂, . . . , y_{N})^{T} in the similarity determination phase.

In step S131, the divisive normalization similarity calculator 100 calculates Y=Σ^{N}ᵢ=₁yᵢ.

In step S132, the divisive normalization similarity calculator 100 calculates z=Σ^{N}ᵢ=₁(wᵢ∧^{F}yᵢ).

In step S133, the divisive normalization similarity calculator 100 calculates s=2Z/(C+Y) as similarity.

In step S35, the divisive normalization similarity calculator 100 inputs the calculated similarity s to the activation function f(a) to obtain an output value f(s). The output value f(s) is the output of the divisive normalization similarity calculator 100 when the noise addition sensitivity characteristic improvement method is not used.

FIG. 49 is a flowchart illustrating processing in the similarity determination phase of the divisive normalization similarity calculator when the noise addition sensitivity characteristic improvement method is used. Steps that perform the same processing as those in FIG. 48 are denoted by the same reference numerals.

In step S31, the divisive normalization similarity calculator 100 receives the input vector y=(y₁, y₂, . . . y_{N})^{T} in the similarity determination phase.

In step S131, the divisive normalization similarity calculator 100 calculates Y=Σ^{N}ᵢ=₁yᵢ.

In step S132, the divisive normalization similarity calculator 100 calculates z=Σ^{N}ᵢ=1 (wᵢ∧^{F}yᵢ).

In step S133, the divisive normalization similarity calculator 100 calculates s=2Z/(C+Y) as similarity.

In step S134, the divisive normalization similarity calculator 100 generates the random variable X according to the probability density function P(X), and sets the random variable X as G.

In step S135, the divisive normalization similarity calculator 100 calculates f(s+G) as the output value. The output value f(s+G) is the output of the divisive normalization similarity calculator 100 when the noise addition sensitivity characteristic improvement method is used.

### Effects of Third Embodiment

In the similarity determination method (FIGS. 46 to 49) according to the third embodiment, the value of input is replaced with a value capable of taking any real number from 0 to 1 using Fuzzy logic.

In this way, it can be applied to a case where the value of the input is not only a value of 0 or 1, for example, multistage values are handled instead of two stages of brightness and darkness such as brightness of an image, or an application range where stepless values such as real numbers are handled.

In the similarity determination method (FIGS. 46 to 49) according to the third embodiment, in the replacement of the value of input using Fuzzy logic, in the similarity determination phase, three values are calculated: the total sum of the values of wᵢ, the total sum of the smaller values of wᵢ and yᵢ, and the total sum of the values of yᵢ, and a value obtained by dividing the value representing the total sum of the smaller values of wᵢ and yᵢ by a value obtained by adding the value representing the total sum of the values of wᵢ and the value representing the total sum of the values of yᵢ is calculated and output as the similarity representing the degree of similarity.

In this way, it can be applied to a case where the value of the input is not only a value of 0 or 1, for example, multistage values are handled instead of two stages of brightness and darkness such as brightness of an image, or an application range where stepless values such as real numbers are handled.

### [Hardware Configuration]

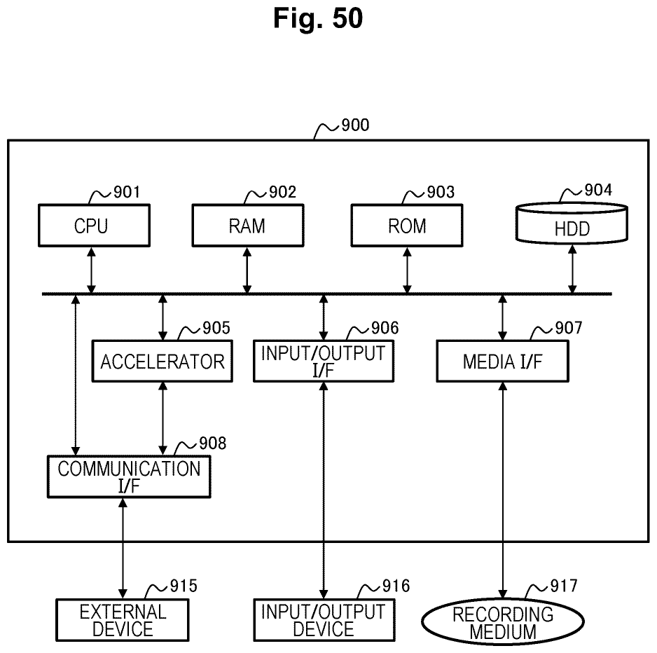

The divisive normalization similarity calculator 100 (FIGS. 1 to 14) according to the first to third embodiments described above is achieved by a computer 900 having a configuration as illustrated in FIG. 50, for example.

FIG. 50 is a hardware configuration diagram illustrating an example of the computer 900 that implements functions of the divisive normalization similarity calculator 100.

The computer 900 includes a CPU 901, RAM 902, ROM 903, an HDD 904, an accelerator 905, an input/output interface (I/F) 906, a media interface (I/F) 907, and a communication interface (I/F) 908. The accelerator 905 corresponds to the divisive normalization similarity calculator 100 illustrated in FIGS. 1 to 14.

The accelerator 905 is the divisive normalization similarity calculator 100 (FIGS. 1 to 14) that processes at least one of data from the communication I/F 908 and data from the RAM 902 at high speed. Note that the accelerator 905 may be of a type (look-aside type) that executes processing from the CPU 901 or the RAM 902 and then returns the execution result to the CPU 901 or the RAM 902. On the other hand, the accelerator 905 may also be of a type (in-line type) that is interposed between the communication I/F 908 and the CPU 901 or the RAM 902 and performs processing.

The accelerator 905 is connected to an external device 915 via the communication I/F 908. The input/output I/F 906 is connected to an input/output device 916. The media I/F 907 reads and writes data from and to a recording medium 917.

The CPU 901 operates on the basis of a program stored in the ROM 903 or the HDD 904 and controls each unit of the divisive normalization similarity calculator 100 illustrated in FIGS. 1 to 14 by executing the program (also called as an application or an app as an abbreviation thereof) read in the RAM 902. Then, the program may be distributed via a communication line or distributed by being recorded in the recording medium 917 such as a CD-ROM.

The ROM 903 stores a boot program to be executed by the CPU 901 when the computer 900 is activated, a program depending on hardware of the computer 900, and the like.

The CPU 901 controls the input/output device 916 including an input unit such as a mouse or a keyboard and an output unit such as a display or a printer via the input/output I/F 906. The CPU 901 acquires data from the input/output device 916 and outputs generated data to the input/output device 916 via the input/output I/F 906. Note that a graphics processing unit (GPU) or the like may be used as a processor in conjunction with the CPU 901.

The HDD 904 stores a program to be executed by the CPU 901, data to be used by the program, and the like. The communication I/F 908 receives data from another device via a communication network (e.g. network (NW)) and outputs the data to the CPU 901 and also transmits data generated by the CPU 901 to another device via the communication network.

The media I/F 907 reads a program or data stored in the recording medium 917 and outputs the program or data to the CPU 901 via the RAM 902. The CPU 901 loads a program regarding target processing from the recording medium 917 onto the RAM 902 via the media I/F 907 and executes the loaded program. The recording medium 917 is an optical recording medium such as a digital versatile disc (DVD) or a phase change rewritable disk (PD), a magneto-optical recording medium such as a magneto optical disk (MO), a magnetic recording medium, a conductor memory tape medium, semiconductor memory, or the like.

For example, in a case where the computer 900 functions as the divisive normalization similarity calculator 100 configured as a device according to the first to third embodiments, the CPU 901 of the computer 900 implements the function by executing a program loaded on the RAM 902. In addition, the HDD 904 stores data in the RAM 902. The CPU 901 reads the program regarding the target processing from the recording medium 917 and executes the program. Additionally, the CPU 901 may read the program regarding the target processing from another device via the communication network.

In addition, the above-described first to third exemplary embodiments have been described in detail for easy description of the present invention, and are not necessarily limited to those having all the described configurations. In addition, a part of a certain configuration of the first exemplary embodiment can be replaced with another configuration of the first exemplary embodiment, and another configuration of the first exemplary embodiment can be added to the certain configuration of the first exemplary embodiment. In addition, the first exemplary embodiment can be implemented in various other forms, and various omissions, substitutions, and changes can be made without departing from the gist of the invention. These first embodiment and modifications thereof are included in the scope and gist of the invention, and are included in the invention described in the claims and the equivalent scope thereof.

In addition, among the pieces of processing described in the above first to third embodiments, all or a part of the pieces of processing described as being automatically performed can be manually performed, or all or a part of the pieces of processing described as being manually performed can be automatically performed by a known method. In addition to this, information including the processing procedures, the control procedures, the specific names, the various kinds of data, and the parameters mentioned above in the specification or shown in the drawings can be modified as desired, unless otherwise particularly specified.

In addition, each component of each device that has been illustrated is functionally conceptual, and is not necessarily physically configured as illustrated. That is, a specific form of distribution and integration of each device is not limited to the illustrated form, and all or a part thereof can be functionally or physically distributed and integrated in any unit according to various loads, usage conditions, and the like.

In addition, some or all of the above-described configurations, functions, processing units, processing means, and the like may be implemented by hardware, for example, by designing with an integrated circuit. In addition, each of the above-described configurations, functions, and the like may be implemented by software for interpreting and performing a program for the processor to implement each function. Information such as a program, a table, and a file for implementing the functions can be held in a recording device such as memory, a hard disk, or a solid state drive (SSD), or in a recording medium such as an integrated circuit (IC) card, a secure digital (SD) card, or an optical disc.

In addition, in the first to third embodiments described above, the names of the divisive normalization similarity calculator and the diffusive learning network are used as the devices, but this is for convenience of description, and the names may be similarity calculator, similarity calculator circuit device, perceptron, diffusive information network, or the like. In addition, the name of the divisive normalization similarity determination method is used as the method and the program, but it may be similarity calculation method, neural network program, or the like.

1. A similarity determination method for calculating a degree of similarity between an input of a learning phase and an input of a similarity determination phase using a perceptron obtained by modeling a nerve cell, the similarity determination method comprising:
receiving one or more input values, wherein
one of a value L and a value His input to each input value,
when an i-th input value in the learning phase is represented as xᵢ and
an i-th input value in the similarity determination phase is represented as yᵢ,
wᵢ is assigned to the i-th input value,
one of the value L and the value His set to the value wᵢ;
in the learning phase, setting the value wᵢ of a weight assigned to the i-th input value to the value of xᵢ; and
in the similarity determination phase,
calculating a value obtained by dividing a number of inputs in which both wᵢ and yᵢ are the value H by a value obtained by adding a number of inputs in which yᵢ is the value H to a number of inputs in which the value of wᵢ is the value H as similarity representing the degree of similarity.

2. A similarity determination method for calculating a degree of similarity between an input of a learning phase and an input of a similarity determination phase using a perceptron obtained by modeling a nerve cell, the similarity determination method comprising:
in the similarity determination phase, calculating a divisive normalization similarity using a formula that incorporates an operation caused by a phenomenon called a shunt effect of a nerve cell into a model of the perceptron.
$$[ Formula 6 ]$$
$$\frac{2 {\sum }_{j = 1}^{6} {y}_{j} \cdot {w}_{j}}{{‖ x ‖}^{2} + {\sum }_{j = 1}^{6} {y}_{j}} = \frac{2 ( y \cdot w )}{{‖ {w}_{i} ‖}^{2} + {‖ {y}_{i} ‖}^{2}}$$

3. The similarity determination method according to claim 1, wherein
the value L of the input is set to 0, and the value H of the input is set to 1, and
in the similarity determination phase,
a number of inputs in which xᵢ is the value H is calculated as a sum of xᵢ for all input values,
a number of inputs in which both wᵢ and yᵢ are the value H is calculated as a total sum of products of wᵢ and yᵢ for all input values or a total sum of logical products of wᵢ and yᵢ, and
a number of inputs in which yᵢ is the value H is calculated as a sum of yᵢ for all i.

4. The similarity determination method according to claim 1, wherein
calculated similarity is used as an input value to an activation function for defining an operation of a perceptron and a neuron, and a resulting value calculated by the activation function is output as a value indicating a degree of similarity.

5. The similarity determination method according to claim 1, wherein
the value L of the input is set to 0, the value H of the input is set to 1,
a fact that the i-th input is connected to a j-th similarity calculator among a plurality of similarity calculators that performs similarity calculation processing is represented by a value Xᵢⱼ, and the value Xᵢⱼ is set to 1 when connected, the value Xᵢⱼ is set to 0 when not connected, when a vector having X₁ⱼ, X₂ⱼ, . . . as components is represented by Xⱼ, a vector having inputs x₁, x₂, . . . of the learning phase as components is represented by x, and a vector having inputs y₁, y₂, . . . of the similarity determination phase as components is represented by y,
a vector w having w₁, w₂, . . . as components is set as w=x,
when the j-th similarity calculator calculates similarity by the similarity determination method according claim 1,
a number of inputs in which xᵢ is 1 is calculated as a square of norm of a Hadamard product xoXⱼ of the vectors x and Xⱼ,
a number of inputs in which both wᵢ and yᵢ are 1 is calculated as an inner product of a vector represented by a Hadamard product woXⱼ and the vector y, and a number of inputs in which yᵢ is 1 is calculated as a square of norm of a Hadamard product yoXⱼ.

6. The similarity determination method according to claim 1, wherein
similarity obtained by adding predetermined noise to calculated similarity is obtained, and final similarity calculation is performed using the similarity to which the noise is added.

7. The similarity determination method according to claim 6, wherein the noise is a random number generated randomly.

8. The similarity determination method according to claim 1, wherein
a value of input is replaced with a value capable of taking any real number from 0 to 1 using Fuzzy logic.

9. The similarity determination method according to claim 8, wherein
in replacement of the value of input using the Fuzzy logic,
in the similarity determination phase,
three values are calculated: a total sum of values of wᵢ, a total sum of smaller values of wᵢ and yᵢ, and a total sum of values of yᵢ, and
a value obtained by dividing the value representing the total sum of the smaller values of wᵢ and yᵢ by a value obtained by adding the value representing the total sum of the values of wᵢ and the value representing the total sum of the values of yᵢ is calculated and output as similarity representing the degree of similarity.

10. A similarity calculator that performs similarity calculation based on the similarity determination method according to claim 1.

11. A diffusive learning network in which a plurality of similarity calculators having some or all of inputs with respect to a plurality of inputs are connected, and further, outputs of the respective similarity calculators are input to a perceptron, wherein
the similarity calculator
receives one or more input values,
one of a value L and a value His input to each input value,
when a value of an i-th input in a learning phase is represented as xᵢ, and
a value of an i-th input in a similarity determination phase is represented as yᵢ,
a value wᵢ is assigned to the i-th input,
one of the value L and the value H is set to the value wᵢ,
in the learning phase, the similarity calculator sets the value wᵢ of a weight assigned to the i-th input to the value of xᵢ, and
in the similarity determination phase,
the similarity calculator performs similarity calculation that calculates a value obtained by dividing a number of inputs in which both wᵢ and yᵢ are the value H by a value obtained by adding a number of inputs in which the value of yᵢ is the value H to a number of inputs in which the value of wᵢ is the value H as similarity representing a degree of similarity.

12. The diffusive learning network according to claim 11, wherein
the plurality of similarity calculators is combined, one or more of entire inputs are used as inputs to each of the similarity calculators, and each of the similarity calculators calculates similarity and outputs a value obtained by summing the similarities calculated by all the similarity calculators as a final similarity.

13. The diffusive learning network according to claim 12, wherein
instead of setting the value obtained by summing the similarities calculated by all the similarity calculators as the similarity, a value obtained by dividing the value obtained by summing the similarities by a number of all the similarity calculators or a sum of values obtained by dividing each of the similarities calculated by all the similarity calculators by a number of all the similarity calculators in advance is set as the similarity.

14. (canceled)
